(19) United States
(12) Patent Application Publication
(10) Pub. No.: US 2023/0061330 A1
(43) Pub. Date: Mar. 2, 2023

(54) FOLDING TAILGATE RAMP SYSTEM

(71) Applicant: Byron Norman Ricketts, Sunrise, FL (US)

(72) Inventor: Byron Norman Ricketts, Sunrise, FL (US)

(21) Appl. No.: 17/411,843

(22) Filed: Aug. 25, 2021

(51) Int. Cl. B60P 1/43

(52) U.S. Cl. CPC B60P 1/435

(57) ABSTRACT

The Folding Tailgate Ramp System (FTRS) is a rotating, retractable Tailgate Ramp which makes accessing an elevated bed of a vehicle, by smaller wheeled objects a possibility. The TRS has a wide base in the Ramp Casing, and a wide rotating and collapsible body in the Tailgate Ramp, and together they bridge the gap between the surface and the elevated Tailgate or bed of a vehicle. The TRS is a true collapsible ramp that is almost as wide as a Tailgate but is compact, can be electrically powered, and have sturdy interlocking joints which close flat. The FTRS is comprised of a Four Planked, Tailgate Ramp and a Three Planked, Tailgate Ramp. The Four Planked, Tailgate Ramp has four Planks and is designed to accommodate taller vehicles such as pickup, while the Three Planked, Tailgate Ramp, has three Planks and is designed to accommodate lower vehicles such as minivans.

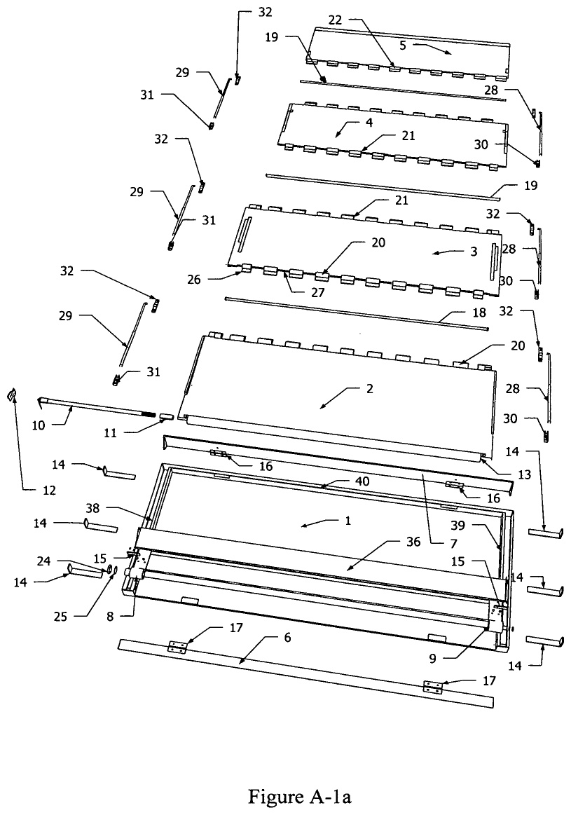

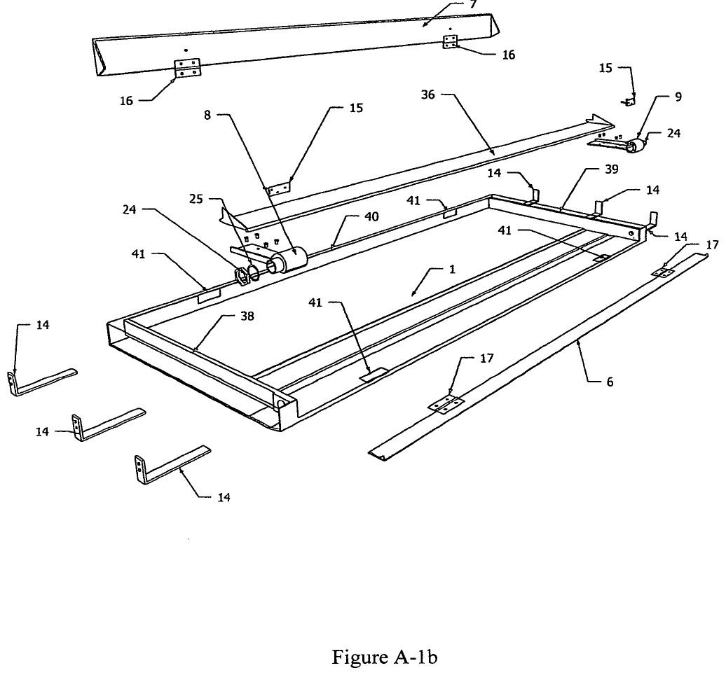

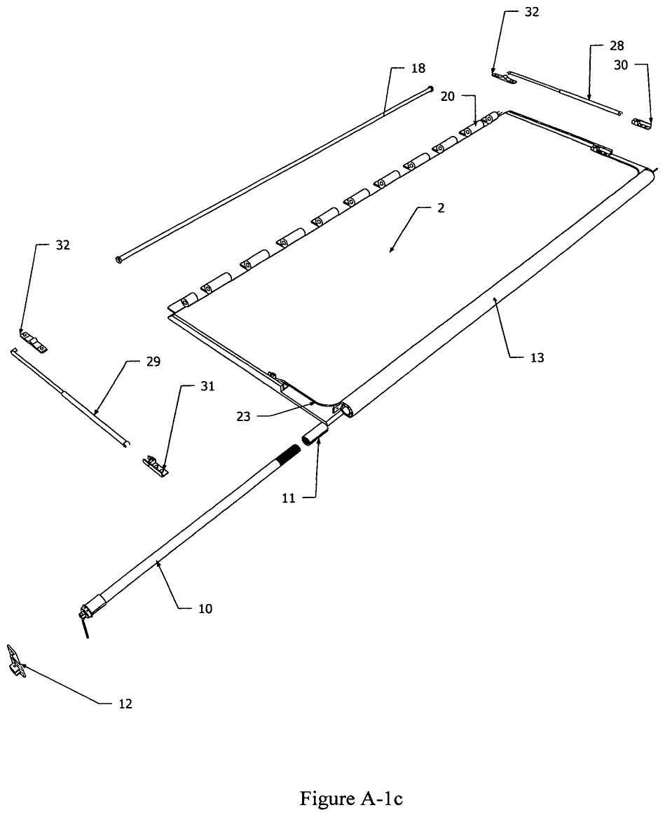

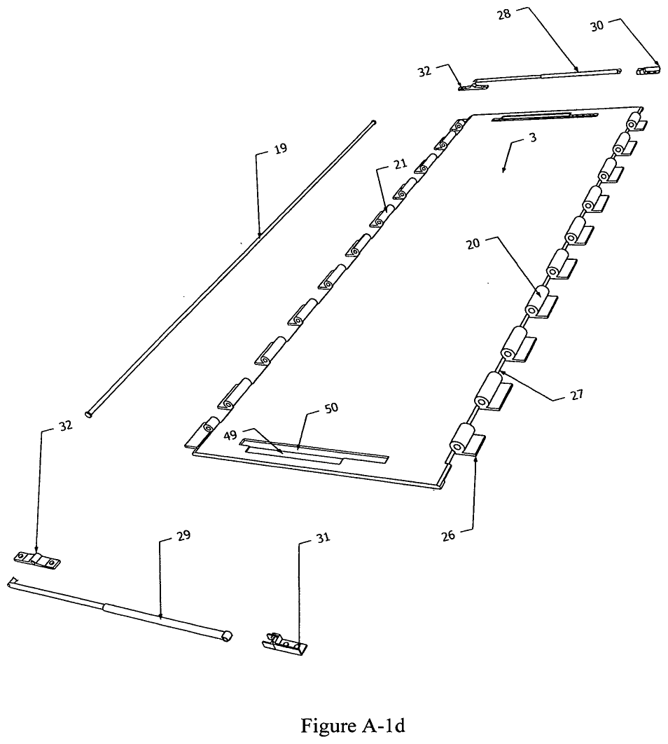

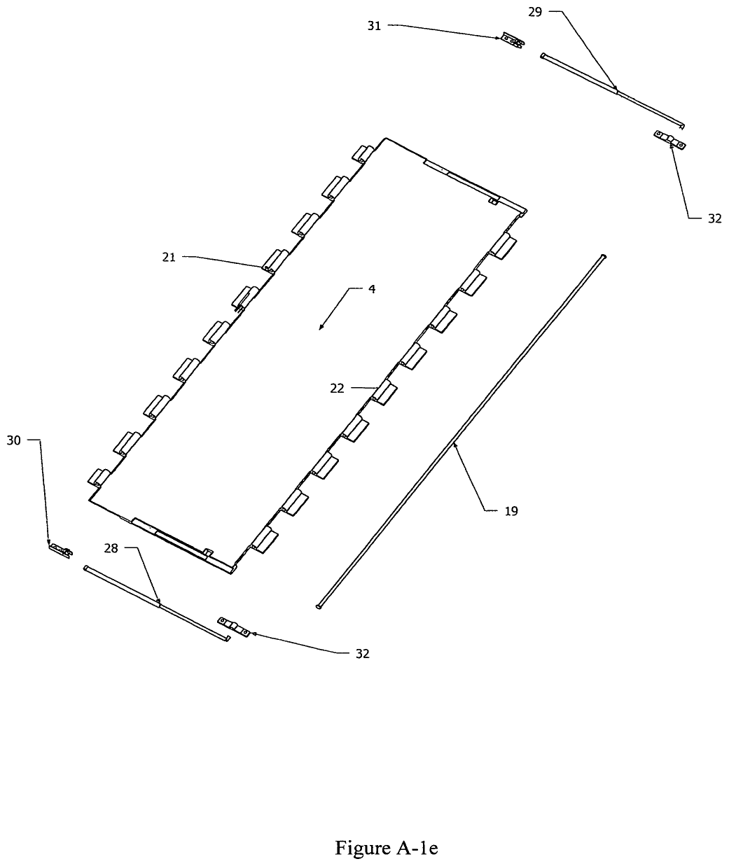

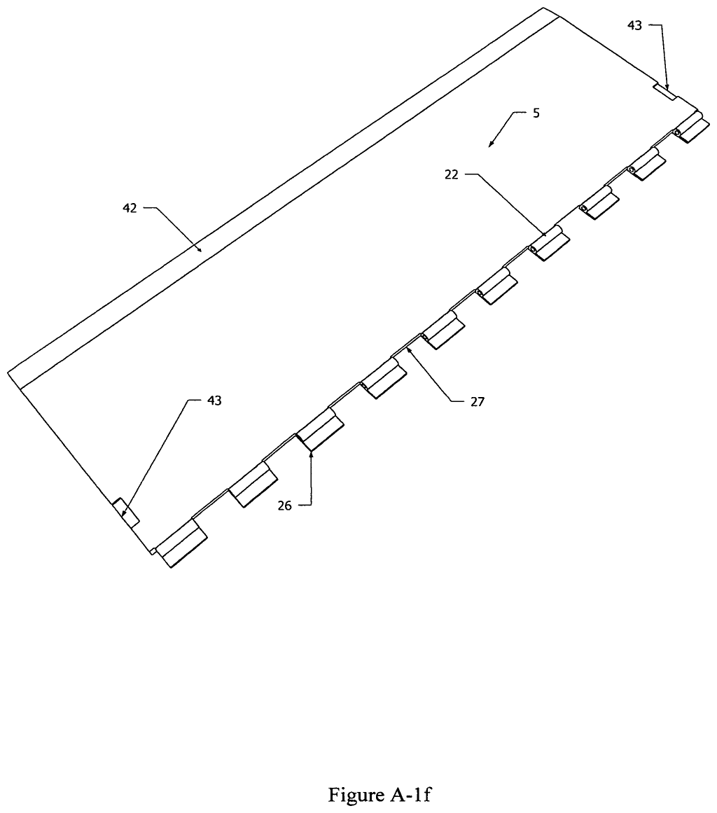

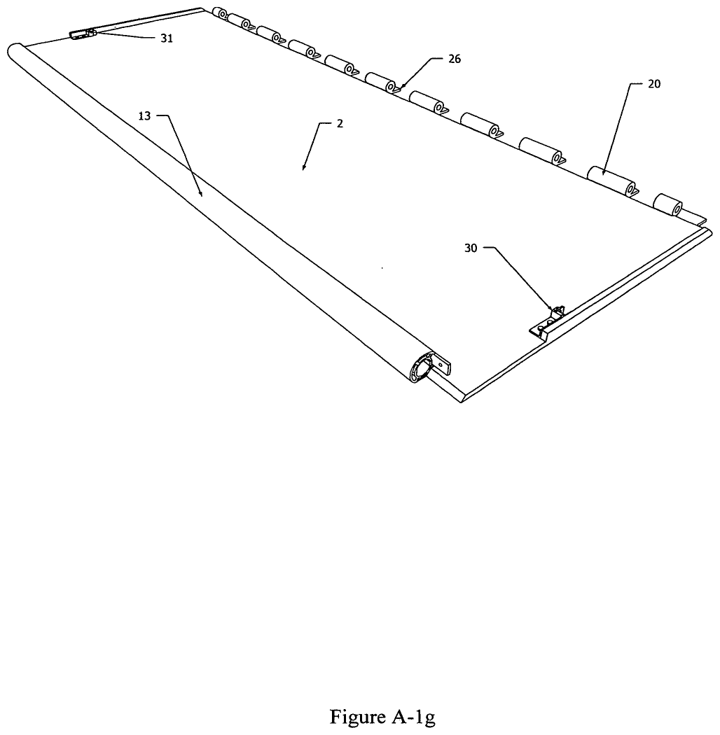

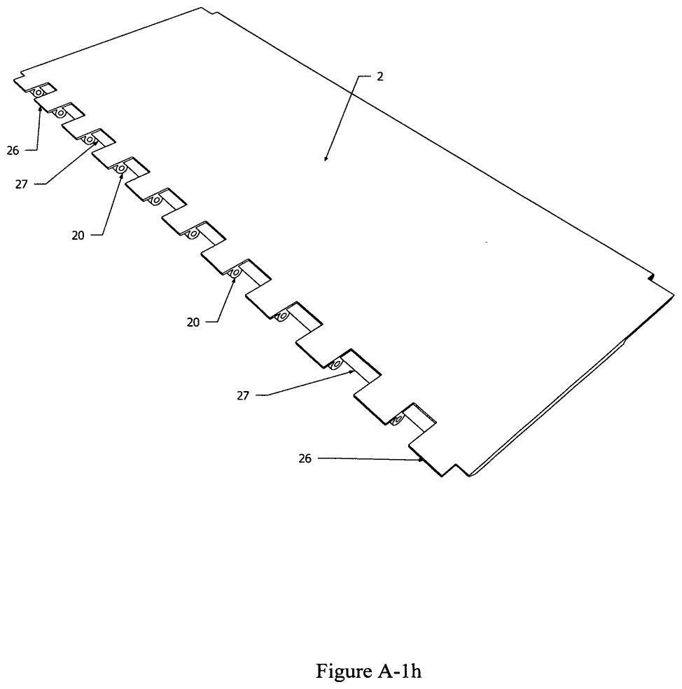

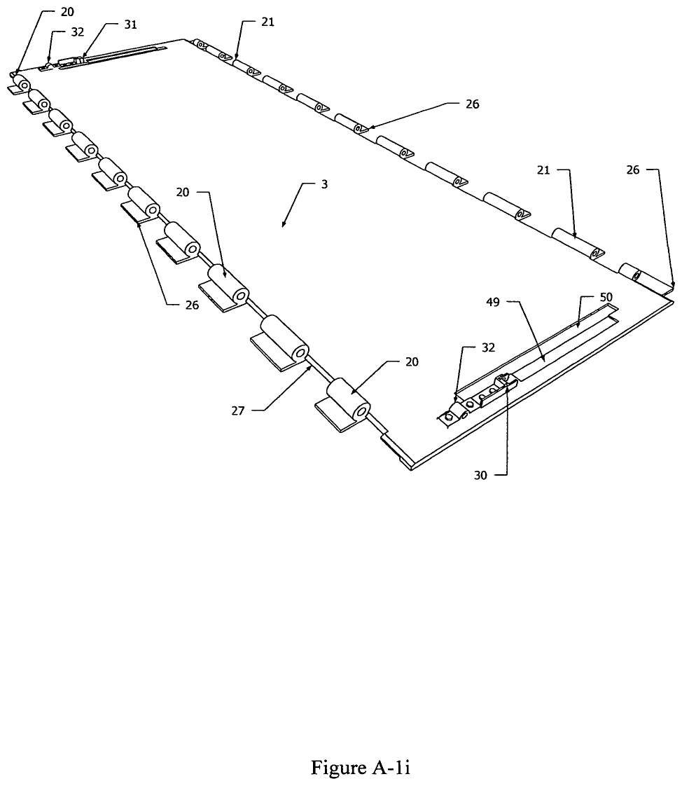

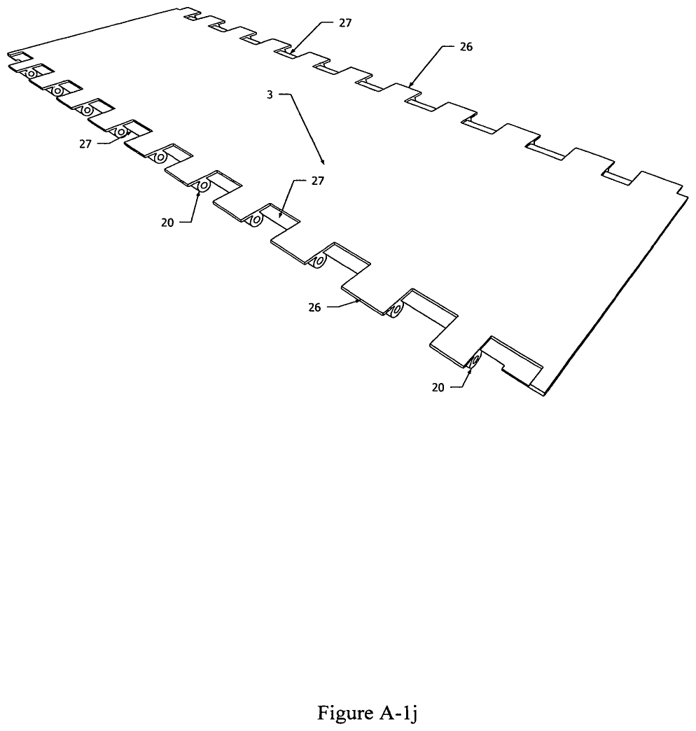

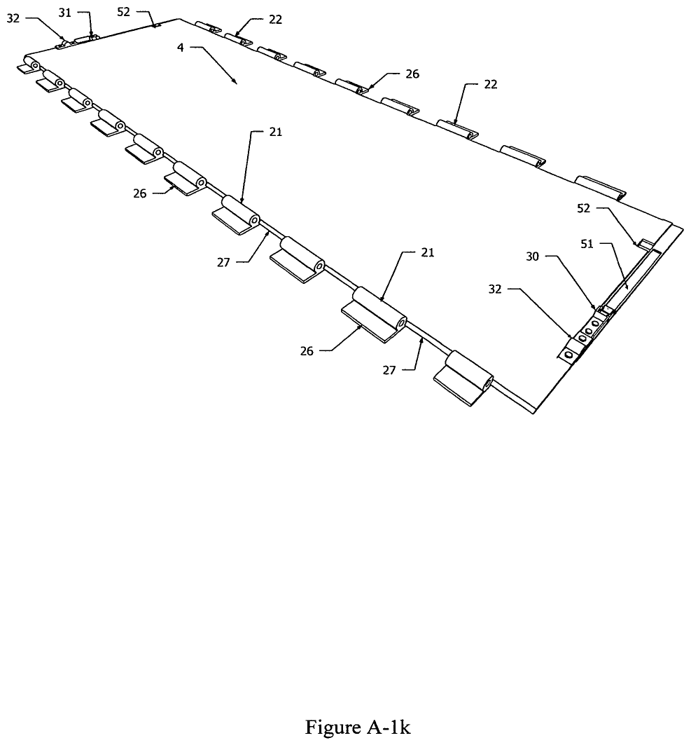

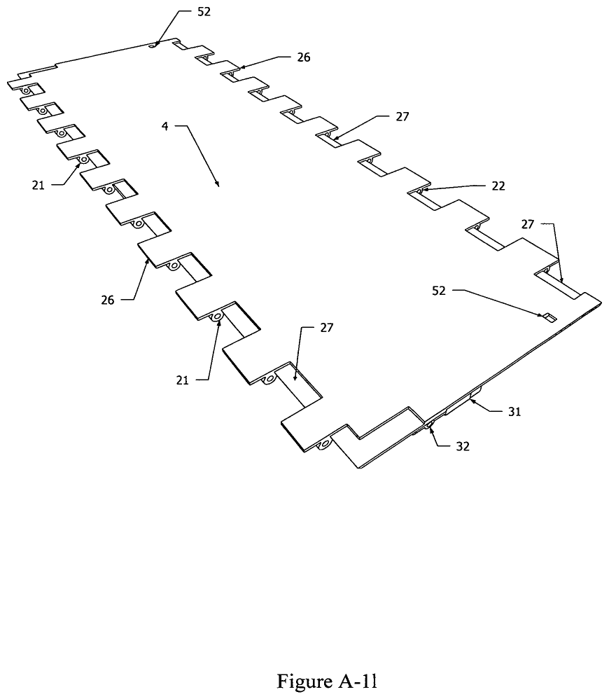

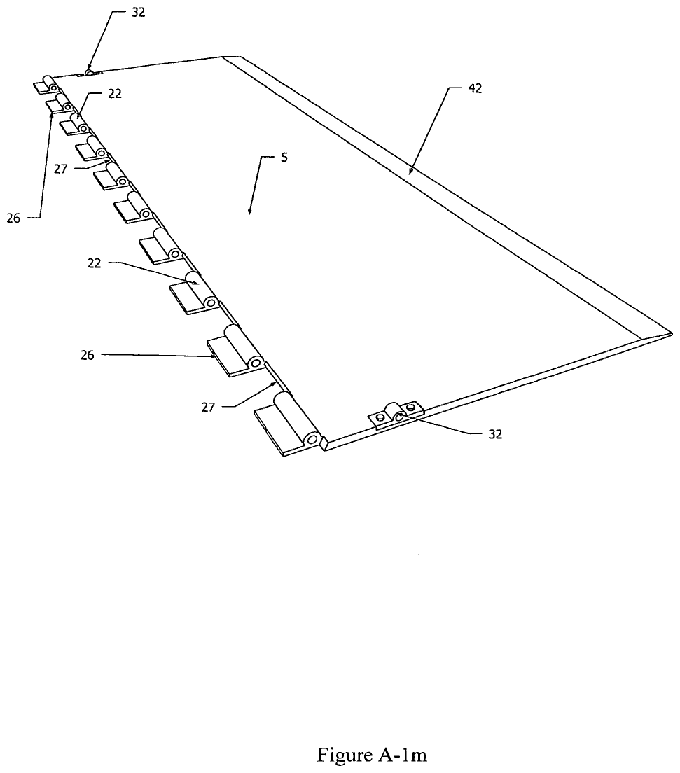

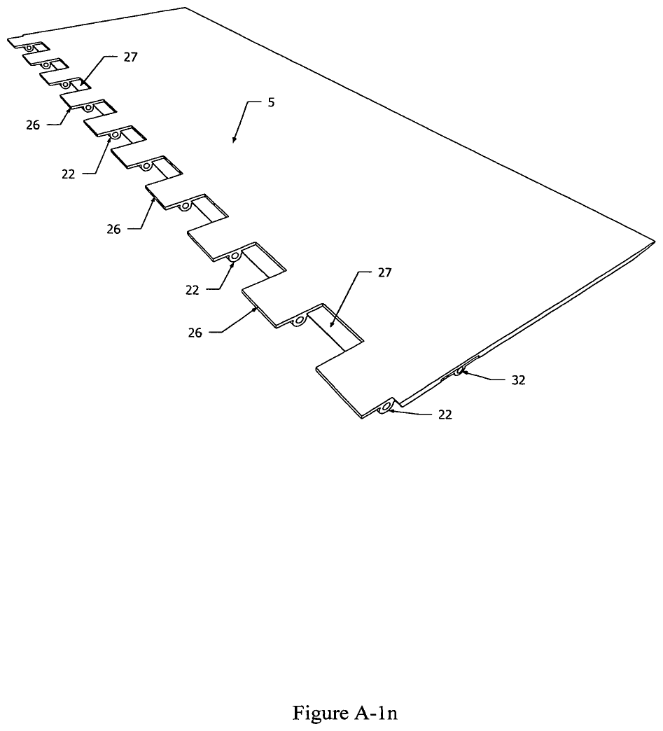

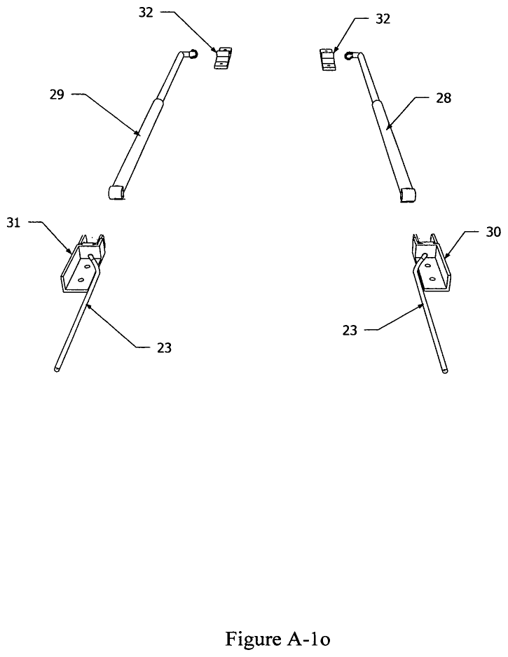

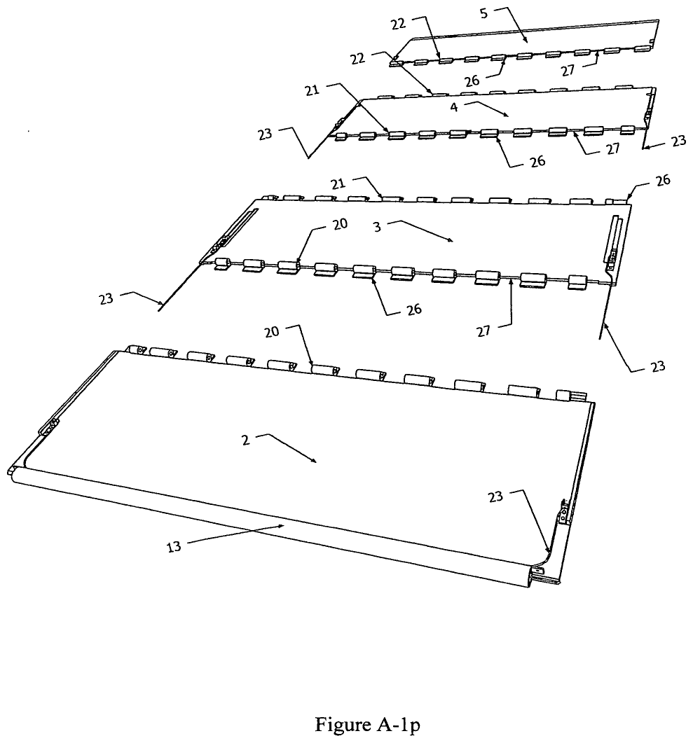

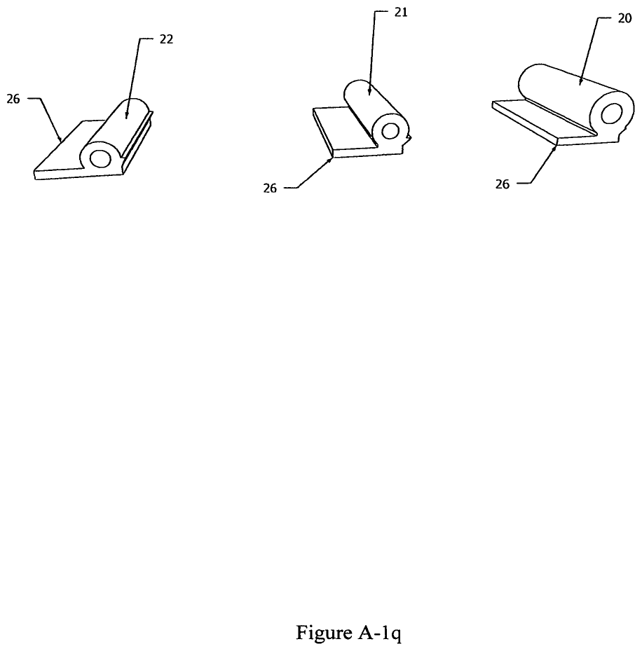

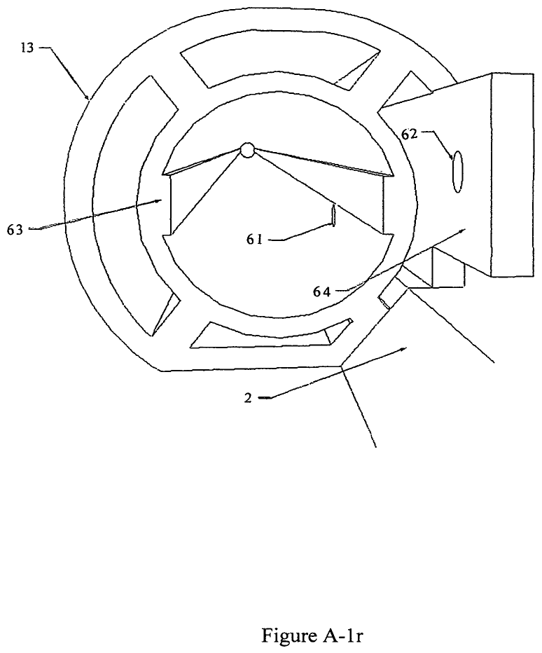

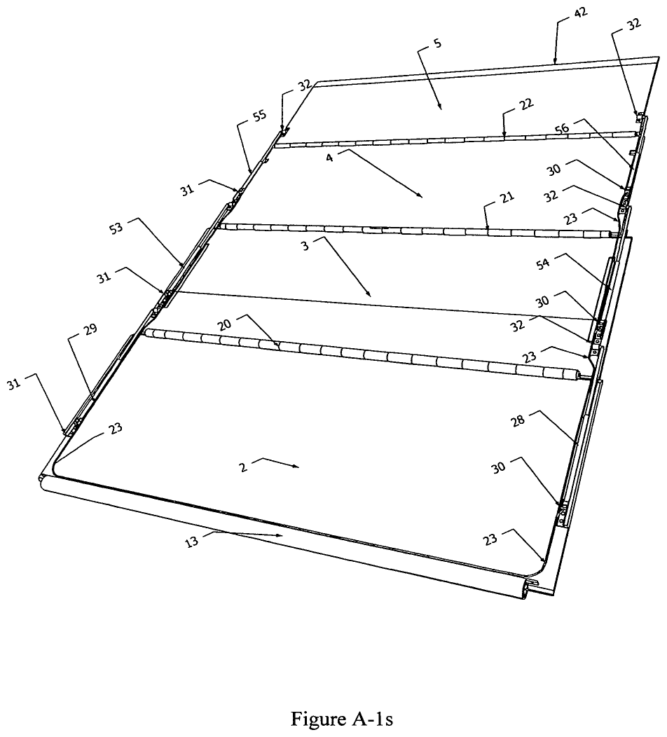

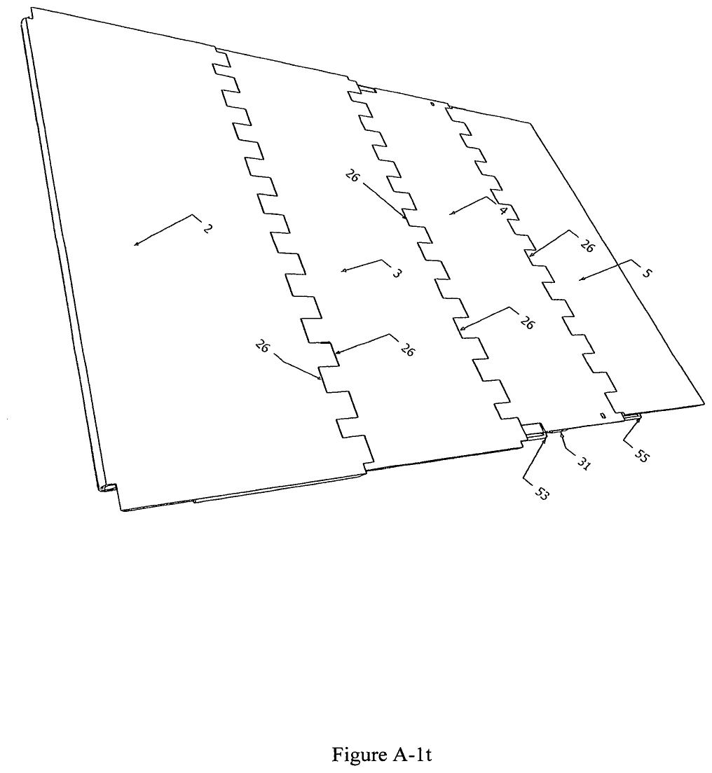

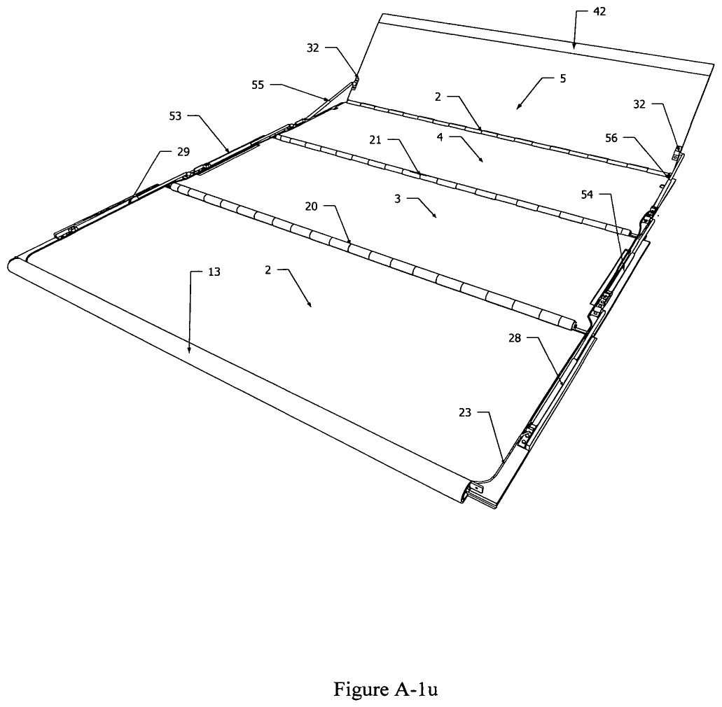

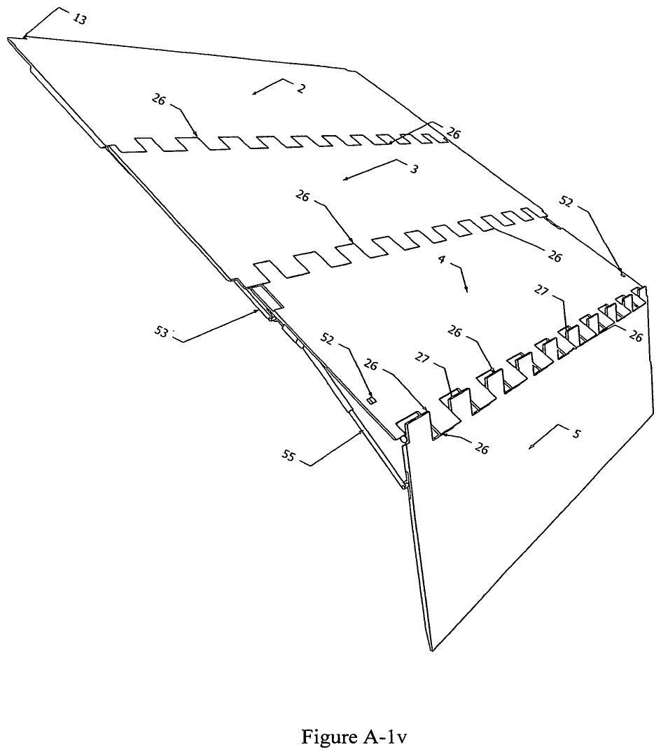

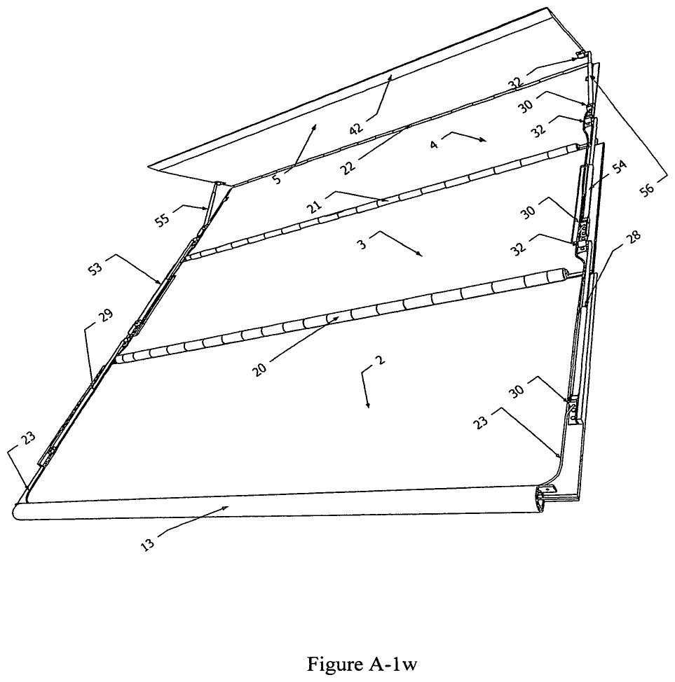

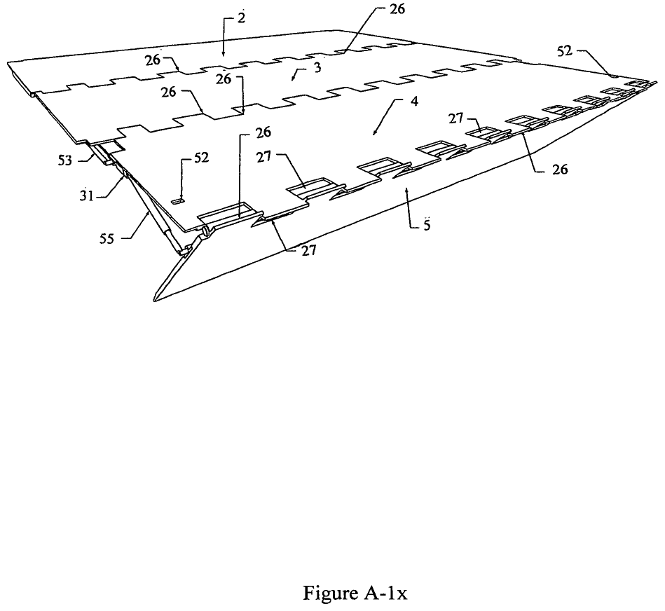

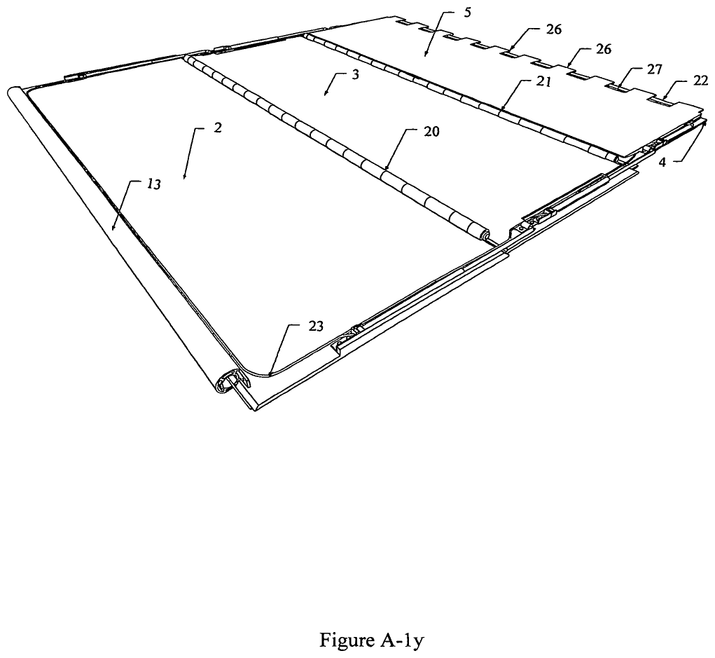

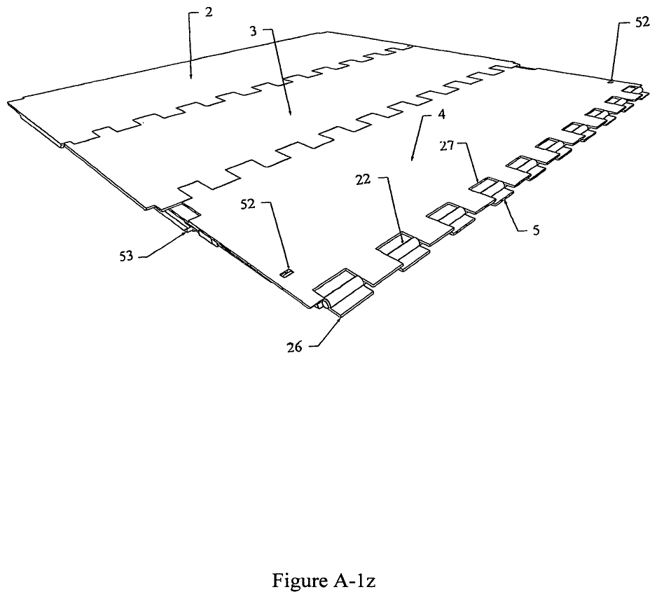

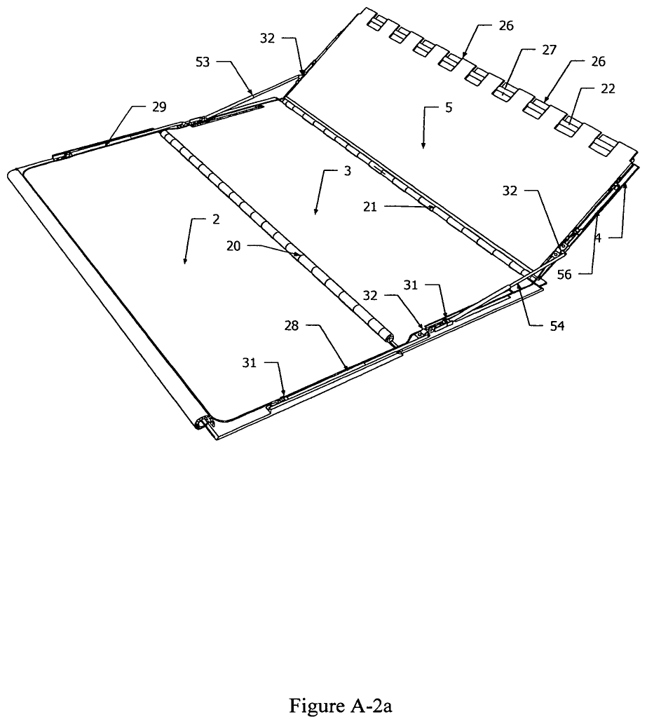

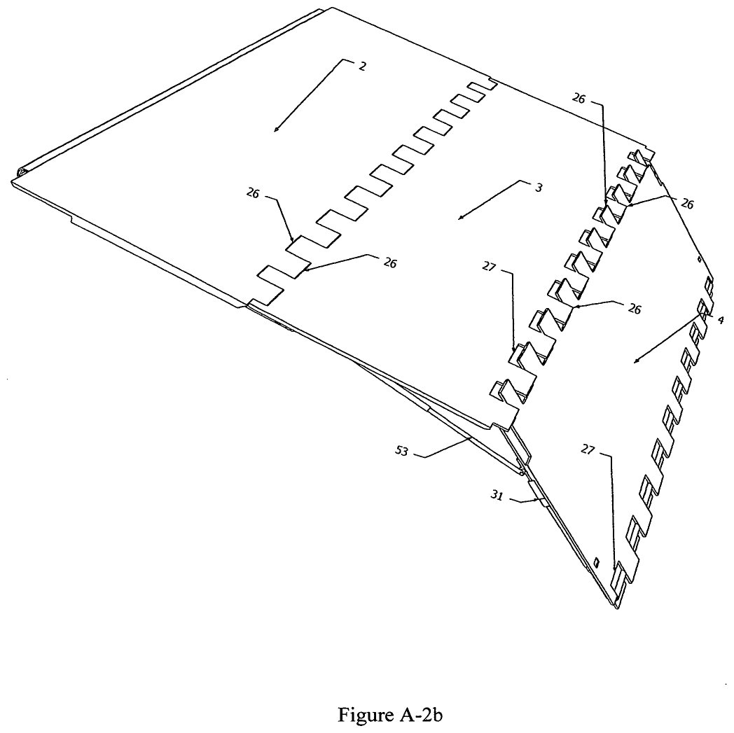

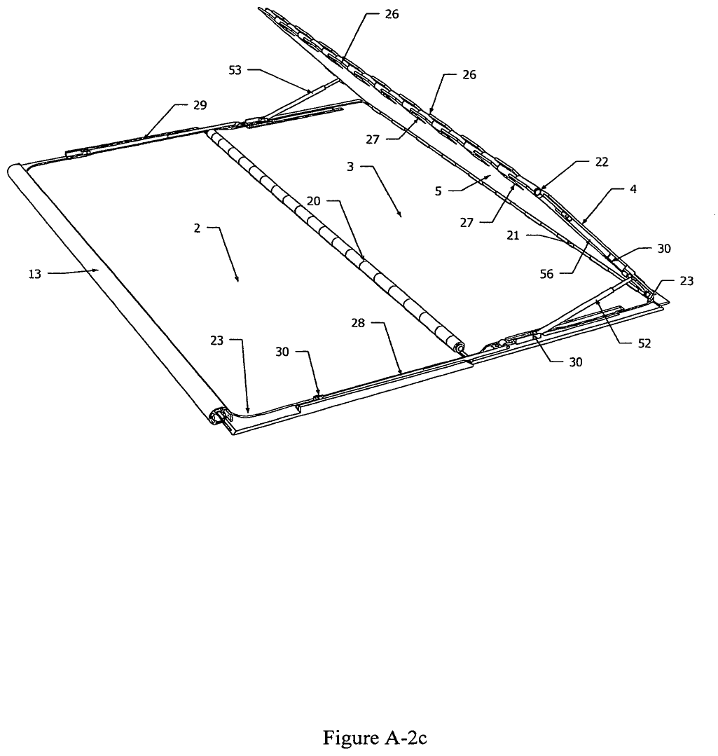

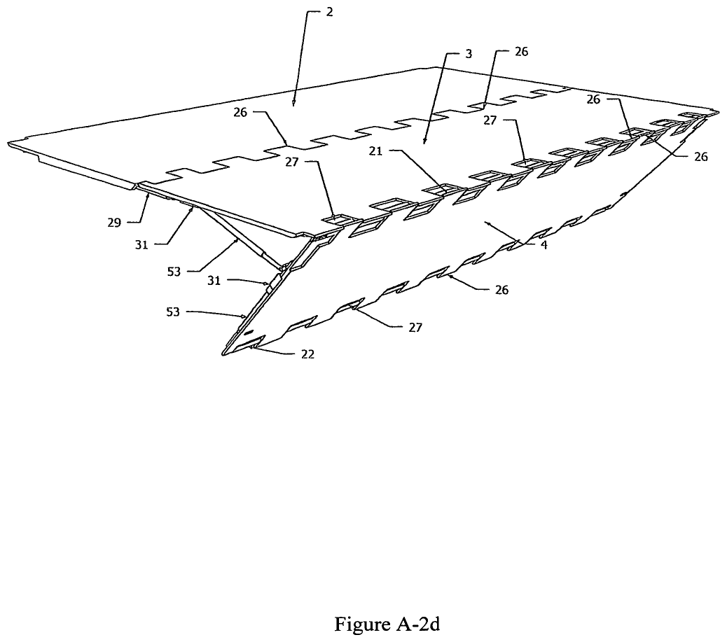

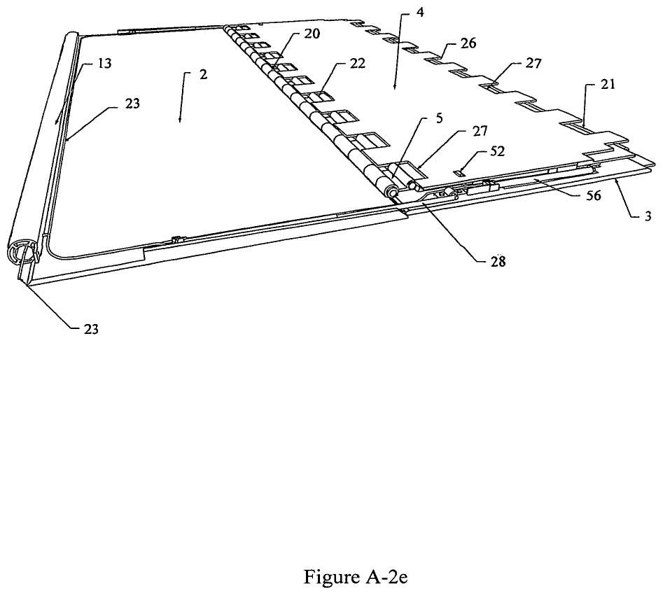

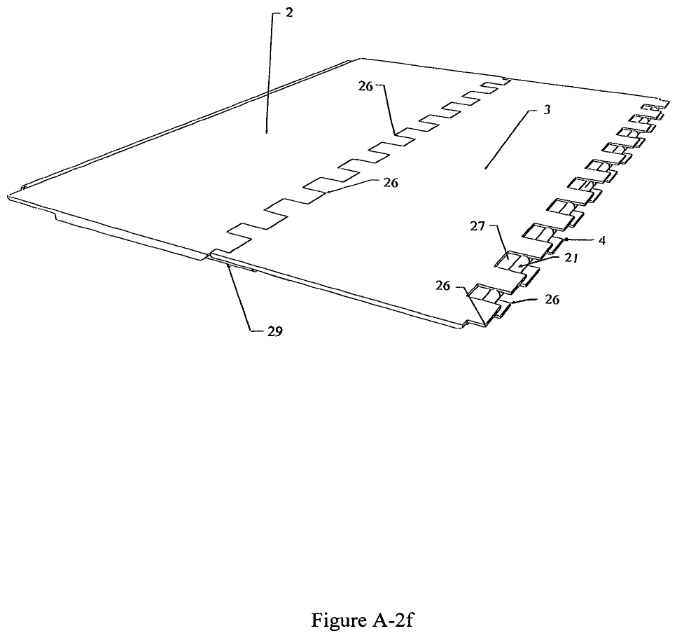

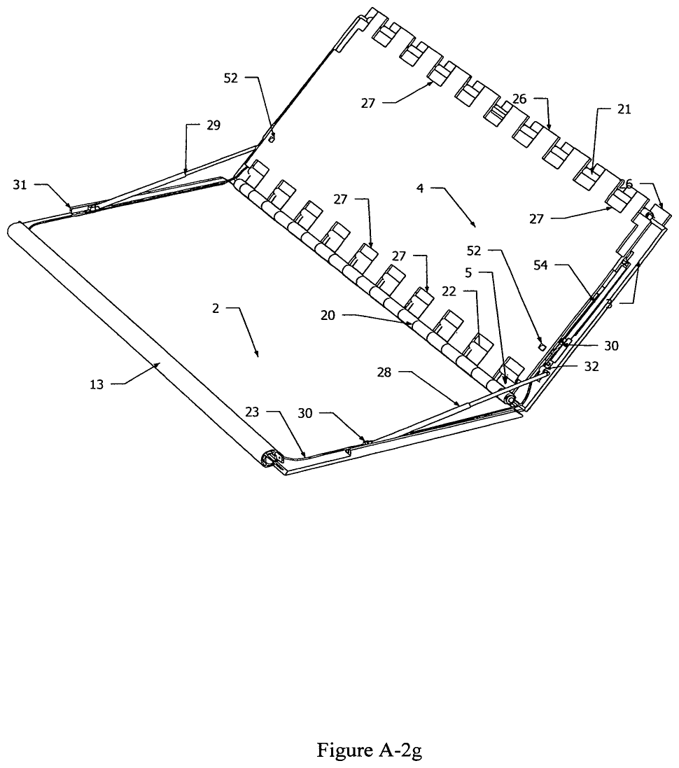

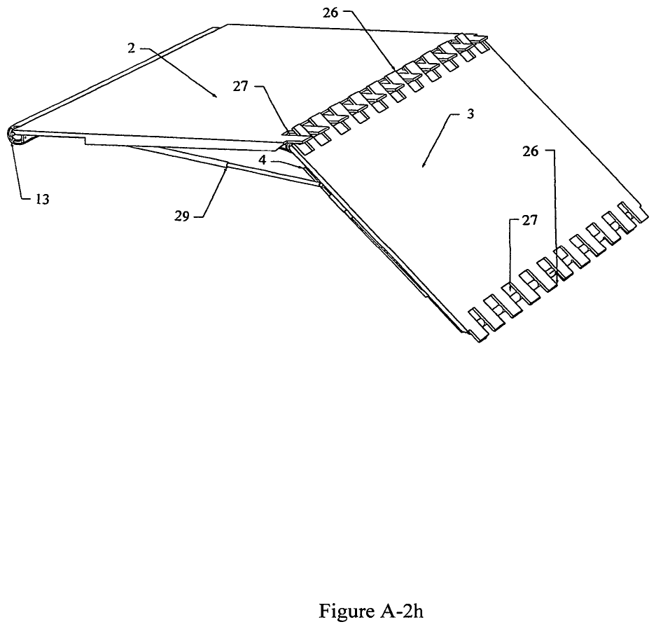

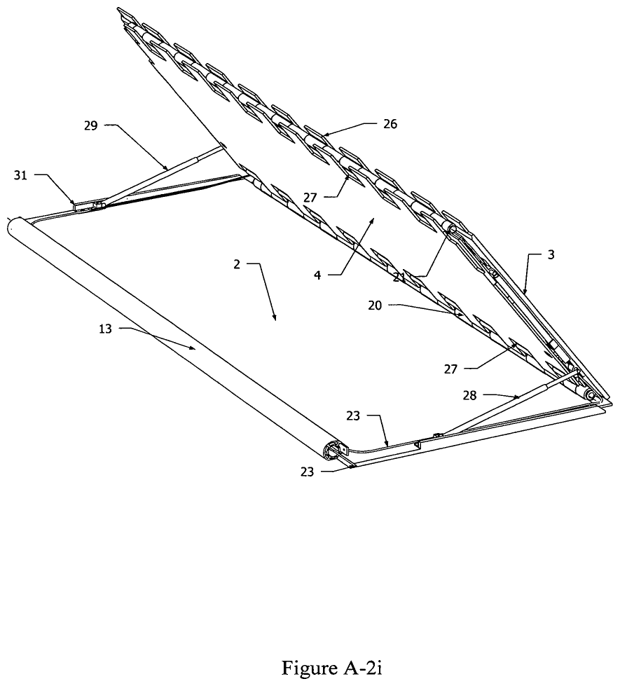

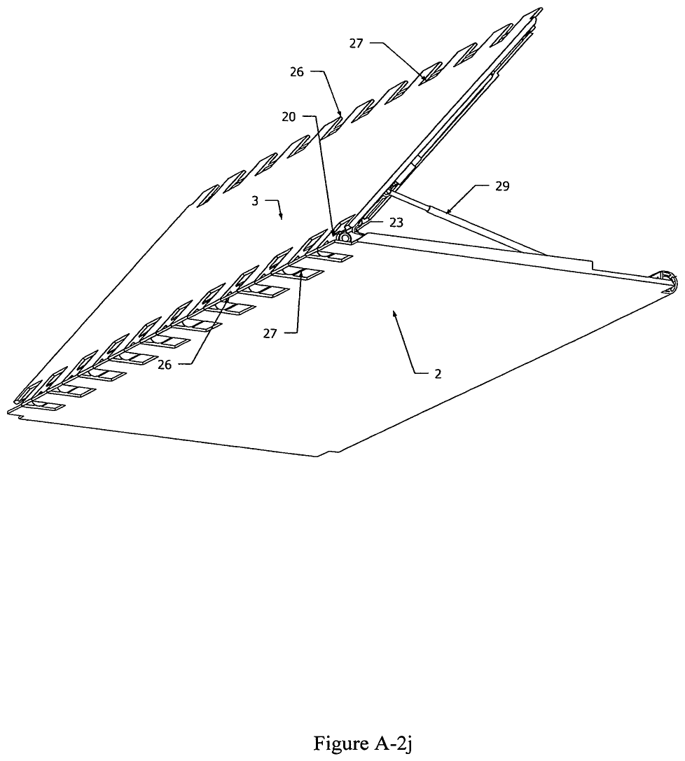

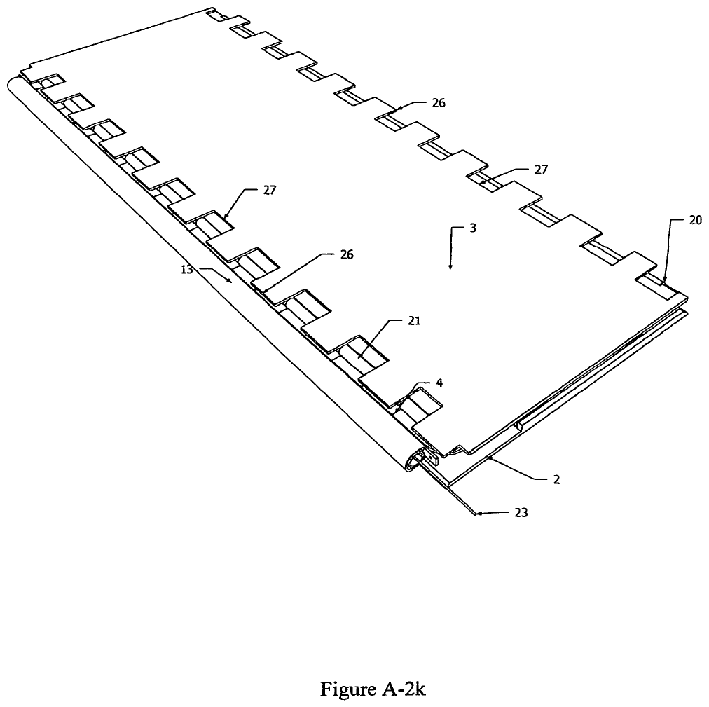

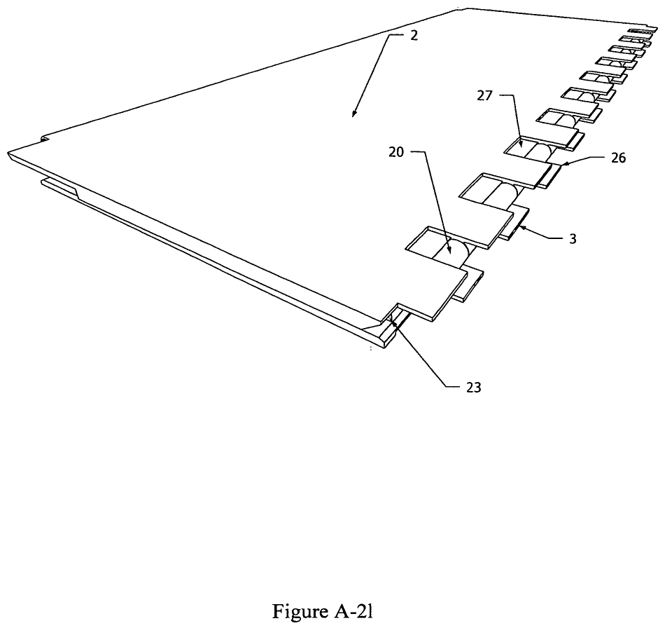

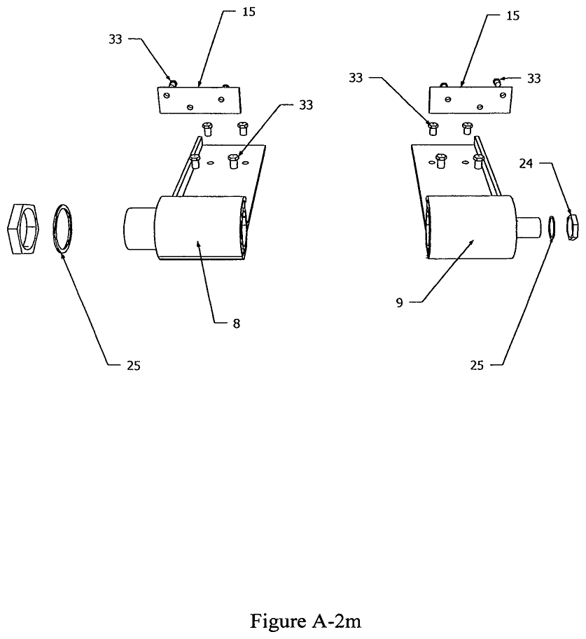

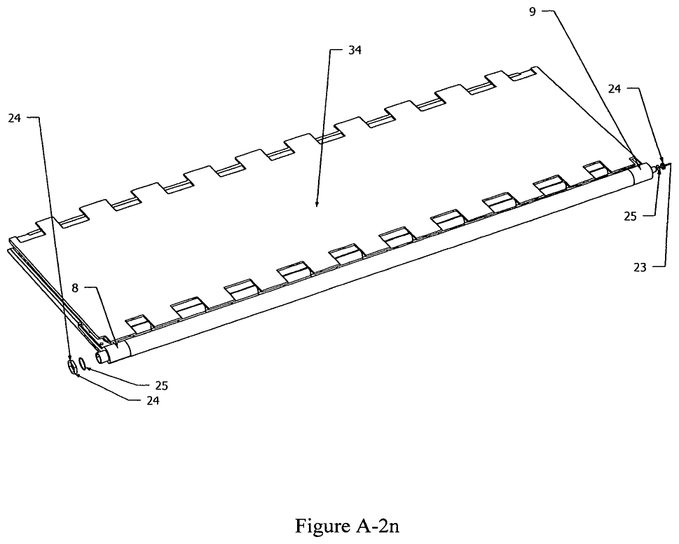

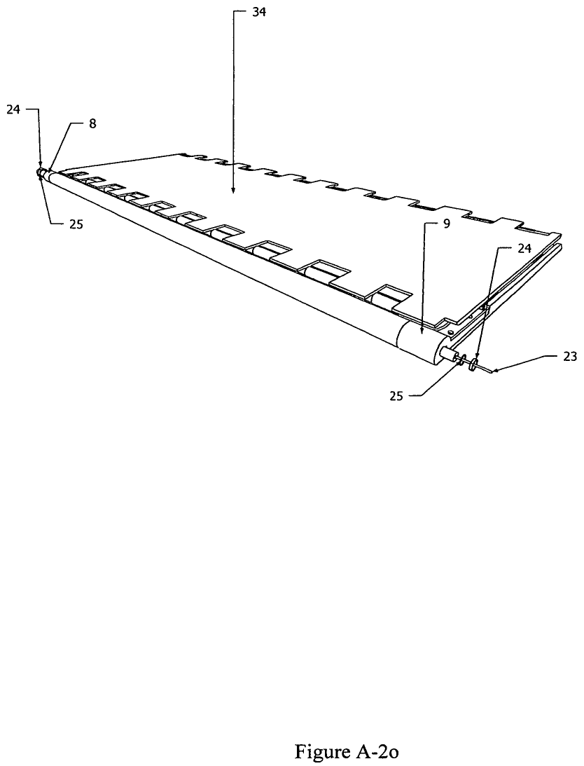

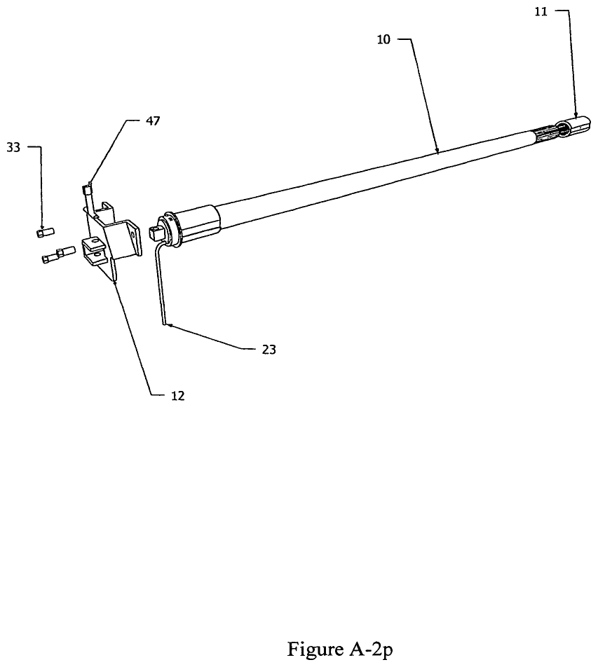

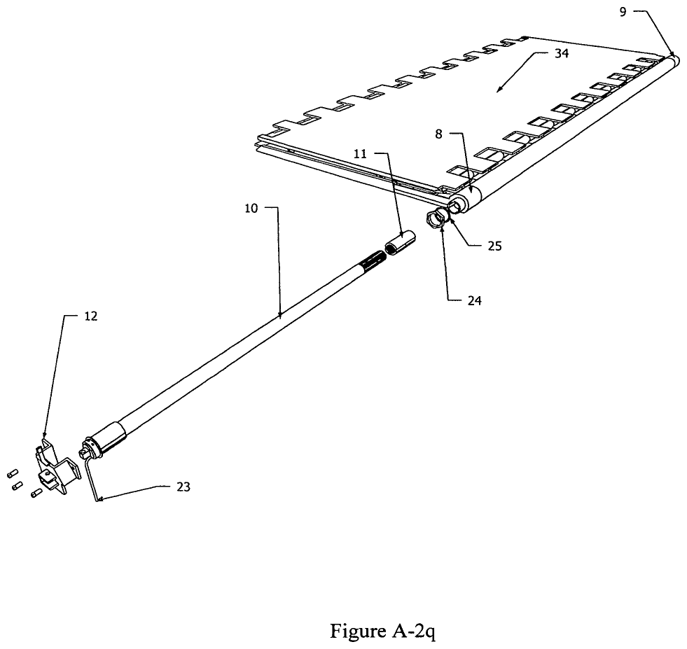

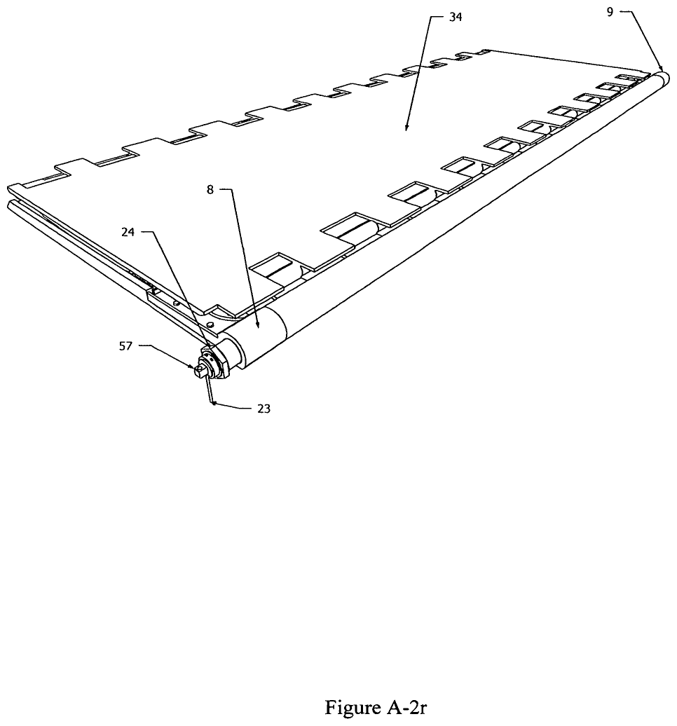

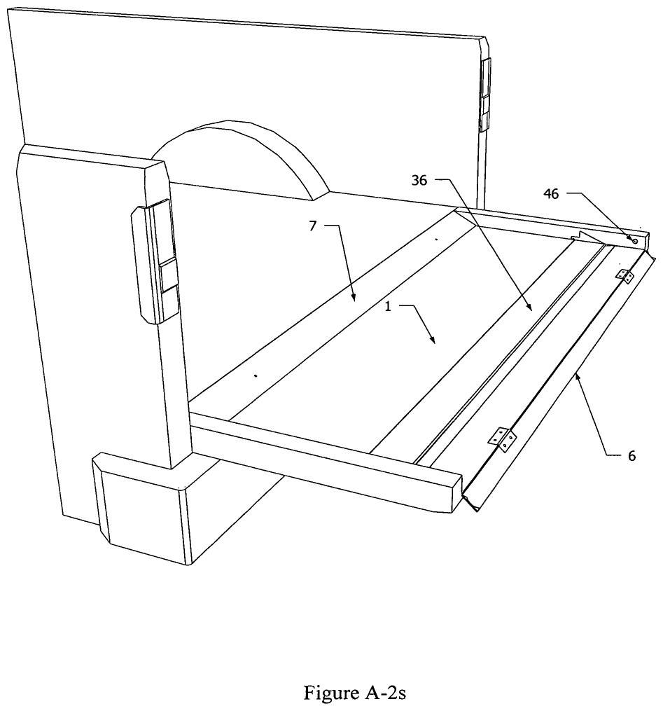

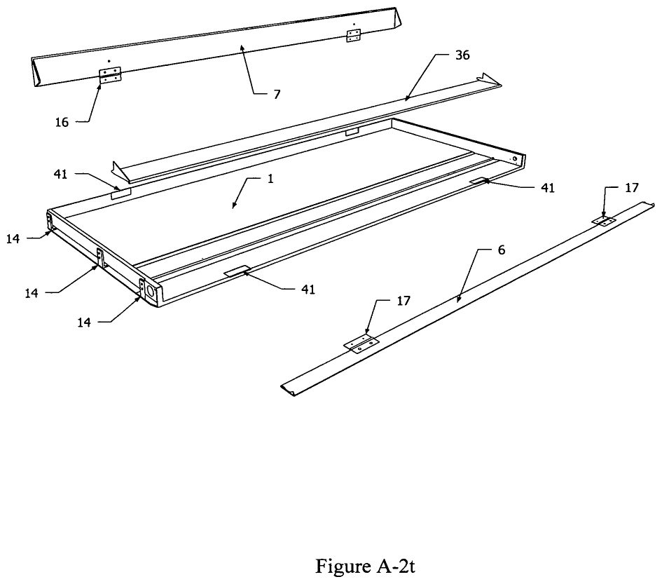

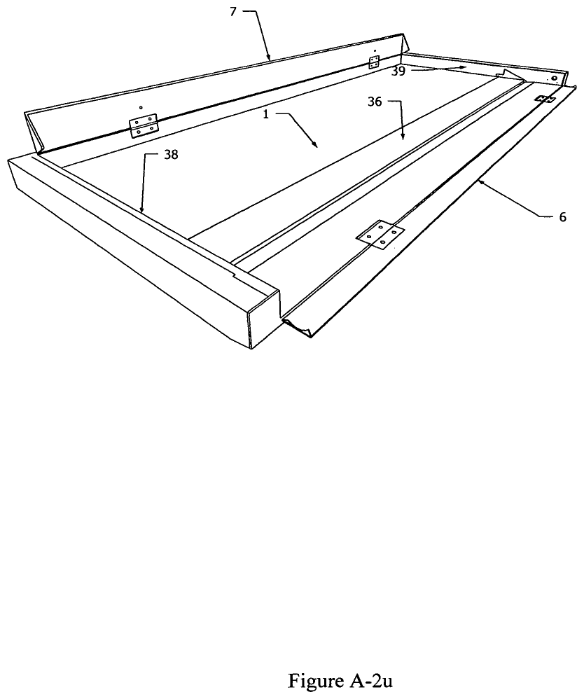

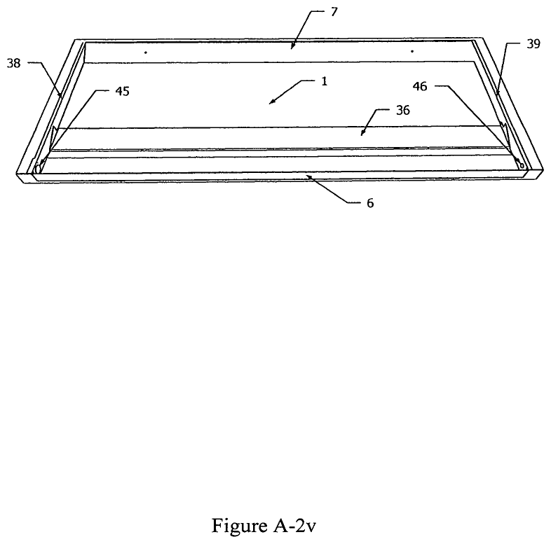

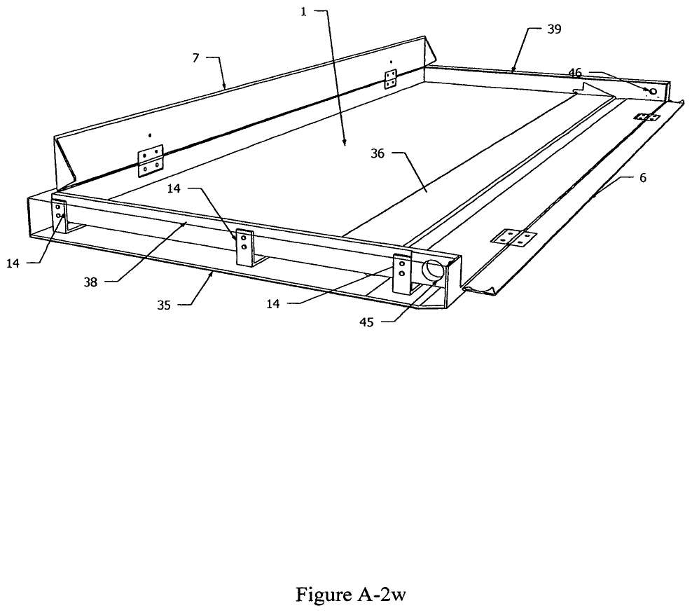

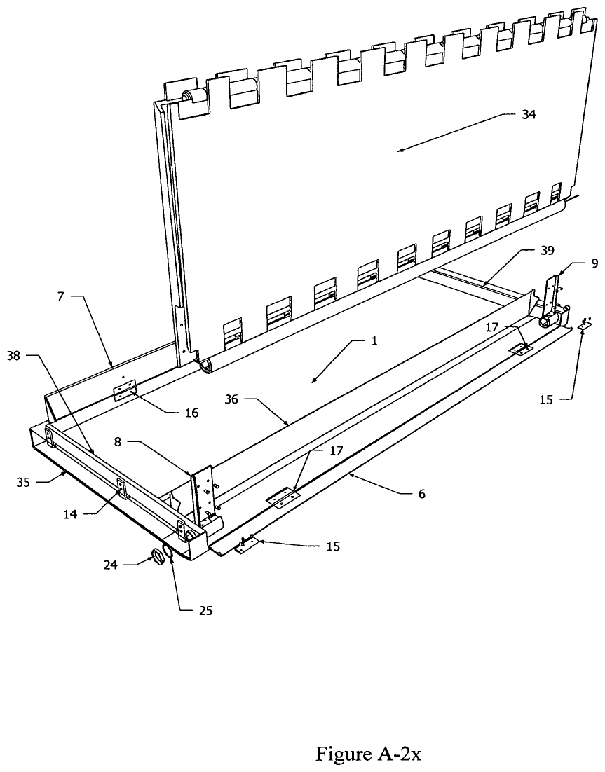

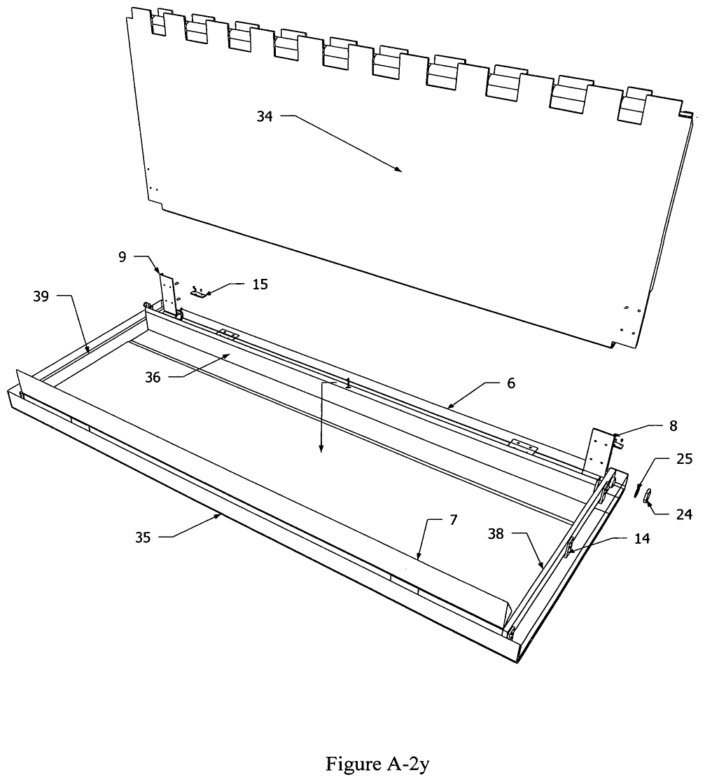

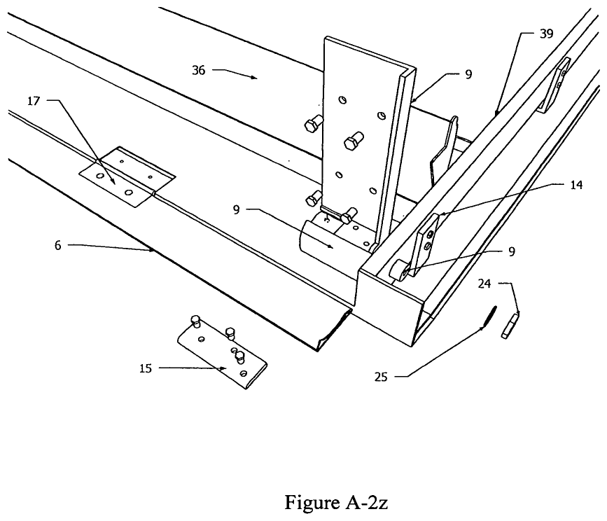

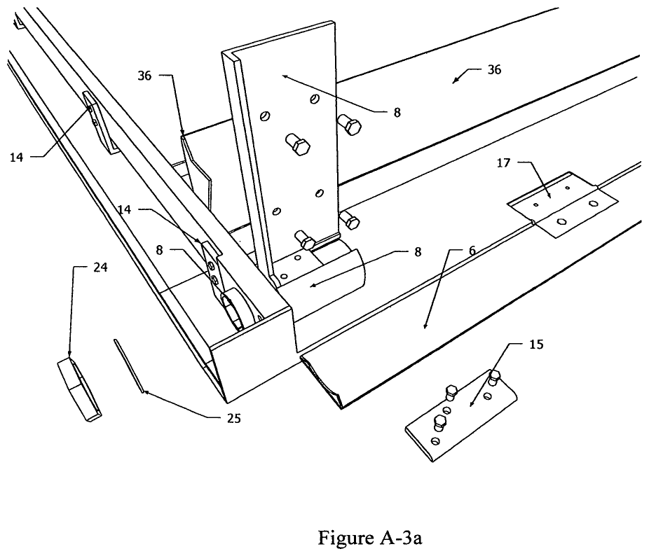

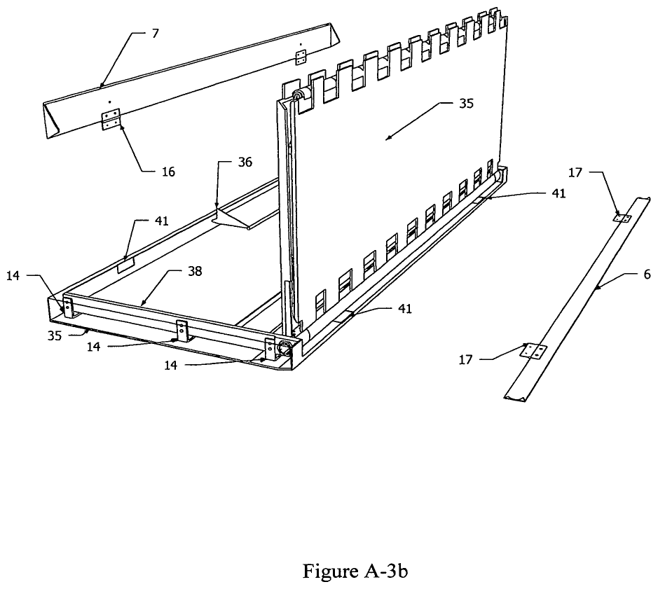

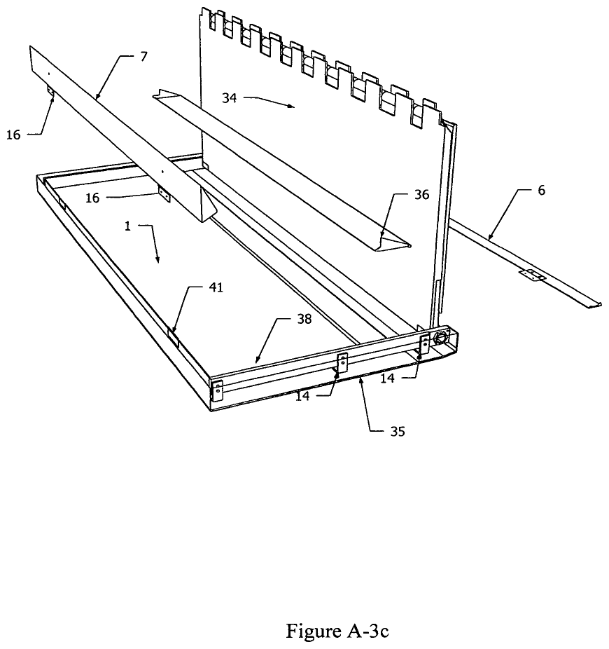

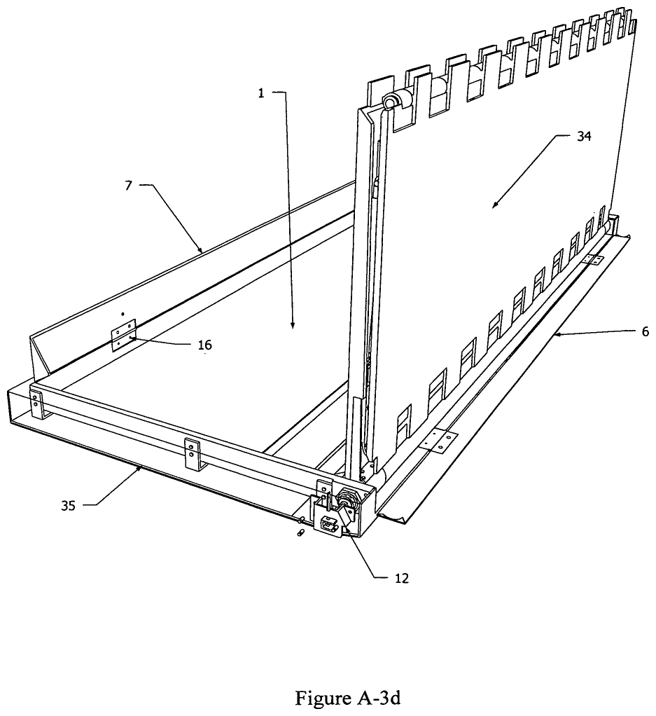

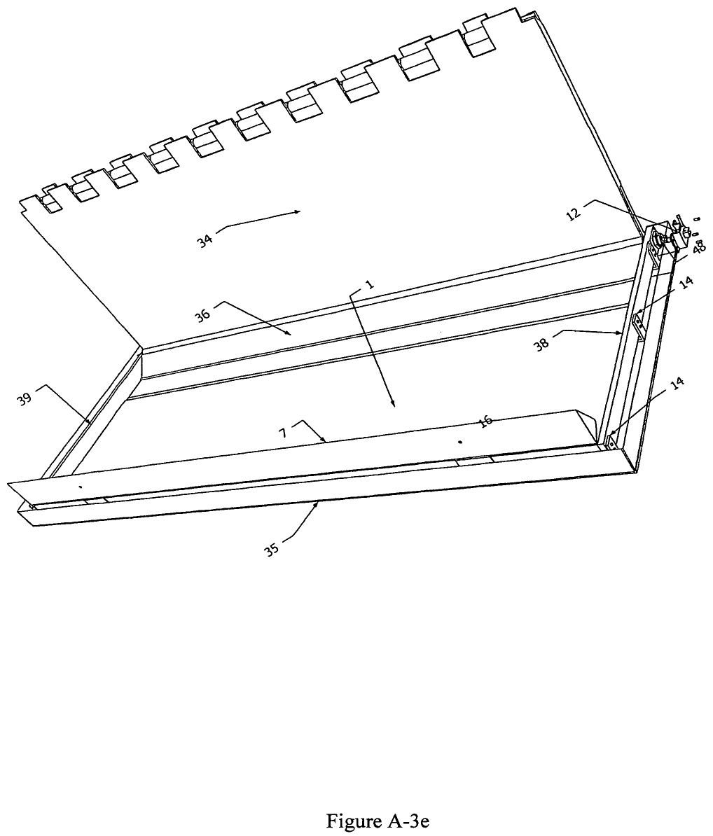

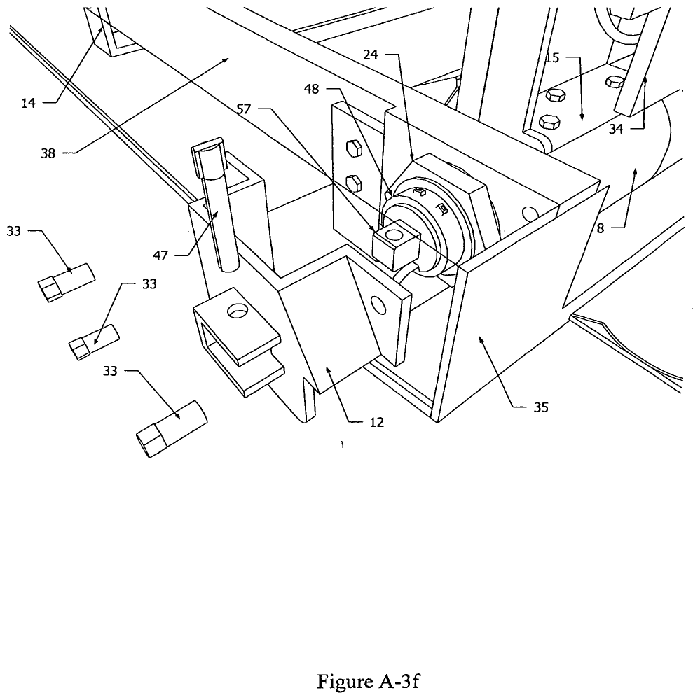

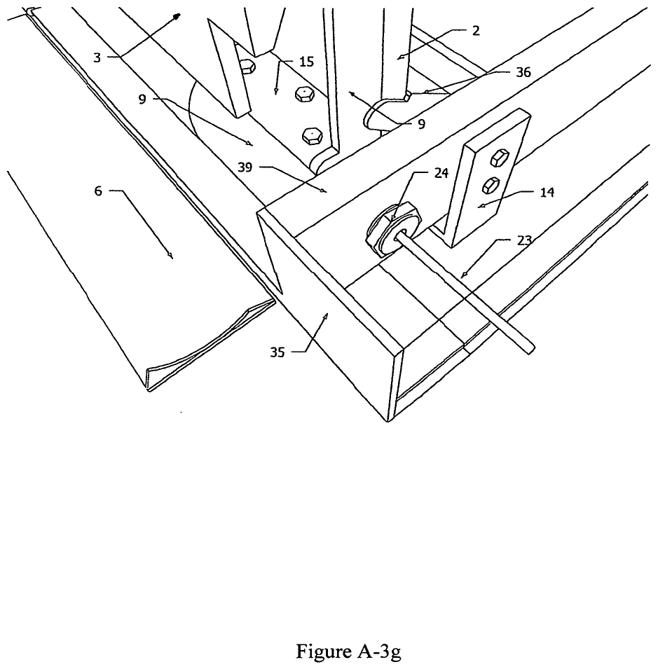

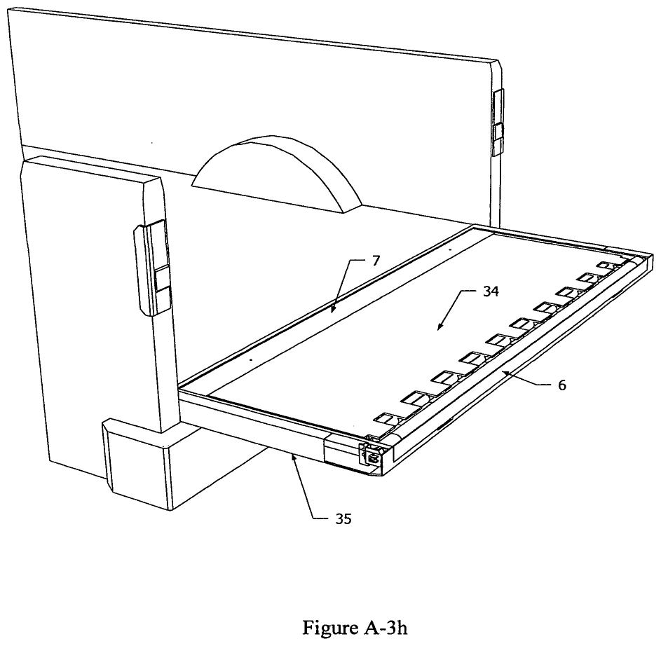

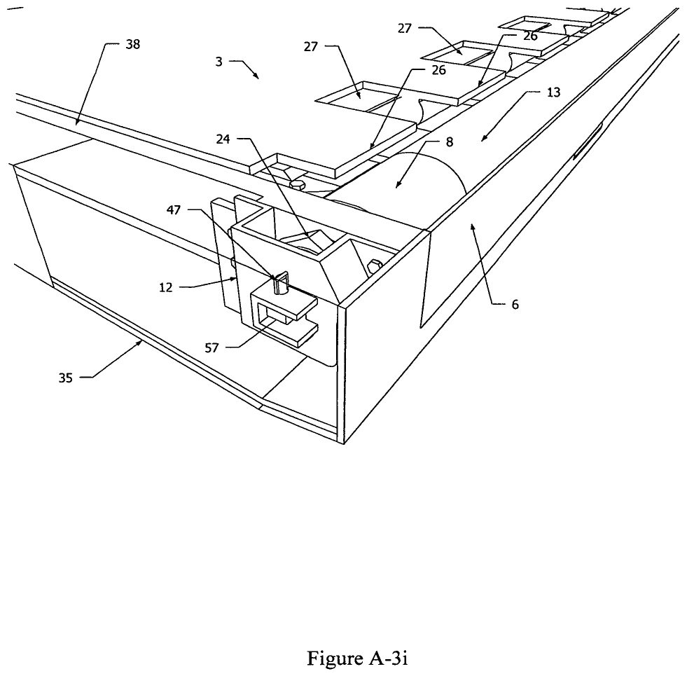

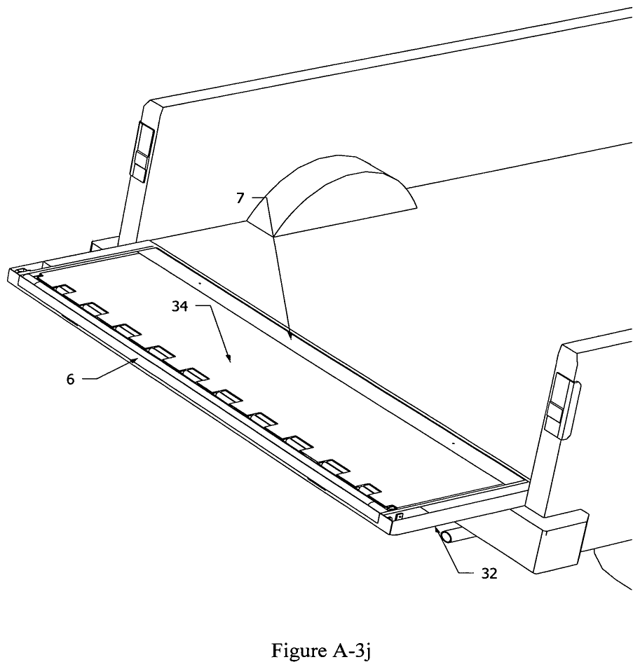

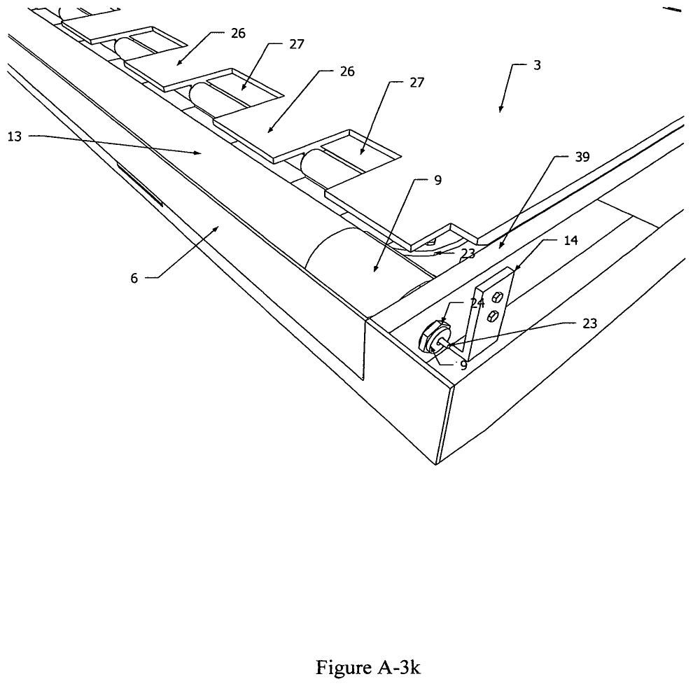

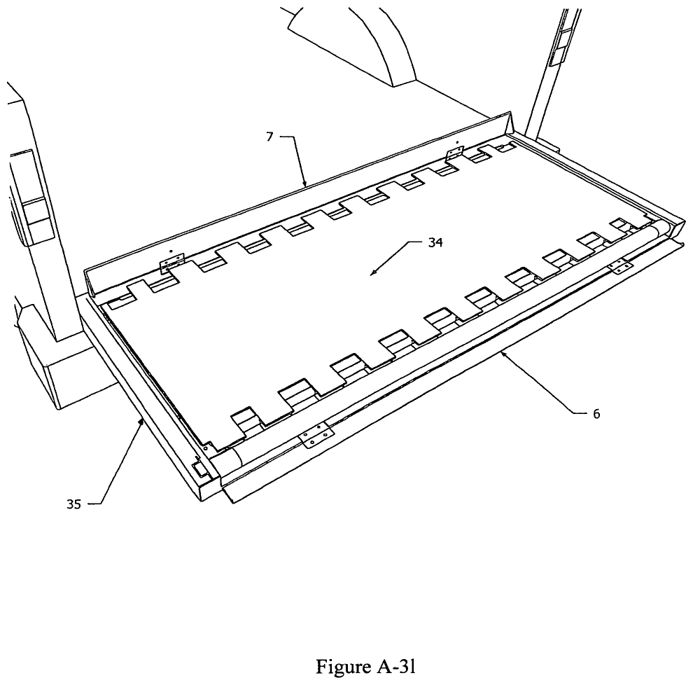

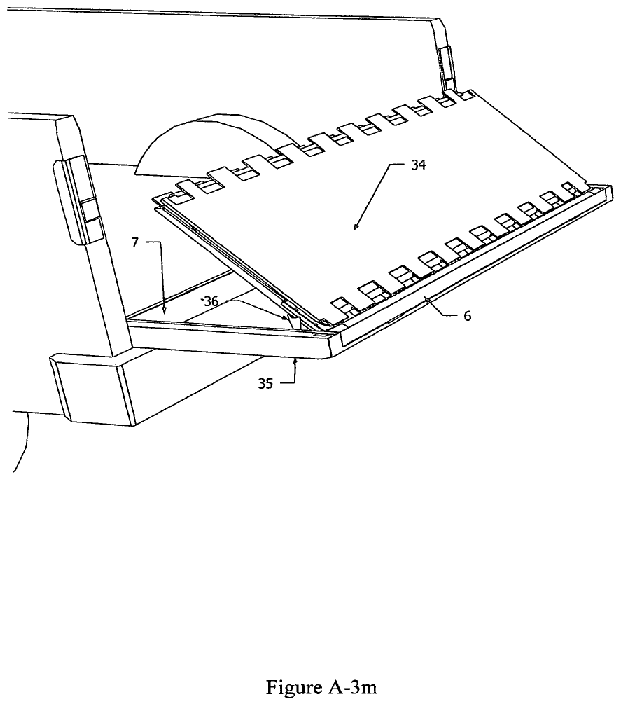

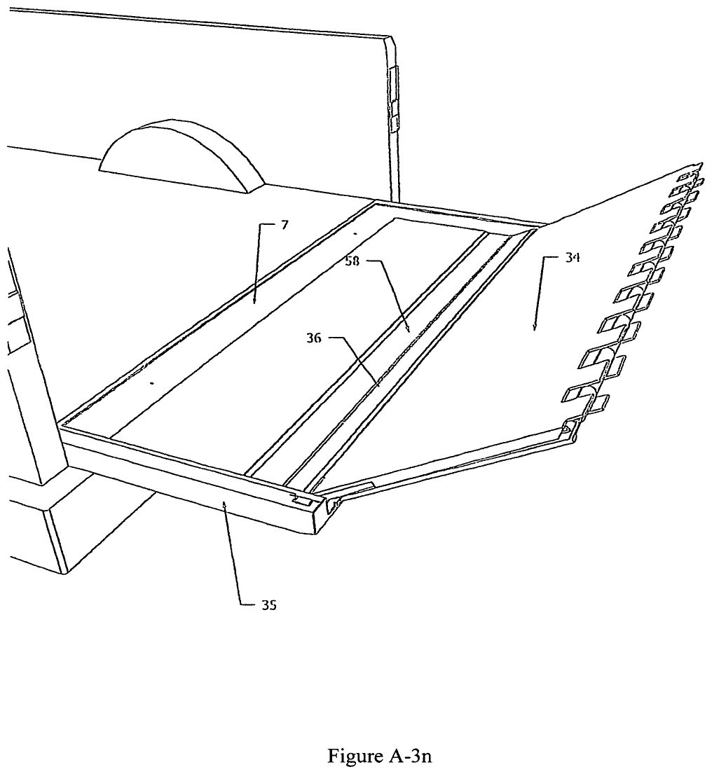

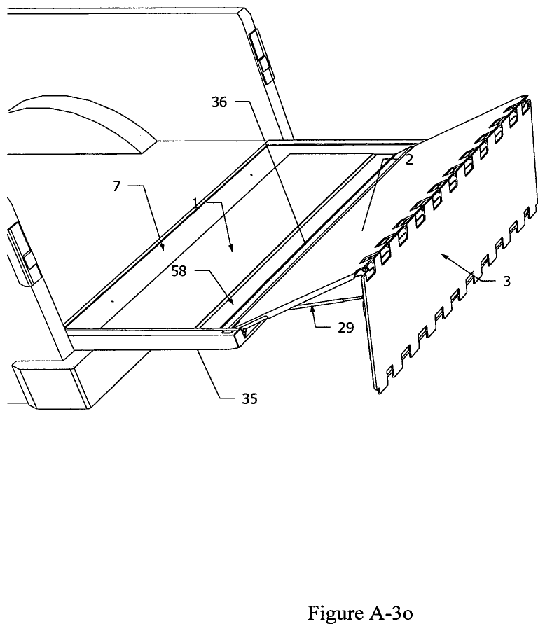

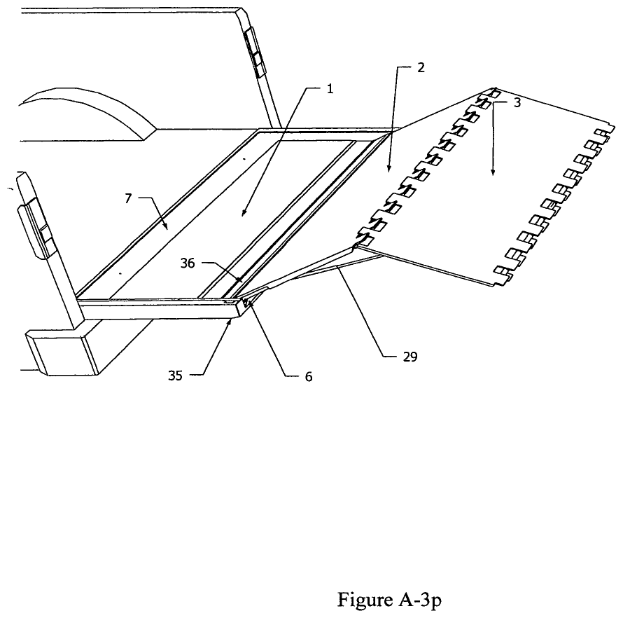

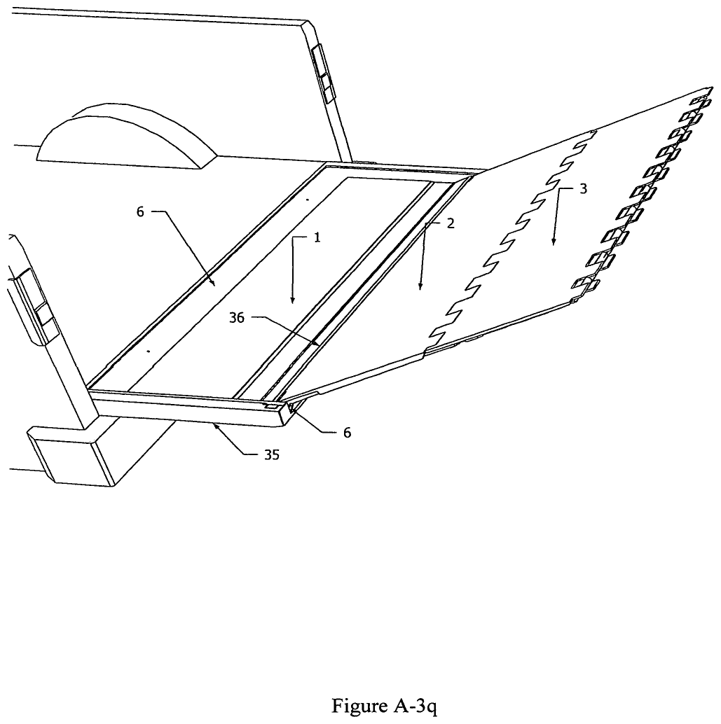

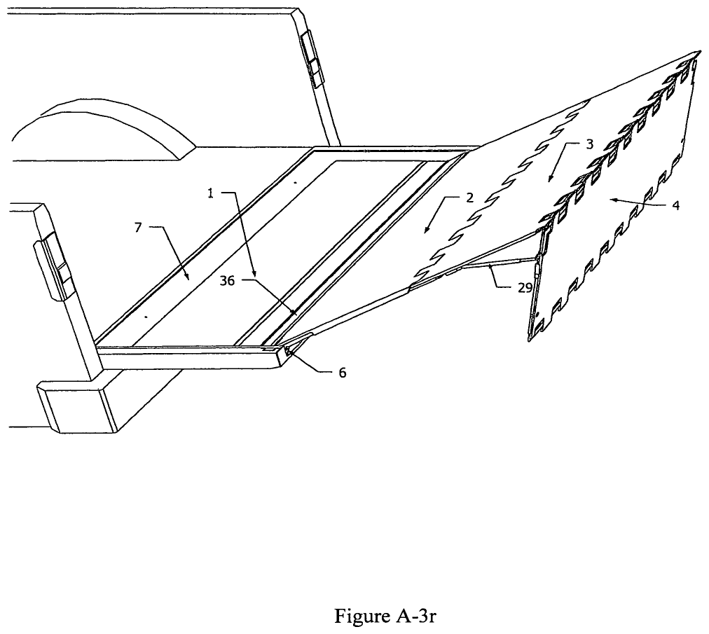

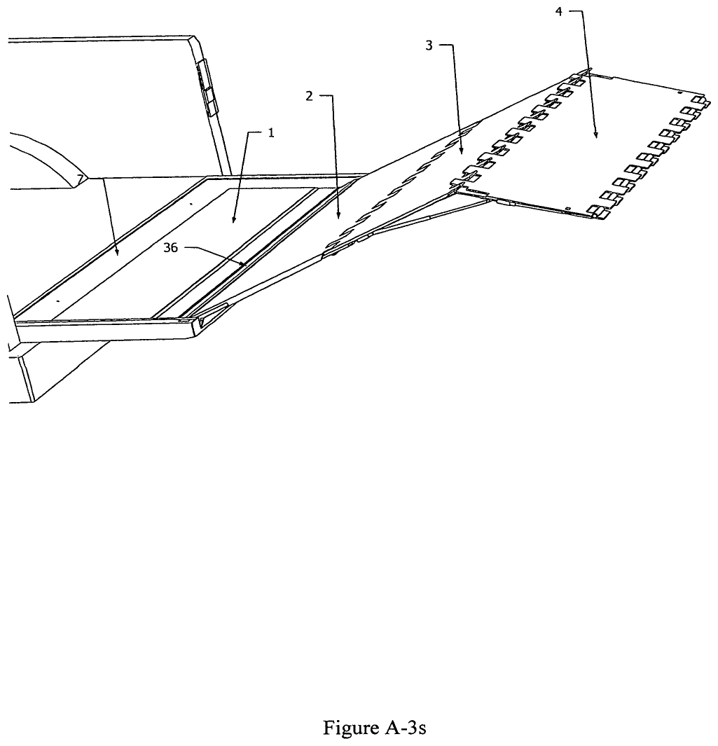

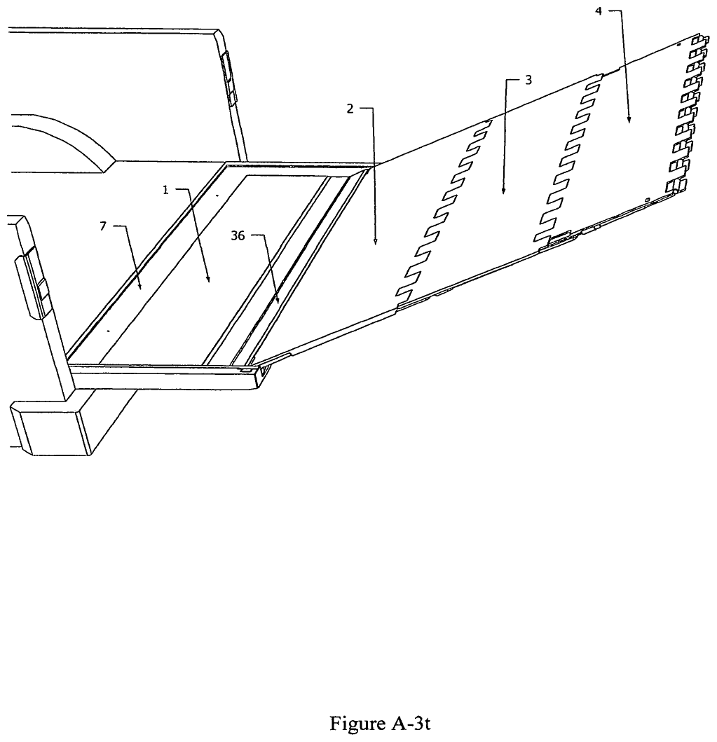

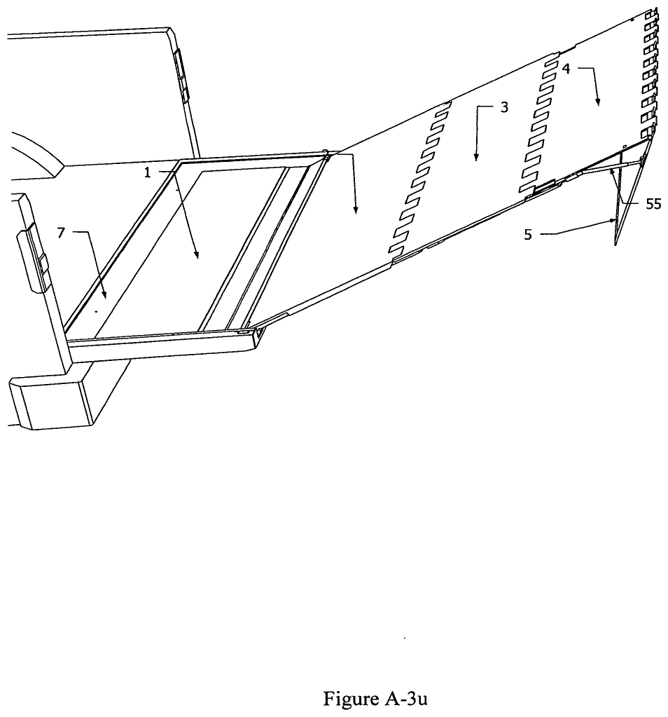

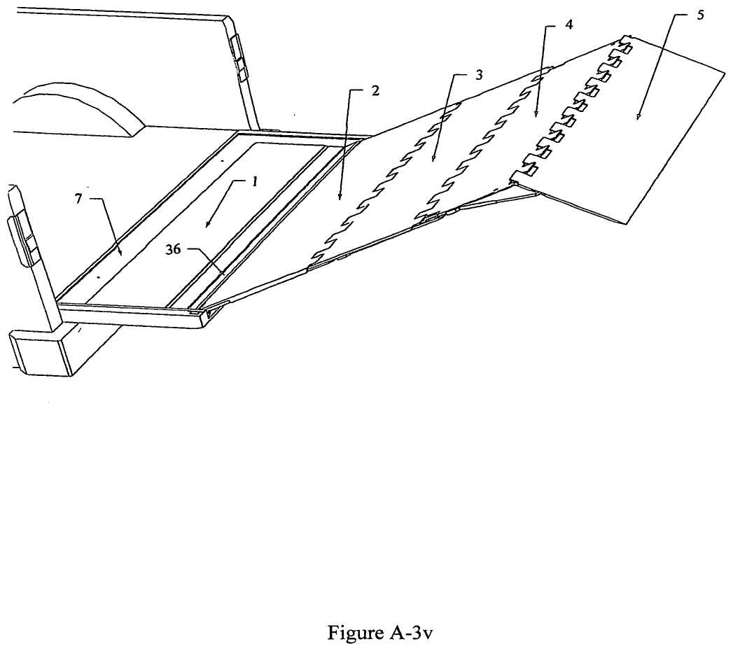

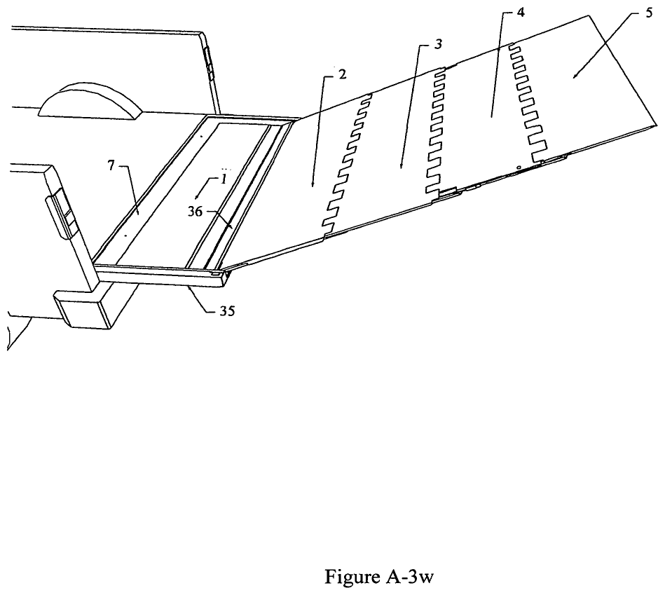

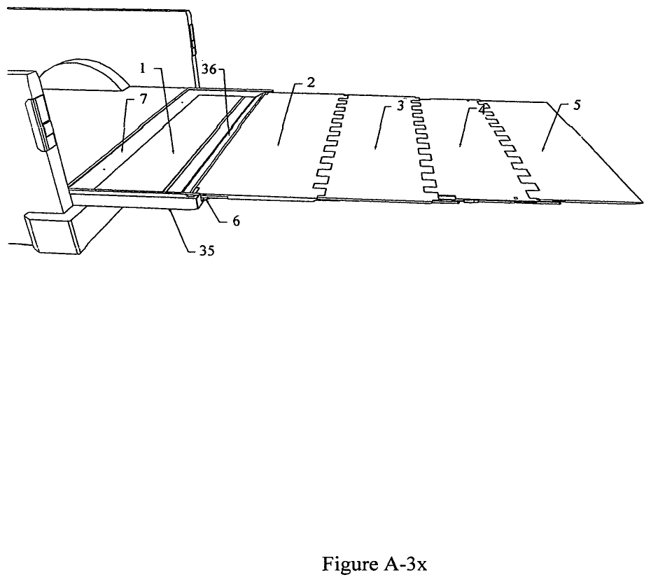

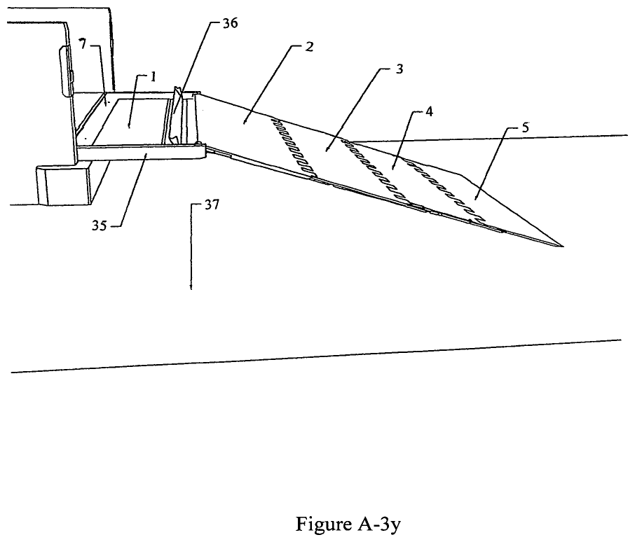

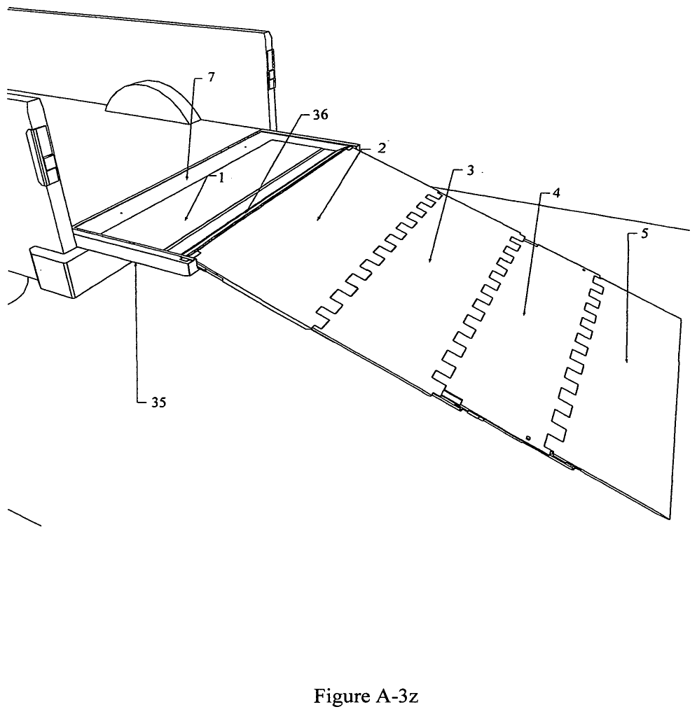

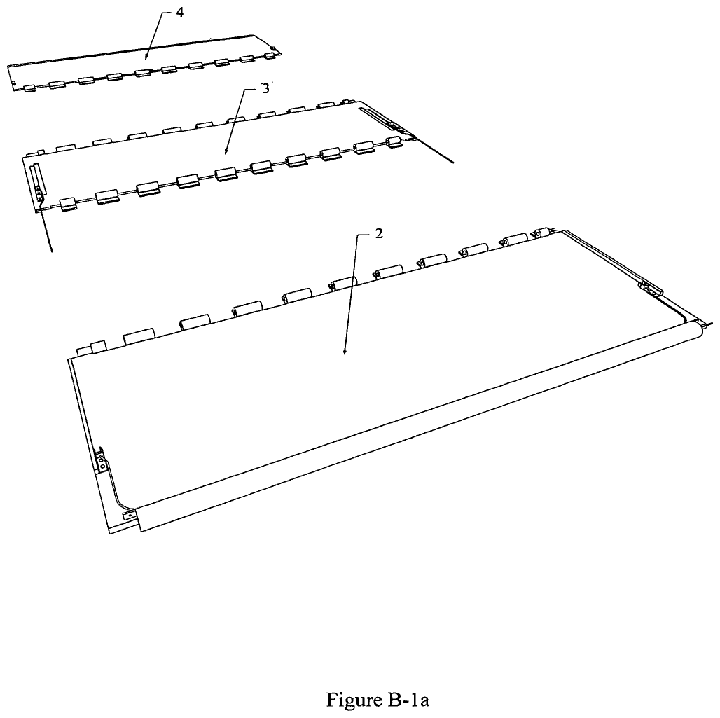

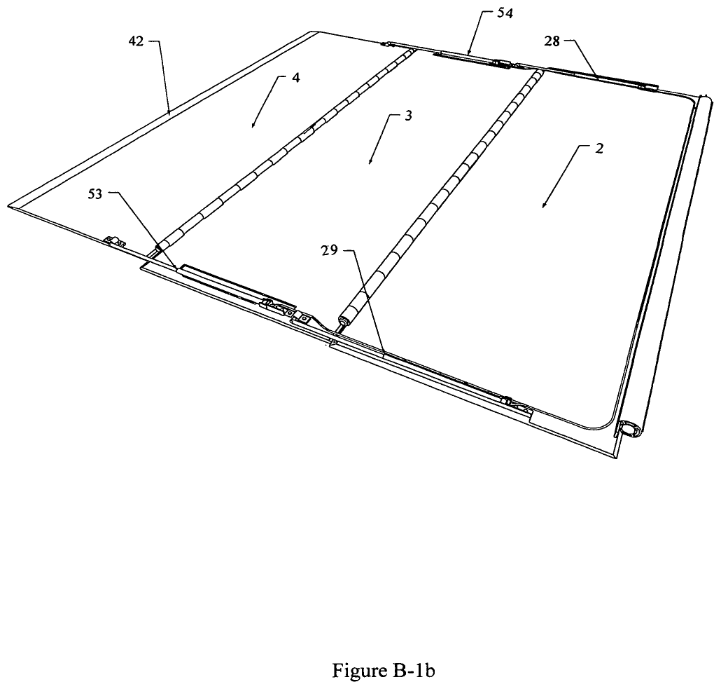

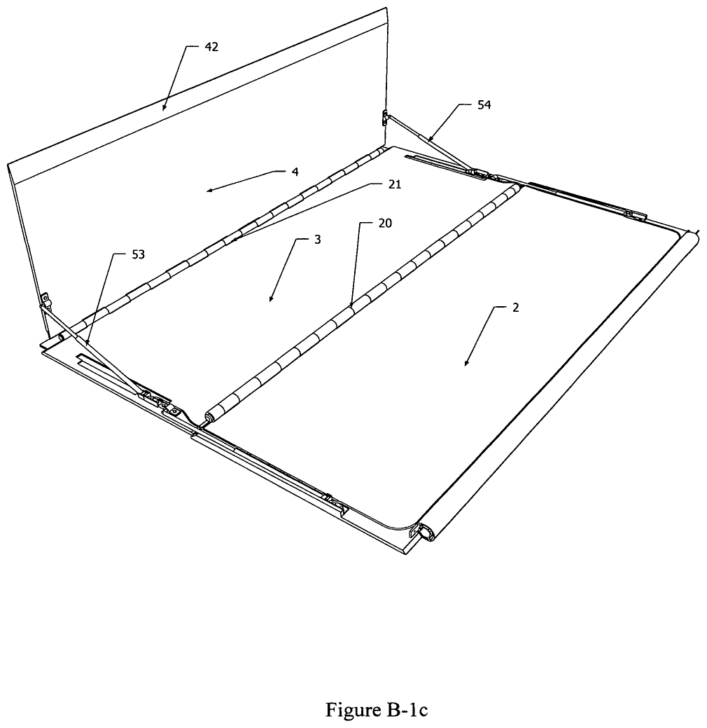

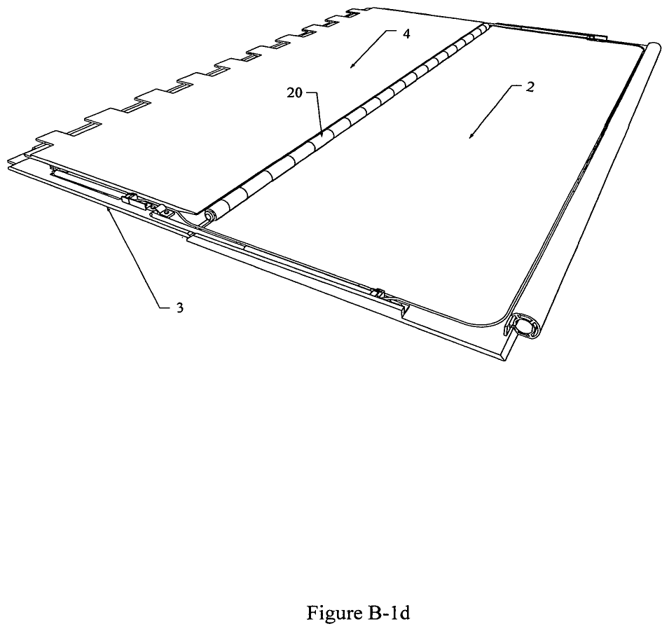

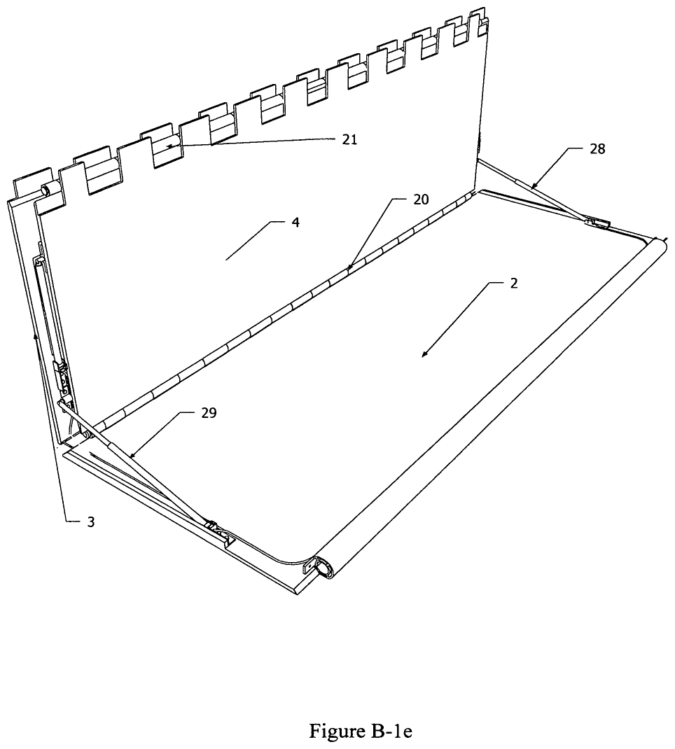

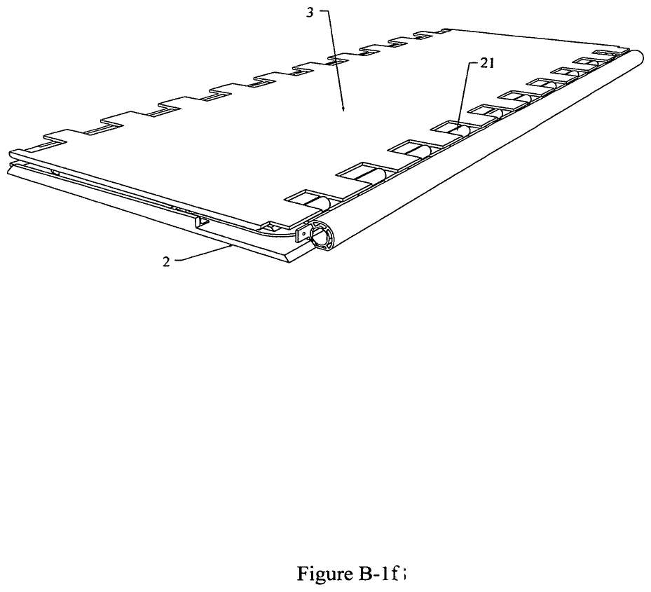

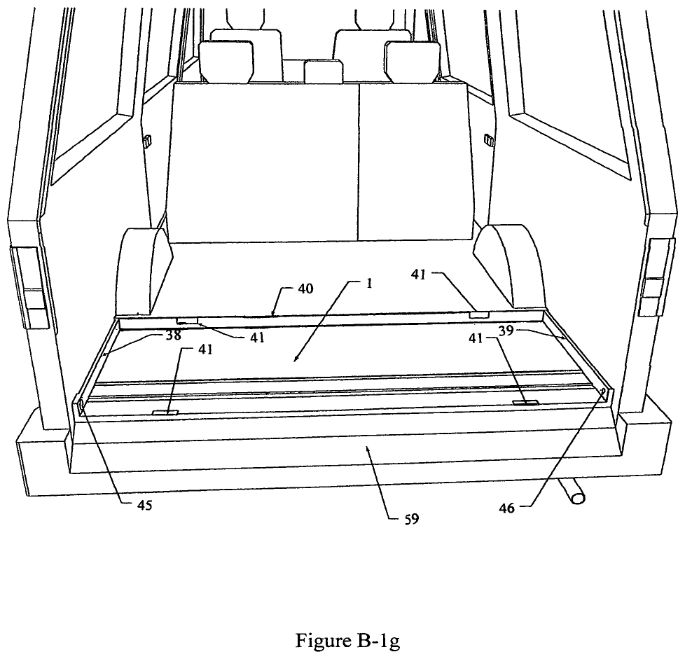

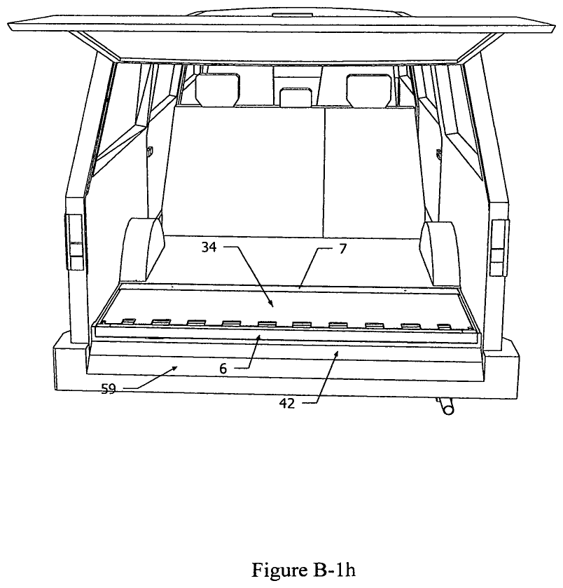

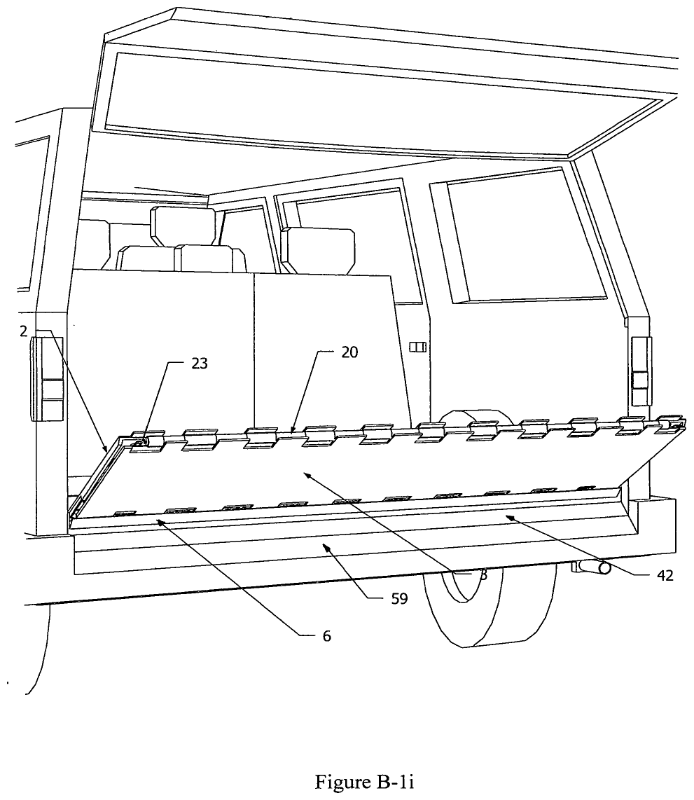

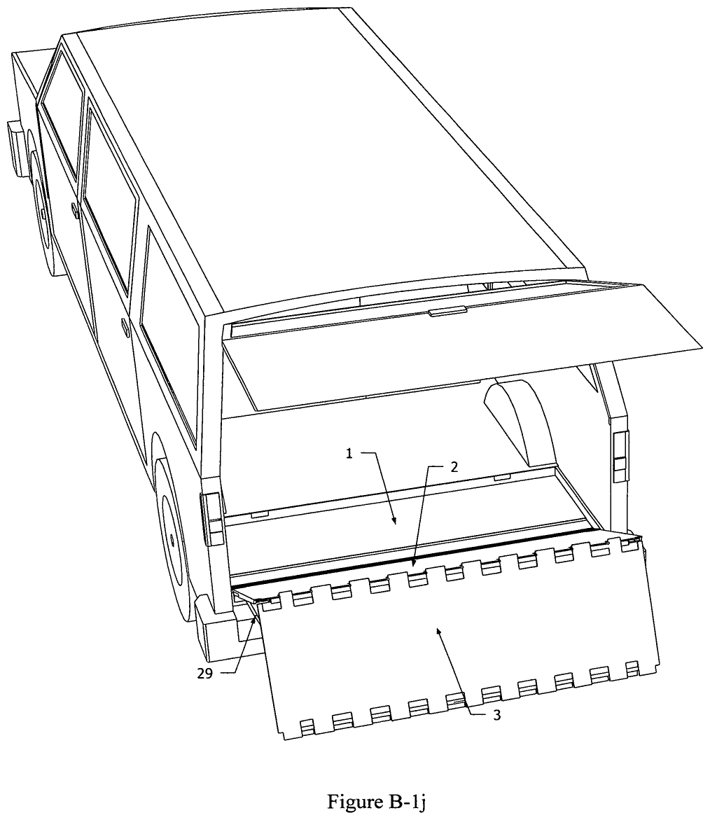

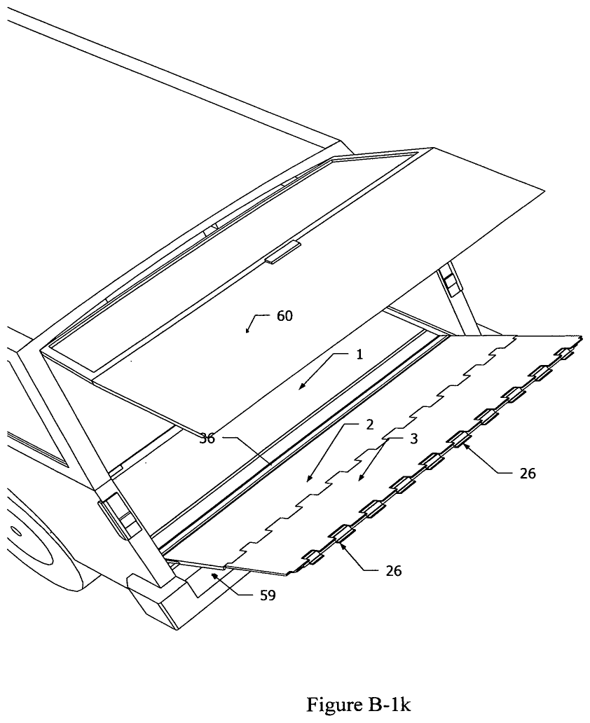

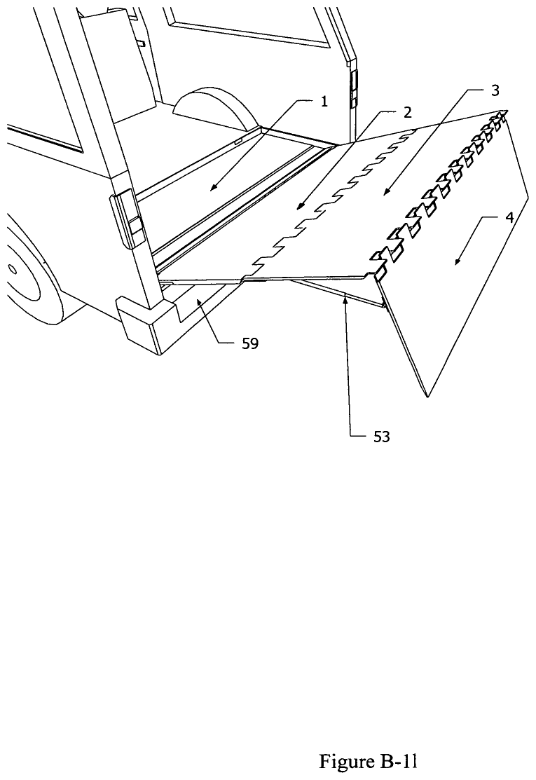

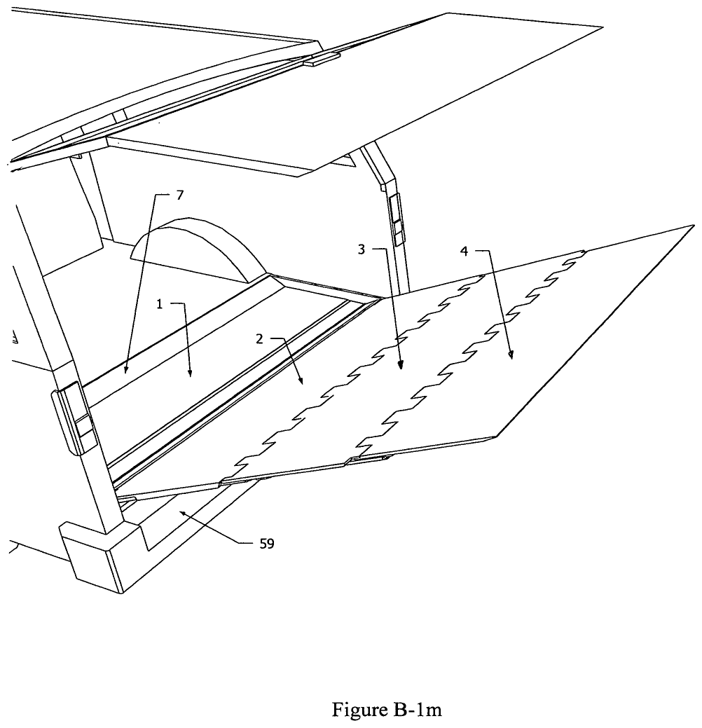

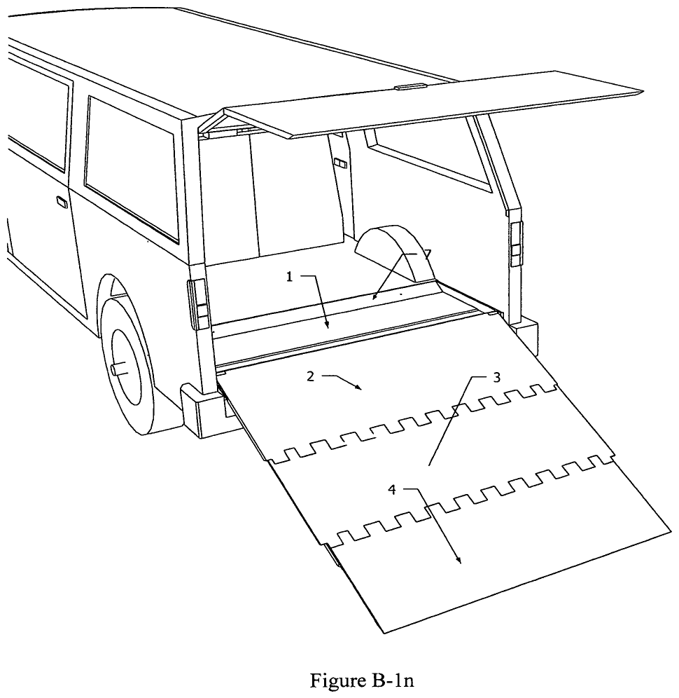

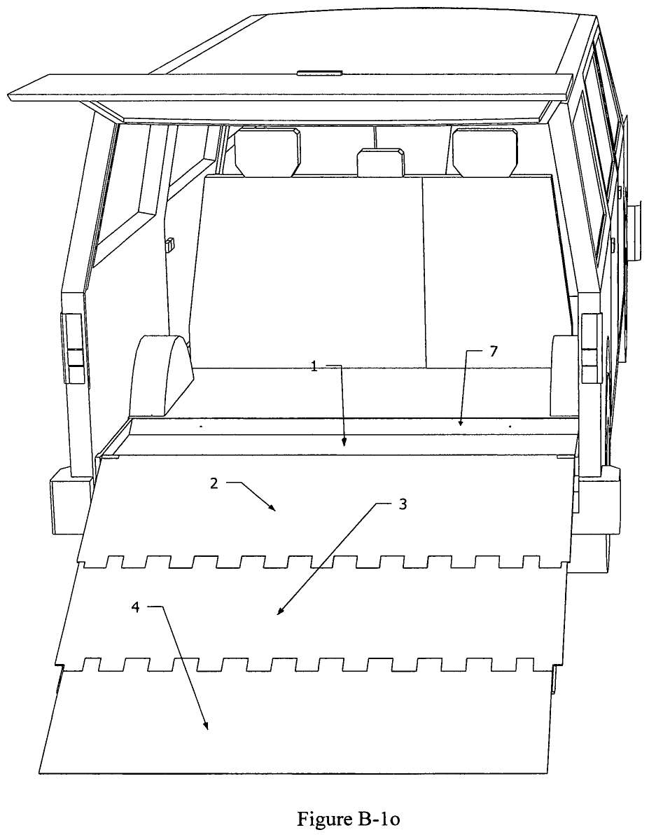

### BACKGROUND OF THE INVENTION

The Folding Tailgate Ramp System (FTRS) is a rotating, retractable, folding, and extendable Tailgate Ramp which makes accessing an elevated bed of a vehicle, by smaller wheeled objects a possibility. The FTRS has a wide base in the Ramp Casing, and a wide rotating and collapsible body in the Tailgate Ramp, and together, they bridge the gap between the surface (ground) and the elevated Tailgate of a pickup, or the elevated bed of a vehicle.

I worked in the construction industry over a decade ago, and to get a work table on wheels, inside our work van was very challenging. We would use two pieces of wood planks, eight inches by two inches by eight feet (8″×2″×8″) long for a ramp, to access the elevated back. It would take two people for it to work efficiently, but sometimes the planks would move and we would have a disastrous outcome. The FTRS would rectify this problem, with its wide area and a sturdy attachment that would eliminates any shakiness.

The FTRS enables small wheeled objects access to the bed of a pickup truck and wheelchairs access to the back of a SUV or a minivan. The FTRS is comprised of a Four Planked, Tailgate Ramp and a Three Planked, Tailgate Ramp. The Four Planked, Tailgate Ramp has four Planks (A, B, C, D), and is designed to accommodate taller vehicles such as pickup trucks, while the Three Planked, Tailgate Ramp, has three Planks (A, B, C) and is designed to accommodate lower vehicles such as SUVs and minivans. Both Planks are identical in appearance, width and their operation, but only differs in length because the Three Planked, Tailgate Ramp has one less Plank.

Most of the inside end of the Tailgate has been recessed, to fit the FTRS and when it is installed and embedded in it, the top is flushed with the surrounding areas. The FTRS utilize an area that would not be used and therefore does not consume any valuable space. When the Tailgate is up and closed, the Tailgate Ramp is locked in place and in unable to open, but when it is lowered, the said Tailgate Ramp, is now able to be opened, and its full potential can be deployed. When the FTRS is activated, the opening process is ignited by the rotation of the Axels, which lift the Tailgate Ramp, and then the opening of the interlocking hinge joints, which cause the Planks to be extended. In the opening process, the Planks of the Tailgate Ramp are opened one by one, from Plank A until the last Plank is extended. The closing process is a reverse of the opening process, where the Plank that touches the surface is lifted and folded, and then the next Plank is folded and the process continues until all the Planks are fully closed.

The Folding Tailgate Ramp System will put an end to makeshift ramps that are sometimes very risky, heavy, takes up valuable space, and time consuming. It also will replace bulky lifts that are very expensive, heavy and some are almost as large as the host vehicle. A workable ramp for a tailgate is nonexistent and my FTRS will revolutionize the industry. The FTRS is a true collapsible ramp that is as wide as a Tailgate but is compact, it can be electrically powered, has flat even surface, sturdy Planks, and heavy-duty interlocking joints which open and close.

### SUMMARY OF THE INVENTION

The Folding Tailgate Ramp System (FTRS) is a rotating, retractable Tailgate Ramp which makes accessing the elevated bed of a vehicle, by smaller wheeled objects a possibility. Two main components of this system are, the Ramp Casing, which is attached to the recessed inside of the Tailgate, and the Tailgate Ramp, that is attached by Axels to the front end of the Ramp Casing.

The Ramp Casing is a casing for the Tailgate Ramp, and it is embedded in the recessed, inside of the Tailgate. It is stationery, it housed and accommodate and it is also an anchor for the Tailgate Ramp. The Ramp Casing is very sturdy, and is secured to the Tailgate by six L Shaped Brackets, with three on each side.

The moveable Tailgate Ramp is the second part of the Folding Tailgate Ramp System (FTGR). There are two types of Tailgate Ramps, and they are, the Four Planked, Tailgate Ramp and the Three Planked, Tailgate Ramp. The Four Planked, Tailgate Ramp has four Planks (A, B, C, D), while the Three Planked, Tailgate Ramp has three Planks (A, B, C). Both Ramps rotate on their Axels, and they have interlocking hinge joints which open their Planks, one by one.

There are three steps in the operation of the FTRS. First, the Tailgate Ramp rotates clockwise, for 147 degrees on its Axels, where it is lifted from the floor of the Ramp Casing, and comes to a halt, and the second step is activated. Plank B then opened from below Plank A and is lifted and align with it. Plank C then opened from below Plank B and is lifted and align with it. Plank D then opened from below Plank C and is lifted and align with it. Now all the Planks are aligned and are on the same plane, and therefore the third step is initiated. The Tailgate Ramp resumes its clockwise rotation on its Axels, for another 53 degrees, until the Beveled Edge of the outer Plank touches the surfaced. The FTRS has moved from closed to a fully functional Ramp and provides access to its elevated area. The closing process is a reverse of the opening process, and the Tailgate Ramp rotates counterclockwise and it is notched away in the Ramp Casing

I worked in the construction industry over a decade ago and to get a wheeled, work table inside our work van, we used two pieces of wood planks, eight inches by two inches by eight feet (8″×2″×8″) long for a ramp, to access the elevated back. It would take two people for it to work efficiently, but sometimes the planks would move and we would have a disastrous outcome. The TRS would rectify this problem, with its wide area and a sturdy attachment that would eliminate any shakiness.

The FTRS has rotating and retractable Planks, that when open provides a wide and sturdy Ramp, which give access to an elevated bed of a vehicle, and when closed is reduced to a fraction of its size, and is stored away in an area that would not be used or at most, takes up minimal space. There are expensive lifts that are large, bulky and costly, that are used to accomplish the same task of getting small vehicles or wheeled objects to an elevated rear end of a pickup. The FTRS achieves its objective by accomplishing its goal by providing a service that has been sought for decades, that has finally been realized by our achievement.

### BRIEF DESCRIPTION OF DRAWINGS

FIG. A-1a is an overhead, front-view of all the floating parts that make up the Folding Tailgate Ramp System. From front to back the five main parts are aligned and they are the Ramp Casing, Plank A, Plank B, Plank C and Plank D. The four Planks when connected form the Ramp and is connected to the Ramp Casing which house and support the Tailgate Ramp.

FIG. A-1b is an overhead front view of the Ramp Casing with aligned, floating parts which makes up the Ramp Casing. When the parts are connected, they form a fully functional Ramp Casing which is the base of the Folding Tailgate Ramp System. The Ramp Casing is connected to the Tailgate by the L Shaped Brackets and is connected to Plank A at the front by ways of the Axel Brackets.

FIG. A-1c is a front, left-sideview of Plank A with floating parts. Together when attached they form a fully functional Ramp section which is powered by a Motor. Plank A is connected to the Ramp Casing in the front and to Plank B in the rear.

FIG. A-1d is a front, left-sideview of Plank B with floating parts. Together when attached they form a fully functional Ramp section which is sandwich by Plank A in the front and Plank C in the rear.

FIG. A-1e is an overhead view of Plank C with floating parts. Together when attached they form a fully functional Ramp section which is sandwich by Plank B in the front and Plank D in the rear.

FIG. A-1f is an overhead view of Plank D. Plank D has a beveled edge in the rear and is connected to Plank C at the front.

FIG. A-1g is a right-side diagonal view of the topside of Plank A with attached Right and Left Strut base. The Tube in the front which stretches almost the full length of Plank A is welded to the Plank. Equally spaced Hinges Barrels are noticeable in the rear which are the connection point for Plank B.

FIG. A-1h is a diagonal rearview of the underside of Plank A. Notched out Hinge Slots Stop and protruding Hinge Extension Stop and partial views of the Hinge Barrel #1 are noticeable from this view.

FIG. A-1i is a right-sideview of the topside of Plank B, with attached Right and Left Strut Base and Strut Attachments on both sides. On the right front side are the larger Number One (#1) Hinge Barrel and on the left back side are the smaller Number Two (#2) Hinge Barrel.

FIG. A-1j is a front view of the underside of Plank B. Notched out Hinge Slots Stop and protruding Hinge Extension Stop are noticeable from this view in the front and in the rear, and partial views of the #1 Hinge Barrel are also noticeable.

FIG. A-1k is a front, right-sideview of the topside of Plank C, with attached Right and Left Strut Base and Strut Attachments on both sides. Protruding Hing Extension Stops and recessed Hing Stop Slots are uniform, and together they create a jagged edge on both long sides of Plank C. Hinge Barrels on the front and back sides are similar in size but in the front, they sit higher on the Hinge Extension Stop.

FIG. A-1l is the left-sideview of the underside of Plank C. From this view the teeth, which is the jagged edge with the Hinge Extension Stops and the Hinge Slot Stops, that are on both sides, fit and interlock into identical rear end of Plank B in the front, and the identical front edge of Plank D in the rear.

FIG. A-1m is a right-sideview of the topside of Plank D. Plank D is the smaller of the planks and has a jagged front end, which is identical to the rear end of Plank B. The protruding Hinge Extension Stops with Hinge Barrels that sit lower on top of them, and recessed Hinge Slot Stops which is between each Hinge Extension Stop completes the front. In the rear is a Beveled Edge which is the only part of the Tailgate Ramp that touches the ground when the Ramp is fully opened.

FIG. A-1n is the sideview of the underside of Plank D. The jagged edge on the frond is very distinct with pronounced Hinge Slot Stops which housed the protruding Hinge Extension Stop from Plank C.

FIG. A-1o is a front view of the Right and Left Struts with floating Right and Left Strut Bases in the front and Strut Attachments in the rear. When the three parts are connected together, on each side, they form a completed Strut.

FIG. A-1p is a front view of the topside of Plank A, Plank B, Plank C and Plank D that are separated but are aligned in order as they would appear on a completed Ramp. The jagged edges of each Plank interlock with each adjacent Plank and form a contiguous Tailgate Ramp.

FIG. A-1q is a sideview of the #1 Hinge Barrel, #2 Hinge Barrel and #3 Hinge Barrel with attached Hinge Extension Stop. When they are all together the differences are very noticeable while they are side by side.

FIG. A-1r shows a cross-section of the right-side of the Tube with a protruding extended flat side of the Tube. From this view the interior of the tube has a hallow Inner tube with connecting points to the main Tube. Inside the inner Tube on the right is a hole which pierces the backside of the tube is the Power Cord Hole. The tiny hole in the middle is the open left end of the Tube.

FIG. A-1s is a front, right side view of the topside of a connected Tailgate Ramp. Each Plank interlock with the adjacent Plank and is secured by the Hinge Pistons which hold the Planks together.

FIG. A-1t is a left-sideview of the underside of a connected Tailgate Ramp. The interlocking connection points are much more pronounced on the backside. Each section is open to its maximum, where the Hinge Extension Stops collide with the hidden Hinge Slot Stops of the adjacent Plank which halts the opening, and therefore create a contiguous even platform in the Tailgate Ramp.

FIG. A-1u is a right-sideview of the topside of a connected Tailgate Ramp. Plank A, Plank B and Plank C are aligned and are fully opened while Plank D has been pulled forward to about 45 degrees. At this angle the Right and Left #3 Struts are lifted off the surface as they pull Plank D forward.

FIG. A-1v is a left-sideview of the underside of a connected Tailgate Ramp. The interlocking slots of the adjoined sections, are flat between Plank A and Plank B and between Plank B and Plank C. However, between Plank C and Plank D, where Plank D is at a slight angle, the teeth are exposed and reveal the Hinge Slot Stops that were hidden behind the Hinge Extension Stops.

FIG. A-1w is a front, right-sideview of the topside of a connected Tailgate Ramp. Plank A, Plank B and Plank C are aligned and are fully opened while Plank D has been pulled forward to about 135 degrees. At this angle the Right and Left #3 Struts are lifted off the surface as they pull Plank D forward to almost a closed position.

FIG. A-1x is a rear, left-sideview of the underside of a fully connected Tailgate Ramp. The teeth of the interlocking sections are flat between Plank A and Plank B and between Plank B and Plank C. However, between Plank C and Plank D, where Plank D is at, a sharp angle, the teeth are exposed and reveal the Hinge Slot Stop that was hidden behind the Hinge Extension Stop. The Hinge Extension Stops of this interlocking joint, stuck outward and appear to separate, as Plank D closed toward Plank C.

FIG. A-1y is a front view, from of the topside, from slightly right, which shows a connected Tailgate Ramp with a closed Plank D that block out almost all the visibility of Plank C. The pronounced Hinge Slot Stops are easily identified between each Hinge Extension Stop at the rear. The end of Plank D is inside the second joint and almost touches the #2 Hinge Barrels while the topsides of both Plank C and Plank D are face to face and are touching.

FIG. A-1z is a rear, left-sideview of the bottom side of a connected Tailgate Ramp, with a closed Plank D. Plank D is only visible at the upward facing Hinge Extension Stop. The recessed Hinge Slot Stops of the #3 Hinge Barrel are noticeable as they are spaced between the Hinge Extension Stops.

FIG. A-2a is a right-sideview of the topside of a connected Tailgate Ramp, with Plank D closed completely and touching face to face with Plank C, while Plank C is raised forward to about 45 degrees which cause the #2 Left and Right Strut to also be at an angle as they pull the Planks forward.

FIG. A-2b is a left-sideview of the bottom side of the said Tailgate Ramp in FIG. A-2a. In this diagram the connecting joint between Plank B and Plank C is offsetting, that reveal the Hinge Slot Stops and the protruding Hinge Extension Stops which are more pronounced. At the far end of Plank C, are jagged edges which are Hinge Extension Stops and Hinge Slot Stops that form interlocking slots that is more visible while the topsides of adjoining Planks are touching which leaves the ends exposed.

FIG. A-2c is a right-sideview of the topside of a connected Tailgate Ramp, with Plank D closed completely and touching face to face with Plank C. Plank C is raised forward, to about 135 degrees which cause the #2 Left and Right Strut to also be at an angle as they pull the Plank forward.

FIG. A-2d is a left-side, rearview of the bottom side of the said Tailgate Ramp in FIG. A-2c. In this diagram the connecting joint between Plank A and Plank B is flat and the Hinge Extension Stops of both Planks are interlocking. Between Plank B and Plank C the joint is open and is offsetting, which reveal the Hinge Slot Stops and the protruding Hinge Extension Stops that are more pronounced. At the bottom end of Plank C, are jagged edges which are Hinge Extension Stops and Hinge Slot Stops that are vacated by the Hinge Extension Stop and Hinge Slot Stop of Plank D that is now face to face with Plank C and touching.

FIG. A-2e shows a sideview of the topside of a connected Tailgate Ramp with outstretched Plank A and Plank B. Plank D is folded and face to face with Plank C, Plank C is folded and face to face with Plank B and Plank D is between Plank B and Plank C. On top, on the right, Plank C underside is facing up and it appears as if it is next to Plank A but it is higher, and it is in line with the top of the #1 Hinge Barrels. Plank D is face to face with Plank C, and is sandwiched between Plank B and Plank C, and is barely visible from this view.

FIG. A-2f is a rear, left-side view of the bottom side of a connected Tailgate Ramp with outstretched Plank A and Plank B. From this view Plank D is completely out of sight, while plank C is only visible at the Hinge Extension Stops which is at the bottom of the rear.

FIG. A-2g is a front, sideview of the topside of a connected Tailgate Ramp with an outstretched Plank A and a raised Plank B that is partially hidden and is in the back ground. Plank B is raised to about 45 degrees while Plank C and Plank D are locked to its face, and is being move along with Plank B. The underside of Plank C is in full view as it is angled towards Plank A. Plank D is sandwiched between Plank B and Plank C, and is barely visible from this view.

FIG. A-2h is a left-side, rearview of the bottom side of a connected Tailgate Ramp. Plank A is parallel to the surface while Plank B is pulled forward to about 45 degrees which reveals the outline of the jagged edge between Plank A and Plank B. From this view Plank C is slightly visible at the lowered left edge while Plank D is completely hidden.

FIG. A-2i is a right-side, front view of the topside of a connected Tailgate Ramp with an outstretched Plank A and a partially hidden Plank B in the back ground, that is pulled forward to about 135 degrees. The under section of Plank C is in full view, while locked with Plank B, as it is angled towards Plank A. Plank D is locked with Plank C and Plank B and is sandwiched between Plank B and Plank C. Plank D is hardly visible from this view as it is fixed between two Planks.

FIG. A-2j is a left-side, rearview of the bottom side of a connected Tailgate Ramp. Plank A is parallel to the surface while Plank B is pulled forward to about 135 degrees, where it is almost touching Plank A, and reveals the outline of the jagged edge between Plank A and Plank B. From this view Plank C and Plank D are completely hidden. Plank D is locked to Plank C and Plank C is locked to Plank B and therefore at this stage Plank C and Plank D are totally depend on Plank B for any movement.

FIG. A-2k is a front, right-side view of the topside of a connected Tailgate Ramp that has been folded completely on itself. From this view the bottom side of Plank B is most prominent is the diagram and takes up most of the drawing. The outline of Plank A is visible along the right-side and along the front via the Tube. Plank C and Plank D are sandwiched between Plank A and Plank B, where Plank D is completely hidden and Plank C is partially visible through the gaps of the Hinge Slot Stops.

FIG. A-2l is a left-side rearview of the bottom side of a connected Tailgate Ramp that has been folded completely on itself. The bottom side of Plank A dominates this view with the outlines of Plank B along the left-side and along the rear through the Hinge Extension Stops. Plank B and Plank C, are sandwiched between Plank A and Plank B and are completely hidden from view.

FIG. A-2m is a front-view of the Right and Left Axel Brackets with floating Bolts at the rear above the flat section, floating Flat Brackets above which is aligned with the backside of the tube section, and with Bolts in the rear of it. On the right and the left of both Axel Brackets are floating Nuts and Washers which secure the Axel Brackets to the Side Walls. The Axel Brackets are bolted and connected to Plank A and are also connected to the Right and Left Side Walls of the Ramp Casing through rotating joints, which allows the Tailgate Ramp to rotate about 200 degrees, from closed to open.

FIG. A-2n is front-view of the topside of a fully completed Tailgate Ramp with attached Left and Right Axel Brackets. The Tailgate Ramp is fully folded and is compact and at this reduced size, it can be fitted on the inside of a tailgate of a pickup. Floating Nuts and Washers flanked both sides of the Tailgate Ramp which secures it to the Ramp Casing.

FIG. A-2o is a sideview of the topside of the said picture in FIG. A-2n. From this view the right-side of the Tailgate Ramp is in full view.

FIG. A-2p is a sideview of a window shade Motor which is used to power the Tailgate Ramp. An aligned Motor Bracket on the left, with floating Bolts, that fits over the head of the Motor and a Motor Sleeve on the right that fits over the grooved tip.

FIG. A-2q shows a fully closed Tailgate Ramp on the far right with attached Left and Right Axel Bracket. The Left Axel Bracket with a large opening, is aligned with the Motor, with floating Motor Sleeve, a large Bolt and Washer to the right, and a Motor Bracket on the far left. The Motor will be inserted through the large hole of the Left Axel Bracket and fits completely in to the Tube and only the Motor Head will be left out.

FIG. A-2r is a left-sideview of a fully completed Tailgate Ramp with attached Left and Right Axel Brackets and an inserted Motor on the left-side.

FIG. A-2s shows the rear of a pickup truck with an opened Tailgate. The inside of the Tailgate is hallowed out to accommodate the Ramp Casing of the Folding Tailgate Ramp System. The open top end of the Tailgate is covered by a spring loaded, Top Flap which span the top. The spring tensioned Hinges of the Top Flap, forces it to stay up in a closed position, but whenever the Tailgate Ramp opens, it pushes the Top Flap downward. When the Tailgate Ramp is lifted in the opposite direction, the spring tensioned Hinges recoil and the Top Flap is returns to its closed position. Behind the Top Flap is the Middle Flap which stretches the width of the Ramp Casing. The Middle Flap has bent, angled ends, with a notched-out piece. It is also spring tensioned and moves with the Tailgate Ramp whenever it lifts and rotates on its Axels. When the Tailgate Ramp is closed it lays on top of the Middle Flap, and as it opens the spring tensioned Middle Flap recoils and lift with it. When the Tailgate Ramp is lifted and flipped over with the rotation of the Axels, the Middle Flap forms a mini ramp which provides a smooth transition from the Tailgate Ramp to the bed of the Ramp Casing.

FIG. A-2t shows a front, left-side view of the Ramp Casing of a Tailgate with a floating Top Flap in the front, a floating Middle Flap above the center and a floating Bottom Flap above the rear. On the Left side of the Ramp Casing are L Shaped Brackets which secure the Ramp Casing to the Tailgate. The right side is a mirror image of the left side and also has three L Shaped Brackets.

FIG. A-2u is a left-side, front view of a fully assembled Ramp Casing of a Tailgate, with an opened Top Flap that stretches across the front, a closed Middle Flap that span the middle section and an opened Bottom Flap that stretches across the rear.

FIG. A-2v is a direct front-view of the Ramp Casing of the FTRS, which is similar to the illustration in FIG. A-2u. In this diagram all the Flaps are closed. The Top Flap is flush with the top end of the Tailgate, the Middle Flap is still flat on the bed of the Ramp Casing, and the Bottom Flap is closed to the bed, and is now a miniature ramp. The bent ends of the Middle Flap are also noticeable from this view. The Larger Left Axel Hole on the left, and the smaller Right Axel Hole on the right, anchor the Axels of the Tailgate Ramp to the Ramp Casing.

FIG. A-2w is a left-side view of the said illustration of the Ramp Casing in FIG. A-2u and FIG. A-2v. In this illustration, the covering of the left-side of the Tailgate has been removed which reveals a clear view of the three L Shaped Brackets on the left, which secures the Ramp Casing to the Tailgate. The right-side is a mirror image of the left-side which also has three L Shaped Brackets that anchor and secure the Ramp Casing to the Tailgate.

FIG. A-2x is a left-side, front view of a completed but separated Folding Tailgate Ramp System. The Tailgate Ramp hovers above the Ramp casing with both Left and Right axel Bracket attached to the Ramp Casing and are pointing in an upright position that is aligned with the Tailgate Ramp. All three Flaps, the Top Flap, Middle Flap and the Bottom Flap are in an open position.

FIG. A-2y is a rear-view of the said diagram in FIG. A-2x with an exposed bottom side of the floating Tailgate Ramp, which is above the Ramp Casing, with the backside in full view. The Tailgate Ramp will be lowered and bolted to both Axel Bracket to form a complete Folding Tailgate Ramp System.

FIG. A-2z is a closeup view of the front right corner of the said Ramp Casing in FIG. A-2x and FIG. A-2y. This diagram shows a floating Flat Bracket with bolts, in the front and behind the Flat Bracket is a partial view of an opened Top Flap that is attached to the Ramp Casing by a Spring Loaded Hinge. Then an upright Right Axel Bracket pierces the Right Side Wall and is aligned by a floating Washer and a Nut to the far right. Secured to the Right Side wall is a partial view of a L Shaped Bracket which secure the Ramp Casing to the Tailgate. Behind the upright Right Axel Bracket is an upright, open Middle Flap which is spring loaded and moves only when the Tailgate Ramp is being moved.

FIG. A-3a is a closeup view of the front left corner of the said Ramp Casing in FIG. A-2x and FIG. A-2y. This diagram shows a floating Flat Bracket with bolts in the front, behind the Flat Bracket is a partial view of an opened Top Flap, that is attached to the Ramp Casing by a Spring Loaded Hinge. Then an upright Right Axel Bracket pierces the Left Side Wall and is aligned by a floating large Washer and a large Nut to the far left. Secured to the Left Side Wall are partial views of L Shaped Brackets which secure the Ramp Casing to Tailgate. Behind the upright Left Axel Bracket is an upright, open Middle Flap which is spring tensioned.

FIG. A-3b is a left-side, front view of the Folding Tailgate Ramp System with an attached and upright Tailgate Ramp which is connected to the Ramp Casing. The Ramp Casing has an open-ended, left-side, which reveals the three L Shaped Brackets that secure the Ramp Casing to the Tailgate. A separated Top Flap, is in the front with a partial view of a hovering Middle Flap, above the Ramp Casing, and behind the Tailgate Ramp. A floating Bottom Flap is in the rear.

FIG. A-3c is a left-side rear view of the said erected Tailgate Ramp attached to the Ramp Casing, that is illustrated in FIG. A-3b. From this view the open-ended left-side is in the front, and all of its inner components are visible. The Top Flap is partially visible at the far right while the hovering Middle Flap and Bottom Flap are in full view.

FIG. A-3d is a left-side, front view of a fully completed Folding Tailgate Ramp System with an upright Tailgate Ramp that is attached to the Ramp Casing, with an attached and opened Top Flap, and an attached opened Bottom Flap.

FIG. A-3e is a left-side, rear-view of the said diagram in FIG. A-3d which shows an erected Tailgate Ramp that is secured to the Ramp Casing. From this view the Tailgate Ramp has been rotated 90 degrees on its Axels and is now upright which reveals the Middle Flap that is against its bottom end. The Middle Flap is spring loaded and moves with the Tailgate Ramp as it turns on the Axels. In the rear of the Ramp Casing, is an open and erected Bottom Flap, which opens and allow the Tailgate Ramp to lift, and closes to the floor of the Ramp Casing, to form a miniature ramp.

FIG. A-3f is a closeup view of the left front corner, of the same illustration in FIG. A-3d and FIG. A-3e. The Motor is inserted in the Tube and secure to the Left Side Wall by the Nut, while the floating and aligned Motor Bracket fits over the head of the motor (Motor Head), and secures it in place, there by prevent it from rotating with the motion of the rest of the Motor.

FIG. A-3g is a closeup view of the right, front corner of the same illustration in FIG. A-3d and FIG. A-3e. The Nut secures the cylindrical part of the Right Axel Bracket in place while the protruding Power Cord tip is a network of wires which is the power connections for the Struts.

FIG. A-3h is a left-side, rear-view of a pickup truck with an opened Tailgate, with a closed Tailgate Ramp imbedded in it. The Top Flap is closed and seal off the top end of the Tailgate while the Bottom Flap is also closed and hold the Tailgate Ramp in place when it is closed.

FIG. A-3i is a closeup view of the front, left-side of the said diagram in FIG. A-3h of the Tailgate with an imbedded Tailgate Ramp. From this view, a Pin is placed through the Motor Bracket and the Motor Head Connector which secures the Motor Head to the Motor Bracket. The Motor Head is now fixed and will not move when the body of the Motor rotates.

FIG. A-3j is a right-side, rear-view of the said diagram in FIG. A-3h of a pickup with an opened Tailgate, and a closed Tailgate Ramp is imbedded in it. The Top Flap is closed and seal off the top end of the Tailgate while the Bottom Flap hold the Tailgate Ramp in place while it closed.

FIG. A-3k is a closeup view of the front, right-side of the said diagram in FIG. A-3j of a Tailgate with an imbedded Tailgate Ramp. A peeled back top layer at the front corner reveals the Right Axel Bracket which pierces, and penetrates the Right Side Wall. A partial L Shaped Bracket which secures the Ramp Casing to the Tailgate is in view through the open area.

FIG. A-3l is a rear, overhead view of a pickup with an opened Tailgate, with an imbedded Folding Tailgate Ramp System. The Top Flap, at the top of the Tailgate is opened but in reality, it is spring tensioned and only opens if it is pushed by the Tailgate Ramp. The Bottom Flap is opened and is in an upright position and therefore make way for the Tailgate Ramp to be open.

FIG. A-3m is a rear, left-side view of a pickup truck with an opened Tailgate and a partially opened Tailgate Ramp. The Tailgate Ramp is in the beginning stage of the opening process, and is opened to about 20 degrees. The left end piece of the Middle Flap which appears as if it is holding up the Tailgate Ramp, is upright and spring loaded which forces it up as the Tailgate Ramp is being lifted. The Bottom Flap is closed all the way to the base of the Ramp Casing which creates a miniature ramp, to access the bed of the pickup truck.

FIG. A-3n is a rear, left-side view of a pickup with an opened Tailgate and a partially opened Tailgate Ramp. The Tailgate Ramp rotates from the bed of the Ramp Casing to about 155 degrees and then, the second step of the opening process is initiated, where the folded inner Planks will open one by one.

FIG. A-3o is a rear, left-side view of a pickup, with an opened Tailgate with an opening Tailgate Ramp, and with Plank A rotate 155 degrees. Now the second step is triggered and Planks B is activated. Plank A is now stationery and Plank B begins its opening process and is now open to about 30 degrees.

FIG. A-3p is a rear, left-side view of a pickup with an opened Tailgate, a partially rotated and stationery Plank A and an opening Plank B which has been opened to about 135 degrees. In this picture the under sides of Plank A and Plank B has been flipped over and are now facing up.

FIG. A-3q is a rear, left-side view of a pickup with an opened Tailgate, a partially rotated and stationery Plank A and a fully opened Plank B which has been opened to its maximum at 180 degrees. Plank A and Plank B are now at the same angle and together they formed a contiguous platform as the opening process continues.

FIG. A-3r is a rear, left-side view of a pickup with an opened Tailgate, a partially rotated and stationery Plank A, and a fully opened Plank B which has been opened to its maximum at 180 degrees. Both Plank A and Plank B are on the same plane and are aligned. Plank C begins its open process, and is now open to about 35 degrees, while Plank D is face to face with Plank C and is hidden from view.

FIG. A-3s is a rear, left-side view of a pickup truck with an opened Tailgate, a partially rotated and stationery Plank A, and a fully opened Plank B which has been opened to its maximum at 180 degrees. Plank A and Plank B are on the same plane and are at the same angle. Plank C is still continuing its opening process and is now open to about 135 degrees, while Plank D is still face to face with Plank C and is hidden from view.

FIG. A-3t is a rear, left-side view of a pickup with an opened Tailgate, a partially rotated and stationery Plank A and a fully opened Plank B and Plank C which has been opened to their maximum at 180 degrees. Plank A, Plank B and Plank C are on the same plane and are at the same angle and therefore together they formed a contiguous platform. In this picture Plank D is still face to face with Plank C and is hidden from view.

FIG. A-3u is a rear, left-side view of a pickup with an opened Tailgate, a partially rotated and stationery Plank A and a fully opened Plank B and Plank C which has been opened to their maximum at 180 degrees. Plank A, Plank B and Plank C are on the same plane and are at the same angle and therefore together they formed a contiguous platform. Plank D is now visible and begins its opening process where it now opened to about 35 degrees and continues to rise.

FIG. A-3v is a rear, left-side view of a pickup with an opened Tailgate, a partially rotated and stationery Plank A and a fully opened Plank B and Plank C which has been opened to its maximum at 180 degrees. Plank A, Plank B and Plank C are on the same plane and are at the same angle and therefore together they formed a contiguous platform. Plank D continues to open and has reached about 135 degrees and is getting closer to be fully opened.

FIG. A-3w is a rear, left-side view of a pickup with an opened Tailgate, a partially rotated and stationery Plank A and a fully opened Plank B, Plank C and Plank D, have been opened to their maximum of 180 degrees. All the Planks are on the same plane and are at the same angle and therefore together they formed a contiguous platform. With all the Planks fully extended, aligned and at the same angle, the third step in the opening process is activated and the clockwise rotation of the Axel will cause extended Planks to be lower it to the surface.

FIG. A-3x is a rear, sideview of a pickup with an opened Tailgate and a fully extended Tailgate Ramp. Now that all the Planks are aligned and extended, the Axels begin to rotate which cause the activation of the next step in the opening process where the Tailgate Ramp is lowered to the Surface. As the Tailgate Ramp continues its rotation, it is being lowered and is now parallel to the surface.

FIG. A-3y is a left-side view of the rear of a pickup with an opened Tailgate and a fully extended and lowered Tailgate Ramp. The Tailgate Ramp is fully opened and has rotated all the way to the surface. The tip of the Tailgate Ramp touches the pavement while still connected to the Tailgate, and therefore creating a full-size ramp which give access to the bed of the pickup truck. The Middle Flap is erected and has been lifted intentionally to show the sudden drop from the Ramp to the floor of the Ramp Casing. The Middle Flap is spring loaded and is always against the Tailgate Ramp, and when it is fully lifted, it creates a miniature ramp, that bridge the gap between the Ramp Casing and the Tailgate Ramp.

FIG. A-3z is a left-side view of the rear of a pickup truck with an opened Tailgate and a fully extended and lowered Tailgate Ramp. In this picture the Middle Flap is in its correct position as it would when the Tailgate Ramp is fully open. The Tailgate Ramp is sturdy and wide enough to accommodate motor cycles and some off-road vehicles.

FIG. B-1a is a front-view of aligned and separated Plank A, Plank B and Plank C. These three Planks in this diagram form a Three Planked Tailgate Ramp, when they are joined together. The Three Planked Tailgate Ramp is shorter, which is ideal for lower vehicles such as minivans and smaller SUVs.

FIG. B-1b is a left-side view of the topside of the Three Planked, Tailgate Ramp with all three planks attached to form one platform. Plank three of the Three Planked, Tailgate Ramp is beveled at the far top end where it touches the surface when it is in full operation. With all the Planks adjoined and on the same plane, the Three Planked, Tailgate Ramp is now stretched out and the Right and Left #1 and #2 Struts are fully extended, and flat against the Planks.

FIG. B-1c is a left-side view of the topside of the Three Planked, Tailgate Ramp with Plank A and Plank B aligned and on the same plane, while Plank C has been pulled forward about 90 degrees. The #2 Right and Left Struts are slight lifted at an angle as they pull Plank C forward.

FIG. B-1d is a left-side, front view of the topside of the Three Planked, Tailgate Ramp with Plank A and Plank B aligned and on the same plane, while Plank C is face to face with Plank B. The underside of Plank C has been flipped up and is in full view at the rear half of the Illustration. It also blocks out most Plank B, where it is only visible on the far left-side.

FIG. B-1e is a left-side, topside view of the Three Planked, Tailgate Ramp with a flat Plank A, while Plank B and Plank C are face to face and are pulled forward to an upright position, which is about 90 degrees. Plank C is in the forefront of the upright section with the underside facing outward and Plank B which is in the rear, is visible around the edges, on the left-side and the rear top edge.

FIG. B-1f is a left-side view of a closed Three Planked, Tailgate Ramp where Planks A is still parallel to the surface and Plank B and Plank C which are face to face, are folded and touching the topside of Plank A. The Tube and the left-side of Plank A is visible from this view, while the underside of Plank B is on top and is in full view, while Plank C is hidden from this view.

FIG. B-1g is a rear view of a SUV with an installed Ramp Casing which is embedded into the rear section. The Three Planked, Tailgate Ramp when installed would allow wheelchair access to the SUV or a minivan and would only utilize minimal space.

FIG. B-1h is a rear view of a SUV with a complete and fully closed Three Planked, Folding Tailgate Ramp System installed in the Ramp Casing of the rear section of a SUV. The highest part of the Three Planked, Tailgate Ramp is flushed with the floor of the SUV which creates an even surface to move about. The Three Planked, Tailgate Ramp takes up minimal space which does not impede with the storage capacity of the trunk of the SUV.

FIG. B-1i is a rear view of a SUV with a Three Planked, Folding Tailgate Ramp System. The Three Planked, Tailgate Ramp has been flipped over on its Axels and the topside is facing down and the bottom side is now up. At this point the Three Planked, Tailgate Ramp has rotated about 155 degrees from the floor of the Ramp Casing. The inner Planks are about to be extended to complete the Ramp.

FIG. B-1j is a rear view of a SUV with a complete Three Planked, Tailgate Ramp, with a stationery Plank A that had rotate 155 degrees. Plank B begins to open and has open to about 90 degrees while Plank C which is hidden from view is face to face with Plank B.

FIG. B-1k is a rear view of a SUV with a complete Three Planked, Tailgate Ramp, with a stationery Plank A that had rotate 155 degrees. Plank B has been fully extended to 180 degrees and is now aligned and on the same plane as Plank A. Plank C is still face to face with Plank B and is now barely visible, from the bottom side, of the front tip along the Hinge Extension Stops.

FIG. B-1l is a rear view of a SUV with a complete Three Planked, Tailgate Ramp, with a stationery Plank A that had rotate 155 degrees. Plank B has been fully extended to 180 degrees and is now aligned and on the same plane as Plank A. Plank C begins to open and has open to about 90 degrees. Below the interlocking joint of Plank B and Plank C, is a partial view of the #2 Left Strut, and along with the hidden #2 Right Struts, they continue to push Plank C upward until it is flush with Plank A and Plank B.

FIG. B-1m is a rear view of a SUV with a complete Three Planked, Tailgate Ramp, with a stationery Plank A that had rotate 155 degrees. Plank B and Plank C have been fully extended, and both are now aligned and are on the same plane as Plank A. Together the three Planks form a fully extended and contiguous Three Planked, Tailgate Ramp that is about to complete its rotation on the Axels, and be lowered to the surface.

FIG. B-1n is a rear view of a SUV with a complete Three Planked, Tailgate Ramp, with a stationery Plank A that had rotate 200 degrees. Plank B and Plank C have been fully extended, and both are now aligned and are on the same plane as Plank A. Together the three Planks form a fully extended and contiguous Three Planked, Tailgate Ramp which has been lowered to the surface.

FIG. B-1o is a rear view of a SUV with a complete Three Planked, Tailgate Ramp, of the said diagram in FIG. B-1n, with a stationery Plank A that rotated another 45 degrees. Plank B and Plank C have been fully extended, and both are now aligned and are on the same plane as Plank A. From straight on, behind the SUV the Ramp is as wide as the back door.

### FULL DESCRIPTION OF DRAWINGS

FIG. A-1a is an overhead, front-view of all the floating parts that make up the FTRS. The FTRS is comprised of a Four Planked Tailgate Ramp, which is the second to fifth large rectangular shaped objects in the diagram. The Three Planked, Tailgate Ramp, will be viewed in FIG. Bs. An indented Tailgate with an imbedded Ramp Casing, is the first large object in the diagram, housed the Tailgate Ramp, which are the next four large objects and the surrounding parts when connected together. In the fore front is a slender Top Flap that has Spring Loaded Hinges. The Top Flap is connected to the main Ramp Casing of the FTRS and the Spring Loaded Hinges keep the Top Flap erected and aligned with the top edge of the said Ramp Casing. The Ramp Casing has an open front end with two indented slots to connect the Top Flap. Floating above the left front corner of the Ramp Casing is the Left Axel Bracket that is aligned with a Washer and a Nut to the left. The Left Axel Bracket fits into the Left Axel Hole in the front of the Left Side Wall of the Ramp Casing, and is secure to it by the aligned floating Washer and Nut. On the right side, floating above the right front corner of the Ramp Casing is the Right Axel Bracket that is aligned with a smaller Washer and a smaller Nut on the right. The right Axel Bracket fits into the smaller Right Axel Hole in the Front of the Right Sidewall of the Ramp Casing and is secure to it by the aligned floating Washer and Nut. The Ramp Casing is Flanked on the right and on the left by three L Shaped Brackets which secure the Ramp Casing to the Tailgate. Floating above the middle of the Ramp Casing is the Middle Flap and above the Rear is the Bottom Flap. The Middle Flap sits flat along the base of the Ramp Casing under the Tailgate Ramp when it is closed. It is spring tensioned and is synchronized with the Tailgate Ramp, so as it opens the Middle Flap brace against the underside and moves along with it. The floating Bottom Flap in the rear has connected regular Hinges that is connected to the indented slots on the Backwall of the Ramp Casing. Plank A, is the first of the Planks and is between the Ramp Casing and the faint #1 Hinge Piston. At the front of Plank A is a long Tube that stretches almost end to end. To the left of the Tube are an aligned Motor Sleeve, Motor and a Motor Bracket. Two thirds of the right and left sides of Plank A are bent upward and the backside has spaced Hinge Barrels with Hinge Extension Stops. Between each Hinge Barrel is the Hinge Slot Stops, which anchors the Hinge Extension Stops when adjacent Planks are on the same plane. Plank A is flanked on both sides by Right and Left Strut Bases, Right and Left #1 Struts and the Strut Attachment on the inside far tip of the Struts. Between Plank A and Plank B is the faint and slender #1 Hinge Piston which is the larger of the two Hinge Pistons. The Hinge Piston is the connecting piece that goes through the Hinge Barrels of the Planks, and connect them together. Plank B is located between #1 Hinge Piston and #2 Hinge Piston and is the second of the Planks. Plank B has spaced #1 Hinge Barrels with protruding Hinge Extension Slots at the front and #2 Hinge Barrels with Hinge Extension Stops of similar spacing on the backside. Plank B has two adjoined indented slots on both sides and is flanked on the right-side and on the left-side by the Strut Base, Strut and a Strut Attachment. Between Plank B and Plank C is the #2 Hinge Piston which is the smaller of the two Hinge Pistons. The Hinge Piston is the connecting piece that goes through the Hinge Barrels of the Planks and secure adjoin Planks. Plank C is located between two #2 Hinge Pistons. It has notched out slots (#3 Indentations) on both sides. On the front of Plank C are spaced #2 Hinge Barrels with protruding Hinge Extension Slots and at the rear are #3 Hinge Barrels with Hinge Extension Stops of with similar spacing. Plank C is also flanked on the right-side and on the left-side by the Strut Base, Strut and a Strut Attachment. Between Plank C and Plank D is the #2 Hinge Piston which is the smaller of the two Hinge Pistons. Plank D is the last of the Planks and is also the smaller of all the Planks. In the front of Plank D are spaced #3 Hinge Barrels with protruding Hinge Extension Slots and Hinge Slot Stops between them. At the rear is a Beveled Edge that stretches from right to left.

FIG. A-1b is an overhead front view of the Ramp Casing with aligned, floating parts which makes up the Ramp Casing. When the parts are connected, they form a fully functional Ramp Casing which is the base of the Folding Tailgate Ramp System. The Ramp Casing is connected to the Tailgate by the L Shaped Brackets, and is connected to Plank A at the front by the Right and Left Axels. In the fore front is a slender Top Flap that has connected Spring Loaded Hinges. The Top Flap would be connected to the main Ramp Casing of the FTRS and the Spring Loaded Hinges would keep the Top Flap erected and aligned with the top edge of the said Ramp Casing. The Ramp Casing has an open front end with two indented slots to connect the Top Flap. Floating above the left front corner of the Ramp Casing is the Left Axel Bracket that is aligned with a Washer and a Nut to the left. The Left Axel Bracket fits into the Left Axel Hole in the front of the Left Sidewall of the Ramp Casing and is secure to it by the aligned floating Washer and Nut. On the right side, floating above the right front corner of the Ramp Casing, is the Right Axel Bracket that is aligned with a smaller Washer and a smaller Nut to the right. The right Axel Bracket fits into the smaller Right Axel Hole in the front of the Right Sidewall of the Ramp Casing and is secure to it by the aligned, floating Washer and Nut. The Ramp Casing is Flanked to the right and on the left by three L Shaped Brackets which secure the Ramp Casing to the Tailgate. Floating above the middle of the Ramp Casing is the Middle Flap and above the Rear is the Bottom Flap. The Middle Flap sits flat along the base of the Ramp Casing, under the Tailgate Ramp when it is closed. It is spring tensioned and is synchronized with the Tailgate Ramp, so as it opens the Middle Flap brace against the underside and moves along with it. The floating Bottom Flap in the rear has connected regular Hinges that is connected to the indented slots on the Backwall of the Ramp Casing.

FIG. A-1c is a front, left-sideview of Plank A with floating parts. Together when attached they form a fully functional Ramp section which is powered by a Motor. Plank A is connected to the Ramp Casing in the front and to Plank B in the rear. Plank A, is the first of the Planks and is between the Ramp Casing and the faint #1 Hinge Piston. At the front of Plank A is a long Tube that stretches almost end to end. This Tube housed the aligned Motor Sleeve and the Motor, and the Motor Bracket secures the Motor in place. Two thirds of the right and left sides of Plank A are bent upward and the backside has spaced Hinge Barrels with Hinge Extension Stops, and between each Hinge Barrel is the Hinge Slot Stops which anchors the Hinge Extension Stop when adjacent Planks are fully open and on the same plane. Plank A is flanked on both sides by Right and Left Strut Bases, Right and Left #1 Struts and the Strut Attachment on the inside far tip of the Struts. Behind Plank A is the faint and slender #1 Hinge Piston which is the larger of the two Hinge Pistons. The Hinge Piston is the connecting piece that goes through the Hinge Barrels of the Planks and connect them together.

FIG. A-1d is a front-view of Plank B with floating parts. Together when attached they form a fully functional Ramp section which is sandwich by Plank A in the front and Plank C in the rear. Plank B fits between Plank A and Plank C and is the second of the Planks. Plank B has spaced #1 Hinge Barrels with protruding Hinge Extension Slots at the front and #2 Hinge Barrels with Hinge Extension Stops of similar spacing on the backside. Plank B has two adjoined indented slots on both sides and is flanked on the right-side and on the left-side by the Strut Base, Strut and a Strut Attachment. In the rear, behind Plank B is the #2 Hinge Piston which is the smaller of the two Hinge Pistons. The Hinge Piston is the connecting piece that goes through the Hinge Barrels of the Planks and secure adjoin Planks.

FIG. A-1e is an overhead view from the rear of Plank C with floating parts. Together when attached they form a fully functional Ramp section which is sandwich by Plank B in the front and Plank D in the rear. Plank C fits between Plank B and Plank D and is the third of the Planks, and has notched out slots, (#3 Indentations) on both sides. On the front of Plank C are spaced #2 Hinge Barrels with protruding Hinge Extension Slots and at the rear are #3 Hinge Barrels with Hinge Extension Stops with similar spacing. Plank C is also flanked on the right-side and on the left-side by the Strut Base, Strut and Strut Attachment. In the front, which is the rear of Plank C, is a #2 Hinge Piston which is the smaller of the two Hinge Pistons, connects Plank C and Plank D.

FIG. A-1f is an overhead, rear-view of Plank D. Plank D has a beveled edge in the rear and is connected to Plank C at the front. Plank D is the last of the Planks and is also the smaller of all the Planks. In the front of Plank D there are spaced #3 Hinge Barrels with protruding Hinge Extension Slots and Hinge Slot Stop. On both sides of the Plank D are Strut Attachment Slots which is an indented area for the Strut Attachment.

FIG. A-1g is a right-side diagonal view of the topside of Plank A. Plank A is the larger of the Planks and is the only Plank that connects directly with the Ramp Casing by ways of the Right and Left Axel Brackets. The Tube in the front which stretches almost the full length of Plank A is welded to the Plank. The said Tube is the connecting point for the Axel Brackets and the left side of it housed the Motor which powers the Tailgate Ramp on its Axels. The attached Right and Left Strut Base provide a durable and ridged anchor for the Struts that push the Planks apart and pull them together. Equally spaced #1 Hinges Barrels with protruding Hinge Extension Stops in the rear are the connection point, which interlocks Plank B. The #1 Hinge Barrels are the Larger of the two Hinge Barrels and is about twice in size of the #2 Hinge Barrel.

FIG. A-1h is a diagonal rearview of the underside of Plank A. Notched out Hinge Slots Stop, protruding Hinge Extension Stop and partial views of the #1 Hinge Barrel dominate the rear which is the frontside of this illustration. This rear, jagged end of Plank A is identical to the front end of Plank B and both ends interlock to form a contiguous piece with a moveable joint. At the far end which is the front of Plank A, there are small notches on both sides which are voids for the missing Right and Left Axel Brackets that would complete both sides.

FIG. A-1i is a right-sideview of the topside of Plank B, with attached Right and Left Strut Base and Strut Attachments on both sides. The Strut Attachment is in front and is aligned with the Strut Base. The tip of Strut fits into the ball joint of the Strut Attachment while the Strut Base provide a durable and ridged anchor for the said Struts. On the right front side are the larger #1 Hinge Barrel and on the left back side are the smaller #2 Hinge Barrel. The front jagged side of Plank B has the larger #1 Hinge Barrels which interlock with the identical rear end of Plank A and create a contiguous piece with a moveable joint. The rear jagged side of Plank B has the smaller #2 Hinge Barrels which interlock with the identical front end of Plank C, and create a contiguous piece with a moveable joint. Behind and aligned with the Strut Base is a shallow indent that is the #1 Indentation which is the clearance that is needed for the cylindrical body of the Strut when Plank B is face to face with Plank C. Inside of #1 Indentation is #2 Indentation which is deeper and longer. This #2 indentation gives clearance to the Strut Attachment, Strut Base and the cylindrical body of the Strut from Plank C.

FIG. A-1j is a front view of the underside of Plank B. Notched out Hinge Slots Stop and protruding Hinge Extension Stop are noticeable from this view in the front and in the rear, and partial views of the #1 Hinge Barrels are also noticeable. The front jagged end of Plank B is identical to the rear end of Plank A and both ends interlock to form a contiguous piece with a moveable joint. At the far jagged end of this Plank B, the slots are aligned with the front end of Plank C, which is similar and together they form an interlocking contiguous piece.

FIG. A-1k is a front, right-sideview of the topside of Plank C, with attached Right and Left Strut Base and Strut Attachments on both sides. Behind the Strut Baes on both sides is #3 Indentation which is open on the outside. The #3 Indentation allows the cylindrical body of the Strut to have enough clearance when the #3 Strut is lowered while connected to the Strut Attachment of Plank D which is partially submerged and sits lower on the Plank. Next to #3 Indentation is the cube shaped #4 Indentation which housed the arch top of the Strut Attachment from Plank D. When Plank C and Plank D are face to face, they touch and the protruding arch of the Strut Attachment fits in it. Protruding Hing Extension Stops and recessed Hing Stop Slots are uniform, and together they create a jagged edge on both long sides of Plank C. On the front Side are #2 Hinge Barrels which span the width of Plank C and sits higher, on the Hinge Extension Stops than the #3 Hinge Barrels that are situated on the rear. Both #2 and #3 Binge Barrels have identical Hinge Barrels that uses the same Hinge Piston but where they differ are, #2 Hinge Barrels sits higher on the Hinge Extension Stops than #3 Hinge Barrels.

FIG. A-1l is the left-sideview of the underside of Plank C. From this view the teeth, which is the jagged edge with the Hinge Extension Stops and the Hinge Slot Stops, that are on both sides, fit and interlock into identical edges of Plank B to the front and Plank D in the rear. On the bottom side of Plank C, the indented Hinge Slot Stops among the Hinge Extension Stops are more pronounced. The Hinge Slot Stops secure the Hinge Extension Stops of the adjoined Planks when they are fully open and when they are on the same plane. On the front ends, the indented Hinge Slot Stops are L shaped which fits over the Right and Left Axel Bracket when the Tailgate Ramp is closed. On the left edge, the Strut Attachment is partially beneath the recessed L shaped Hinge Slot Stop and is adjoined to the Strut Base. On both sides close to the rear is the #4 Indentation which pierces the underside of Plank C is about half the size on this side.

FIG. A-1m is a right-sideview of the topside of Plank D. Plank D is the smaller of the planks and has a jagged front which is comprised of protruding Hinge Extension Stops with lowered Hinge Barrel sitting on top of them, and recessed Hinge Slot Stops which is between each Hinge Extension Stop. On both sides are partially submerged Strut Attachments which are secured to the Strut Attachment Slots. In the rear is a beveled edge which is the only part of the Tailgate Ramp that touches the ground when the Ramp is fully opened.

FIG. A-1n is the left-side view of the underside of Plank D. The jagged edge on the front is very distinct with pronounced Hinge Slot Stops which housed the protruding Hinge Extension Stops from Plank C. From the left side the outline of the partially submerged Strut Attachment is noticeable.

FIG. A-1o is a front view of the Right and Left Struts with floating Right and Left Strut Bases in the front and Strut Attachments in the rear. When the three parts are connected together, on each side, they form a completed Strut. Power Cord attached to the Strut Base supply the electrical power source to the Strut. The main and only purpose of the Strut is to push the adjoined Planks apart and to make them flush at about 180 degrees and to pull them back to their original position.

FIG. A-1p is a front view of the topside of a Tailgate Ramp with separated Plank A, Plank B, Plank C and Plank D which are aligned in order as they would appear on a completed Ramp. The jagged edges of each Plank interlocks with the adjacent Plank to form a contiguous Tailgate Ramp. Plank A has an attached Tube in the front, and Power Cord which lead to the Strut Base, bends and disappears behind the Tube. Large #1 Hinge Barrels complete the backside of Plank A. On both ends of the frontside of Plank B are elongated Power Cords which lead to the Strut Base. The Power Cords is apart of a network of wires which powers the Planks. It pierces the Tube and exit through the center of the Right Axel Bracket and connect to its source. The front end of Plank B has #1 Hinge Barrels, Hinge Extension Stops and Hinge Slot Stops which will interlocks with the rear end of Plank A. Plank B is completed in the rear by a jagged end with evenly spaced #2 Hinge Barrels. Also, on both ends of the frontside of Plank C are elongated Power Cords which leads to the Strut Base. These Power Cords is also a part of the said network of wires which powers the Planks. The front end of Plank C has #2 Hinge Barrels, Hinge Extension Stops and Hinge Slot Stops which will interlocks with the rear end of Plank B. Plank C is completed in the rear by a jagged end with evenly spaced #3 Hinge Barrels. The front end of Plank D has #3 Hinge Barrels, Hinge Extension Stops and Hinge Slot Stops which will interlocks with the rear end of Plank C.

FIG. A-1q is a sideview of the #1 Hinge Barrel, #2 Hinge Barrel and #3 Hinge Barrel with attached Hinge Extension Stop. When they are all together, the differences among them are distinct while they are side by side. The Larger, #1 Hinge Barrel, on the right, is located between Plank A and Plank B. They are evenly spaced across the rear of Plank A and across the Front of Plank B. The #1 Hinge Barrel is made larger to create enough space between Plank A and Plank B that when folded, and are face to face, enough space is created to fit Plank C and Plank D in between. The #2 Hinge Barrel in the middle is second in size and is located between Plank B and Plank C. The Barrel of the #2 Hinge Barrel is actually similar to the Barrel of the #3 Hinge Barrel. Both share the same size Barrel Piston but where they differ is, the #2 Hinge Barrel sits much higher on the Hinge Extension Stop. This is to create enough space when Plank B and Plank C are folded, and face to face there is enough clearance for Plank D to fits between them. The #3 Hinge Barrel is the smaller of the Hinge Barrel and does not need any clearance space. With no clearance space needed between Plank C and Plank D, the #3 Hinge Barrel is made flatter so that the face of both Planks would touch.

FIG. A-1r shows a cross-section of the right-side of the Tube with a protruding Extended Flat Side of Tube. From this view the interior of the tube has a hallow Inner tube with connecting points to the main Tube. Inside the inner Tube on the right is a hole which pierces the backside of the tube, which is the Power Cord Hole, and the tiny hole in the middle, is the Tube opening at the left-side. The flat surface of Plank A is in the lower right which shows the interlocking connecting point on the right of the Tube and Plank A. The protruding Extended Flat Side of Tube fits into the notched-out piece of the Axel Bracket and is secure in place by the Flat Bracket that is bolted through the Bolt Hole in the center.

FIG. A-1s is a front, right-side view of the topside of a connected Tailgate Ramp. Each Plank interlock with the adjacent Plank, and is secured by the Hinge Pistons which hold the Planks together. This diagram shows a completed Tailgate Ramp with all the Planks connected and are on the same plane. In the front is the long Tube of Plank A, behind it at both ends are bent Power Cords, which connect to the Strut Bases. The Right and Left #1 Struts are at rest and are flat along Plank A, and extend and connect to the Strut Attachments of Plank B. The #1 Hinge Barrels are the connecting points between Plank A and Plank B. On both sides, the Power Cords stretched from Plank A and connect with the Strut Base of Plank B. The Right and Left #2 Struts are at rest and are flat along Plank B and extend and connect to the Strut Attachments of Plank C. The #2 Hinge Barrels are the connecting points between Plank B and Plank C. On both sides, the Power Cords stretched from Plank B and connect with the Strut Base of Plank C. The Right and Left #3 Struts are at rest and are flat along Plank C and extend and connect to the Strut Attachments of Plank D. The #3 Hinge Barrels are the connecting joint between Plank C and Plank D. Plank D has a Beveled Edge on the far backside which is the only part of the Tailgate Ramp that touches the surface when it is open.

FIG. A-1t is a left-sideview of the underside of a connected Tailgate Ramp. The interlocking connecting joint are much more pronounced on the backside. Each section is open to its maximum and the Hinge Extension Stops act as stop barriers when they brace against the Hinge Slot Stops, which prevent any further opening at about 180 degrees when the Planks are inline. At this point the Hinge Extension Stops collide with the Hinge Slot Stops, that are hidden from view. With this collision, the adjoined Planks are open to their maximum and all upward movement end abruptly as they are aligned. The Tube of Plank A in the front is partially visible from this view. The three joints show offsetting Hinge Extension Stops from adjoined Planks which interlock and create a contiguous Tailgate Ramp. Along the rear edge of the left-side, the #2 Left Strut, Left Strut Base and #3 Left Strut are partially visible.

FIG. A-1u is a right-sideview of the topside of a connected Tailgate Ramp. Plank A, Plank B and Plank C are aligned and are fully opened while Plank D has been pulled forward, about 45 degrees. At this angle the Right and Left #3 Struts are lifted off the surface as they pull Plank D forward. In the front is the long Tube of Plank A, and behind it at both ends are bent Power Cords, which connect to the Strut Bases. The Right and Left #1 Struts are at rest and are flat along Plank A, and extend and connect to the Strut Attachments of Plank B. The #1 Hinge Barrels are the connecting joint between Plank A and Plank B. On both sides, the Power Cords stretched from Plank A and connect with the Strut Base of Plank B. The Right and Left #2 Struts are at rest and are flat along Plank B and extend and connect to the Strut Attachments of Plank C. The #2 Hinge Barrels are the connecting joint between Plank B and Plank C. On both sides, the Power Cords stretched from Plank B and connect with the Strut Base of Plank C. The Right and Left #3 Struts are angled, extend and connect to the Strut Attachments of Plank D. The Struts pull Plank D forward on the moveable #3 Hinge Barrels which are the connecting joint between Plank C and Plank D. The raised Plank D shows off the elevated Beveled Edge on the far backside which is the only part of the Tailgate Ramp that touches the surface when fully opened.

FIG. A-1v is a left-sideview of the underside of a connected Tailgate Ramp. The interlocking slots of the adjoined sections are flat between Plank A and Plank B and between Plank B and Plank C. However, between Plank C and Plank D, where Plank D is at a slight angle, the jagged edges are exposed and reveal the Hinge Slot Stops that was hidden behind the Hinge Extension Stops. At the front left, a small section of the Tube is visible at the notched-out area. At the first two interlocking joints the Hinge Extension Stops collide with the Hinge Slot Stops which are hidden from view, and the upward movement of the Planks are ceased as they are aligned. At the third joint between Plank C and Plank D there is an opened joint as Plank D is polled forward and therefore exposing the Hinge Slot Stops. Below the second joint, is the extended piece of the #2 Left Strut and to the right of it is an angled #3 Left Strut and together with the #3 Right Strut, they pull Plank D forward. Above the angled #3 Left Strut is the #4 Indentation which penetrates Plank C and narrows as it reaches the backside.

FIG. A-1w is a front, right-sideview of the topside of a connected Tailgate Ramp. Plank A, Plank B and Plank C are aligned and are fully opened while Plank D has been pulled forward to about 135 degrees. At this angle the Right and Left #3 Struts are lifted off the surface and contract as they pull Plank D forward to almost a closed position. In the front is the long Tube of Plank A, and behind it at both ends are bent Power Cords, which connect to the Strut Bases. The Right and Left #1 Struts are at rest and are flat along Plank A and extend and connect to the Strut Attachments of Plank B. The #1 Hinge Barrels are the connecting joint between Plank A and Plank B. On both sides, the Power Cords stretched from Plank A and connect with the Strut Base of Plank B. The Right and Left #2 Struts are at rest and are flat along Plank B and extend and connect to the Strut Attachments of Plank C. The #2 Hinge Barrels are the connecting joint between Plank B and Plank C. On both sides, the Power Cords stretched from Plank B and connect with the Strut Base of Plank C. The Right and Left #3 Struts are angled and is contracted, while still connect to the Strut Attachments of Plank D. The Struts pull Plank D forward on the #3 Hinge Barrels which are the connecting joint between Plank C and Plank D. Plank D is now been pulled forward and is almost on top of Plank C.

FIG. A-1x is a rear, left-sideview of the underside of a fully connected Tailgate Ramp. The interlocking slots of the adjoined sections are flat between Plank A and Plank B and between Plank B and Plank C. However, between Plank C and Plank D, where Plank D is at, a sharp angle, the jagged edges are exposed and reveal the Hinge Slot Stops that was hidden behind the Hinge Extension Stops. The Hinge Extension Stops on this interlocking joint are stuck outward and appear to separate as Plank D closed toward Plank C. At the first two interlocking joints the Hinge Extension Stops collide with the Hinge Slot Stops which are hidden from view, and the upward movement of the Planks are ceased as they are aligned. At the third joint between Plank C and Plank D there is an opened joint as Plank D is polled forward and therefore exposing the Hinge Slot Stops. Below the second joint, is the extended tube of the #2 Left Strut and to the right of it is an angled, and contracted #3 Left Strut, which together with the #3 Right Strut pull Plank D forward. Above the angled #3 Left Strut is the #4 Indentation, which penetrates Plank C and narrows as it reaches the underside.

FIG. A-1y is a front view from of the topside from slightly right, which shows a connected Tailgate Ramp with a closed Plank D that block out almost all of Plank C. Plank C is only partially visible at the far-right side. The pronounced Hinge Slot Stops are easily identified between each Hinge Extension Stop at the rear. The tip of Plank D is inside the second joint and almost touches the #2 Hinge Barrels, while the topsides of both Plank C and Plank D are face to face and touch. In the front is the long Tube of Plank A, and behind it at both ends are bent Power Cords, which connect to the Strut Bases. The Right and Left #1 Struts are at rest and are flat along Plank A and extend and connect to the Strut Attachments of Plank B. The #1 Hinge Barrels are the connecting joint between Plank A and Plank B. On both sides, the Power Cords stretched from Plank A and connect with the Strut Base of Plank B. The Right and Left #2 Struts are at rest and are flat along Plank B and extend and connect to the Strut Attachments of Plank C. The #2 Hinge Barrels are the connecting points between Plank B and Plank C. On both sides, the Power Cords stretched from Plank B and connect with the Strut Base of Plank C. The Right and Left #3 Struts have contracted to its minimal length and is flat between Plank C and Plank D while still connected with both Planks.

FIG. A-1z is a rear, left-sideview of the bottom side of a connected Tailgate Ramp with a closed Plank D. Plank D is only visible at the upward facing Hinge Extension Stops. The recessed Hinge Slot Stops of the Hinge Barrel #3 are noticeable as they are spaced between the Hinge Extension Stops. Between Plank C and Plank D, where Plank D is folded flat on top of Plank C, the jagged edges are exposed and reveal the Hinge Slot Stops that was hidden behind the Hinge Extension Stops. The Hinge Extension Stops on this interlocking joint are stuck outward and appear to separated. At the first two interlocking joints the Hinge Extension Stops collide with the Hinge Slot Stops which are hidden from view, and the upward movement of the Planks are ceased as they are aligned. At the third joint between Plank C and Plank D, there is a fully opened joint as Plank D has been polled all the way forward and therefore fully exposing the Hinge Slot Stops. Below the second joint, is the extended tube of the #2 Left Strut and the #4 Indentation which penetrates Plank C and narrows as it reaches the underside, are near the rear on both sides.

FIG. A-2a is a right-sideview of the topside of a connected Tailgate Ramp, with Plank D closed completely and touching face to face with Plank C, while Plank C is raised forward to about 45 degrees which cause the Left and Right #2 Strut to also be at an angle as they pull the Planks forward. In the front is the long Tube of Plank A, and behind it at both ends are bent Power Cords, which connect to the Strut Bases. The Right and Left #1 Struts are at rest and are flat along Plank A, and extend, and connect to the Strut Attachments of Plank B. The #1 Hinge Barrels are the connecting joint between Plank A and Plank B. On both sides, the Power Cords stretched from Plank A and connect with the Strut Base of Plank B. The Right and Left #2 Struts are angled as they pull Plank C forward which housed a closed Plank D. The #2 Hinge Barrels are the connecting joint between Plank B and Plank C and are in motion as Plank C is being pulled forward. On both sides, the Power Cords stretched from Plank B and connect with the Strut Base of Plank C. The bottom side of Plank D is facing upward as it is locked, face to face with Plank C, and blocks out most of Plank C, where it is only visible at the right edge. Plank D is locked to Plank C and only moves with any movement of Plank C. The Right #3 Strut has contracted and lays between Plank C and Plank D on the right. The raised joint between both Plank shows the notched-out Hinge Slot Stops with the #3 Hinge Barrels which span the center of each slot, and protruding Hinge Extension Stops between and below the said Hinge Slot Stops.

FIG. A-2b is a left-sideview of the bottom side of the said Tailgate Ramp in FIG. A-2a. In this diagram the connecting joint between Plank B and Plank C is offsetting which reveal the Hinge Slot Stops and the protruding Hinge Extension Stops which are more pronounced from this view. At the far end of Plank C, are jagged edges which are Hinge Extension Stops and Hinge Slot Stops that form interlocking slots that is more visible while the topsides of adjoining Planks are touching which leaves the ends exposed. The first joint is flat while the adjoined Planks are on the same plane while the second joint is being separated as Plank C is being pulled forward which exposed the Hinge Slot Stops and separate the Hinge Extension Stops. The lowered end is the third joint between Plank C and Plank D which shows the notched-out Hinge Slot Stops with the #3 Hinge Barrels that span the center of each one, and protruding Hinge Extension Stops that is between the said Hinge Slot Stops. As Plank D is face to face with Plank C the interlocking slots of Plank C is vacated by the interlocking slots of Plank D and therefore create the jagged edge of Plank C.

FIG. A-2c is a right-sideview of the topside of a connected Tailgate Ramp, with Plank D closed completely and touching face to face with Plank C. Plank C is raised forward to about 135 degrees and is about to be face to face with Plank B which will cause the Left and Right #2 Strut to also be at an angle as they pull the Plank forward. In the front is the long Tube of Plank A, and behind it at both ends are bent Power Cords, which connect to the Strut Bases. The Right and Left #1 Struts are at rest and are flat along Plank A, extend and connect to the Strut Attachments of Plank B. The #1 Hinge Barrels are the connecting joint between Plank A and Plank B. On both sides, the Power Cords stretched from Plank A and connect with the Strut Base of Plank B. The Right and Left #2 Struts are angled and contracted as they pull Plank C forward, which housed a closed Plank D. The #2 Hinge Barrels are the connecting joint between Plank B and Plank C and are in motion as Plank C is being pulled forward. On both sides, the Power Cords stretched from Plank B and connect with the Strut Base of Plank C. The bottom side of Plank D is now facing downward as it is locked, face to face with Plank C and blocks out most of it. Plank C it is only visible at the right edge, and at the Hinge Extension Stops. Plank D is locked to Plank C and only moves with any movement of Plank C. The Right #3 Strut has contracted and lays between Plank C and Plank D on the right. The raised joint between both Plank shows the notched-out Hinge Slot Stops with the #3 Hinge Barrels which span the center of each slot, and the protruding Hinge Extension Stops between and above the said Hinge Slot Stops.

FIG. A-2d is a left-side, rearview of the bottom side of the said Tailgate Ramp in FIG. A-2c. In this diagram the connecting joint between Plank A and Plank B is flat and the Hinge Extension Stops of both Planks are interlocking. Between Plank B and Plank C the joint is open and is offsetting, which reveal the Hinge Slot Stops and the protruding Hinge Extension Stops that are more pronounced. At the bottom end of Plank C, are jagged edges which are Hinge Extension Stops and Hinge Slot Stops that are vacated by the Hinge Extension Stops and Hinge Slot Stops of Plank D that is now facing down. Along the left-side, below the first joint is the extended part of the #1 Left Strut which is connected to the Strut Attachment of Plank B. To the right is the Strut Base of Plank B which is connected to the angled #2 Left Strut that is anchored to the Strut Attachment of Plank C. The #2 Left Strut along with the hidden #2 Right Strut are contracting as they poll Plank C forward and will lay flat when both Planks are pulled together. Below the connecting point of the angled #2 Left Strut is the Strut Base of Plank C, which is connected to the #3 Left Strut.

FIG. A-2e shows a sideview of the topside of a connected Tailgate Ramp with outstretched Plank A and Plank B. Plank D is folded, and is face to face with Plank C, Plank C is folded and face to face with Plank B and Plank D is between Plank B and Plank C. On top, on the right, the underside of Plank C is facing up and it appears as if it next to Plank A, but it is higher and in line with the top of the #1 Hinge Barrels. Plank D is face to face with Plank C and is sandwiched between Plank B and Plank C and is barely visible from this view. The tip of the Power Cord extends pass the open end of the Tube on the front, right. The said Power Cord penetrates the backside of the Tube, close to the right, and split in two directions, where the one that goes left, powers the #1, #2 and #3 Left Struts and the one that goes right, powers the #1, #2 and #3 Right Struts. The large joint in the middle connects Plank A to Plank B. Behind the joint is the open end of Plank C which is connected to Plank D. At this end the Hinge Slot Stops reveals the #3 Hinge Barrels which span the center and the opening to the left of the #3 Hinge Barrel also reveals Plank D from this view. On both sides the extended #1 Strut is connected to Plank A and Plank B. The #4 Indentation which is more visible on the right is close to the right edge and the #3 Right Strut, which is connected to Plank C and Plank D is between and parrel to Plank B and Plank C. At the bottom end of Plank C, are jagged edges which are Hinge Extension Stops and Hinge Slot Stops that are vacated by the Hinge Extension Stop and Hinge Slot Stop of Plank D that is now facing down.

FIG. A-2f is a rear, left-side view of the bottom side of a connected Tailgate Ramp with outstretched Plank A and Plank B. From this view Plank D is completely out of sight, while plank C is only visible at the Hinge Extension Stops which is at the bottom of the rear. Plank D is folded, and is face to face with Plank C, Plank C is folded and face to face with Plank B and Plank D is between Plank B and Plank C. The joint between Plank A and Plank B is flat and the Hinge Extension Stops of both Planks are interlocking. The extended section of #1 Strut which connected to Plank B is on the edge, just below the flat joint. Plank C is beneath Plank B and the joint that they share is open and is offsetting, which reveal the Hinge Slot Stops with #2 Hinge Barrel that span the center, and protruding Hinge Extension Stops from both Planks that are more pronounced from this view.

FIG. A-2g is a front, sideview of the topside of a connected Tailgate Ramp with an outstretched Plank A and a raised Plank B that is partially hidden and in the back ground. Plank B is raised to about 45 degrees while Plank C and Plank D are locked to its face and is being move along with Plank B. The underside of Plank C is in full view as it is angled towards Plank A. Plank D is sandwiched between Plank B and Plank C, and is barely visible from this view. The Tube is in the front and almost span the width of the Tailgate Ramp. Behind the Tube are bent Power Cords on both sides which connect with the Strut Bases and diverge to the other Planks. The Strut Base on both sides are anchored to Plank A and secure the Struts which are lifted, and connected to the Strut Attachments of Plank B. The #1 Hinge Barrels of the joint rotate as the Right and Left #1 Struts pull Plank B forward. Next to the joint is the underside, open end of Plank C which is connected to Plank D and at the raised end is the open end of Plank C that is connected to Plank B. At the lower end, the Hinge Slot Stops are evenly spaced across the joint and the #3 Hinge Barrels, span the center of them. Plank D is visible through the Hinge Slot Stops, at the gap below the #3 Hinge Barrels. At the raised jagged end, there are offsetting Hinge Extension Stops from Plank B and Plank C and Hinge Slot Stops from Plank C where #2 Hinge Barrels span the center of each one. The #4 Indentations which narrow and penetrate Plank C are visible on both sides just above the Hinge Slot Stops. The Strut Attachment and the Strut Base of Plank B are noticeable on the edge of the raised side.

FIG. A-2h is a left-side, rearview of the bottom side of a connected Tailgate Ramp. Plank A is parallel to the surface while Plank B is pulled forward to about 45 degrees which reveals the outline of the jagged edge between Plank A and Plank B. From this view Plank C is slightly visible at the lowered left edge while Plank D is completely hidden. At the front left corner is the open end of the Tube and to the right is the lowered, extended #1 Left Strut which is connected to Plank A and Plank B. Above the #1 Left Strut is a partially open joint between Plank A and Plank B. Plank C is beneath Plank B and the joint that they share is open. The open slots are vacated by the Hinge Slot Stops and the Hinge Extension Stops of Planks C.

FIG. A-2i is a right-side, front view of the topside of a connected Tailgate Ramp with an outstretched Plank A and a partially hidden Plank B in the back ground, that is pulled forward to about 135 degrees. The underside of Plank C is in full view, while locked with Plank B, as it is angled towards Plank A. Plank D is locked with Plank C and Plank B and is sandwiched between Plank B and Plank C. Plank D is hardly visible from this view as it is fixed between two Planks. The Tube in the front, almost span the width of the Tailgate Ramp. Behind the Tube are bent Power Cords on both sides which connect with the Strut Bases and diverge to the other Planks. The Strut Base on both sides are anchored to Plank A and they secure the contracted Struts, as they are lifted, while still connected to the Strut Attachments of Plank B. The #1 Hinge Barrels of the joint rotate as the Right and Left #1 Struts pull Plank B forward. Next to the joint is the underside, open end of Plank C which is connected to Plank D and at the raised end, is the open end of Plank C that is connected to Plank B. The lower end is of Plank C is bent sharply and is at a steep angle, but still reveals the Hinge Slot Stops which are evenly spaced across the joint. At the raised jagged end, there are offsetting Hinge Extension Stops from Plank B and Plank C and Hinge Slot Stops from Plank C with #2 Hinge Barrels that span, the center of them.

FIG. A-2j is a left-side, rearview of the bottom side of a connected Tailgate Ramp. Plank A is parallel to the surface while Plank B is pulled forward to about 135 degrees, almost touching Plank A, which reveals the outline of the jagged edge between Plank A and Plank B. From this view Plank C and Plank D are completely hidden. Plank D is locked to Plank C and Plank C is locked to Plank B and therefore at this stage Plank C and Plank D totally depend on Plank B for any movement. From this view the joint between Plank A and Plank B is opened, while Plank B is being pulled forward. The #1 Hinge Barrels are noticeable through the Hinge Slot Stops and the protruding Hinge Extension Stops of both Planks have touching tips. The top end of Plank B, have exposed Hinge Extension Stops and Hinge Slot Stops. Close to the right corner, between the gap of both Planks, is a piece of the Power Cord which power the Left Struts. The angled #1 Left Strut is visible on the right, and along with the hidden #1 Right Strut, both are contracting as they pull Plank B on top of Plank A.

FIG. A-2k is a front, right-side view of the topside of a connected Tailgate Ramp that has been folded completely on itself. From this view the bottom side of Plank B is most prominent is this diagram and takes up most of the drawing. The outline of Plank A is visible along the right-side and along the front via the Tube. Plank C and Plank D are sandwiched between Plank A and Plank B, where Plank D is completely hidden and Plank C is partially visible through the gaps of the Hinge Slot Stops. The Tailgate Ramp is folded flat and is about the thickness of the Tube in the front. In the front right corner, the Power Cord runs through the open right end of the Tube. Along the top side, the tips of the Hinge Extensions Stops of Plank B are next to the Tube and they are aligned with it. The gap between the Hinge Slot Stops along the front, reveal the #2 Hinge Barrels, and in front of them Plank C is partially visible through the gap of the said Hinge Slot Stops. On the far end, is an opened joint with exposed Hinge Extension Stops and Hinge Slot Stops, and stretched across the Hinge Slot Stops are the outline of the cylindrical #1 Hinge Barrels.

FIG. A-2l is a left-side rearview of the bottom side of a connected Tailgate Ramp that has been folded completely on itself. The bottom side of Plank A dominates this view, with the outlines of Plank B along the left-side and along the rear, through the Hinge Extension Stops. Plank B and Plank C, are sandwiched between Plank A and Plank B and are completely hidden from view. At the rear left corner there is a partial view of the Power Cord which powers the Left Struts. The #1 Hinge Barrels are visible through the Hinge Slot Stops, while offsetting Hinge Extension Stops, from Plank A and Plank B are parrel and point in the same direction.

FIG. A-2m is a front-view of the Right and Left Axel Brackets with floating Bolts at the rear. Above the rear section with the floating Bolts, are flat floating Flat Brackets with Bolts on the backside of them. The cylindrical section of the Axel Brackets, on the left is larger and is flanked by larger floating Nuts and Washers while on the right is smaller larger and is flanked by smaller floating Nuts and Washers. The Nuts and Washers on both sides secure the Axel Brackets to the Side Walls. The Axel Brackets are bolted and connected to Plank A and the cylindrical section pierce the Right and Left Side Walls of the Ramp Casing and create rotating joints which allows the Tailgate Ramp to rotate about 205 degrees, from closed to open. The large curved sections of both Axel Brackets align with the Tube of Plank A, and the flat area in the rear, connects with the flat area on the outer edge behind the Tube of Plank A. The Flat Brackets are installed last and they secure the rear of the Tube to the Axel Brackets.

FIG. A-2n is front-view of the topside of a fully completed Tailgate Ramp with attached Left and Right Axel Brackets. The Tailgate Ramp is fully folded and at this size it can fit inside of the recessed Tailgate of a pickup. Floating Nuts and Washers flanked both sides of the Tailgate Ramp which secures it to the Ramp Casing. From the left the Nut and the Washer are aligned with Left Axel Bracket which is connected to the Tailgate Ramp. The Right Axel Bracket is connected to the Tailgate Ramp on the right and is aligned with the smaller Washer and Nut on the far right.

FIG. A-2o is a right sideview of the topside of the said picture in FIGURE A-2n. From this view the right-side of the Tailgate Ramp is in full view. On the right corner, the Power Cord which powers all the Struts, runs through the narrow opening of the Right Axel Bracket and through the aligned small Washer and Nut. The small Washer and Nut fasten the Right Angle Bracket to the Right Sidewall of the Ramp Casing. The Right Axel Bracket is connected to the Tailgate Ramp on the right-side. The Left Axel Bracket is connected to the left-side of the Tailgate Ramp, and is fasten to the Left Sidewall of the Ramp Casing, by the larger Washer and Nut.

FIG. A-2p is a sideview of a window shade Motor which is used to power the Tailgate Ramp. An aligned Motor Bracket on the left, with floating Bolts, fits over the head of the Motor, and a Motor Sleeve on the right fits over the grooved tip. The Motor Bracket in the left is flanked by three screws, fits over the Motor Head and keeps it fixed in position. The Power Cord is attached to the Motor Head as it filters the power source to the Motor. The Motor Head is the only part of the Motor that is always stationery and does not move when it is in motion. From just inside of the Motor Head, to the right tip is moveable and rotates clockwise and counterclockwise, and can be set to a desired opening and closing. The Motor Sleeve on the right, is cylindrical with elongated gear teeth and fits over the geared tip of the Motor. When the Motor is inserted inside the Tube, the notched-out sides of the Motor Sleeve, fit into the inside track of the Tube and is secured to it by a small screw. This secures the Motor to the Tube and allows it to move with the rotation of the Motor.

FIG. A-2q shows a fully closed Tailgate Ramp on the far right with attached Left and Right Axel Bracket. The Left Axel Bracket with a large opening, is aligned with the Motor, with floating Motor Sleeve, a large Bolt and Washer to the right, and a Motor Bracket on the far left. The Motor will be inserted through the large hole of the Left Axel Bracket and fits completely in the Tube and only the Motor Head will be left outside of the Tube. From left the Motor Bracket is flanked by three screws and is aligned with the Motor to the right. Right of the Motor is the Motor Sleeve and right of the Motor Sleeve is a large Nut and a Washer. The Left Axel Bracket is right of the Washer and is connected to the Tailgate Ramp. On the right-side of the Tailgate Ramp is the connected Right Axel Bracket. The Motor which powers the Axels, is inserted through the Left Axel Bracket and into the Tube. The head of the Motor (Motor Head) is attached to the Left Sidewall by the Motor Bracket and the cylindrical body of the Motor is inserted and secured inside the Tube. With the head of the Motor stationery and secured by the Motor Bracket, the cylindrical body inside of the Tube is able to rotate clockwise and counterclockwise, which enables the Tailgate Ramp to open and close.

FIG. A-2r is a left-sideview of a fully completed Tailgate Ramp with attached Left and Right Axel Brackets and an inserted Motor on the left-side. The Motor is fully inserted into the left side of the Tailgate Ramp and the fixed head is the only part of it that is visible. The Power Cord which points downward, powers the Motor and therefore causes the Tailgate Ramp to rotate in both direction on its Axels. The cube shaped Motor Head Connector, of the Motor Head, has a hole that penetrates the topside to the bottom side. A pin is inserted through the connected Motor Bracket and through the Motor Head Connector which secure the Motor Head to the Motor Bracket. The large Nut and the hidden Washer are to the right of the Motor Head, and the space between the Nut and the Left Axel Bracket is the thickness of the missing Left Sidewall of the Ramp Casing. The Right Axel Bracket is connected to the Tailgate Ramp at the right, front corner.

FIG. A-2s shows the rear of a pickup truck with an opened Tailgate. The inside of the Tailgate is recessed, it has been hallowed out to accommodate the Ramp Casing of the Folding Tailgate Ramp System. On the top end of the Tailgate, there is an opened Top Flap which span the top. The Top Flap has spring tensioned Hinges that forces it to stay up in a closed position, but whenever the Tailgate Ramp opens, it pushes the Top Flap downward, and when the Tailgate Ramp is lifted in the opposite direction, the spring tensioned Hinges recoil and the Top Flap returns to its closed position. Behind the Top Flap is the Middle Flap which stretches the width of the Ramp Casing. The Middle Flap has bent, angled ends, with a notched-out piece. The Middle Flap is also spring tensioned and moves with the Tailgate Ramp whenever it moves on its Axels. When the Tailgate Ramp is closed it lays on top of the Middle Flap, and as it opens the spring tensioned Middle Flap recoils and lift with it. As the Tailgate Ramp lifts and flipped over with the rotation of the Axels, the Middle Flap forms a mini ramp which provides a smooth transition from the Tailgate Ramp to the bed of the Ramp Casing. The Bottom Flap is a mini ramp between the Tailgate and the bed of the pickup truck. It provides a smooth transition from the Ramp Casing to the bed of the pickup truck. When the Tailgate Ramp is closed, the Bottom Flap sits on top of it and secures it in place. The Right Axel Hole on the right end of the Ramp Casing, housed the cylindrical piece of the Right Axel Bracket and together they form a rotating joint.

FIG. A-2t shows a front, left-side view of the Ramp Casing of a Tailgate with a floating Top Flap in the front, a floating Middle Flap above the center and a floating Bottom Flap above the rear. On the Left side of the Ramp Casing are L Shaped Brackets which secure the Ramp Casing to the Tailgate. The Top Flap in the front is the cover for the open end of the Ramp Casing. The attached Spring Loaded Hinges, keep the Top Flap upright, and locked to the topside of the Tailgate Ramp. On the front open end of the Ramp Casing are Hinge Slots, which the aligned Spring Loaded Hinges of the Top Flap, are connected and secured to. The Middle Flap which hover, will be snapped in at both ends, and lay flat on the bed of the Ramp Casing, underneath the closed Tailgate Ramp. The Middle Flap is also springe tensioned and is locked to the bottom side of Plank A. The Back Wall of the Ramp Casing has Hinge Slots which house and connect the Hinges of the floating Bottom Flap in the Rear. On the left-side which is a mirror image to the right-side, has three connected L Shaped Brackets that secures the Ramp Casing to the Tailgate.

FIG. A-2u is a left-side, front view of a fully assembled Ramp Casing of a Tailgate, with an opened Top Flap that stretches across the front, a closed Middle Flap that span the middle section and an opened Bottom Flap that stretches across the rear. All three Flaps are connected, the Top Flap and the Bottom Flap are opened while the Middle Flap is lying flat in a closed position. The Left Sidewalls and the Right Sidewall are sturdy and the Tailgate Ramp is anchored and secured to the front ends of both by way of a rotating joint. The Ramp Casing is stationery, and is embedded in the recessed, inside area of the Tailgate, and it is a casing, which house, accommodate, support and is the foundation of the Folding Tailgate Ramp System. The Ramp Casing is very sturdy. It is secured to the Tailgate by six L Shaped Brackets, with three on each side. For added strength the L Shaped Brackets are welded to the inside of the Tailgate and the Ramp Casing is them bolted to them. This connection secures the Ramp Casing to the Tailgate. The Ramp Casing has three walls and they are, Right Sidewall, Left Sidewall and Rear Sidewall. It has an open front that is occupied by a spring-loaded Top Flap that, when closed, is flush with the opening. The Left Sidewall runs the full length of the left-side, from the open front to the rear where it connects with the thinner Rear Sidewall. It is one of the anchoring points for the Ramp Casing, which accommodates the three evenly spaced L Shaped Brackets, that are securely bolted to it. The Left Sidewall has a large hole in the front, which the Motor that is encompass by the Left Axel Bracket passes through. The Right Sidewall runs the full length of the right-side, from the open front to the rear where it connects with the thinner Rear Sidewall. It is the other anchoring point of the Ramp Casing, which accommodates the three evenly spaced L Shaped Brackets, that are securely bolted to it. The Right Sidewall has a small hole in the front, which the Right Axel Bracket passes through. In the rear, is the Rear Sidewall, which runs the full length of the rear, and connects with both Right and Left Sidewalls. The Rear Sidewall is equal in height to both sidewall but half their thickness. The Rear Sidewall housed the Bottom Flap, which holds the Tailgate ramp in place, when closed, and is a miniature ramp between the Ramp Casing and the bed of the pickup. The opened front end of the Ramp Casing is occupied by the moveable, spring loaded Top Flap which is flushed and aligned with the top of the Tailgate. During the opening process, the rotating Tailgate Ramp pushes on to Top Flap and force it open, and because it is spring loaded, whenever the Tailgate Ramp closes, it recoils, and return to its starting position. In the interior, along the floor of the Ramp Casing is a narrow-recessed area which housed a closed Middle Flap. This indentation allows the top of the Middle Flap, when closed, to be flushed with the rest of the floor of the Ramp Casing. The Middle Flap is spring loaded and sits underneath a closed Tailgate Ramp, and as the Tailgate Ramp rotates on its Axels and lift to open, the Middle Flap lift with it. The Middle Flap will continue to lift until it flips over and forms a miniature ramp between the Tube of the Tailgate Ramp and the floor of the Ramp Casing.

FIG. A-2v is a direct front-view of the Ramp Casing of the Tailgate, which is similar to the illustration in FIG. A-2u. In this diagram all the Flaps are closed. The Top Flap is flush with the top end of the Tailgate, the Middle Flap is still flat on the bed of the Ramp Casing, and the Bottom Flap is closed to the bed, and is now a miniature ramp. The bent ends of the Middle Flap are also noticeable from this view. The larger Left Axel Hole at the front of the Left Sidewall, and the smaller Right Axel Hole at the front of the Right Sidewall, are the anchoring joint of the Tailgate Ramp to the Ramp Casing.

FIG. A-2w is a left-side view of the said illustration of the Ramp Casing in FIG. A-2u and FIG. A-2v. In this illustration, the covering of the left-side of the Tailgate has been removed which reveals a clear view of the three L Shaped Brackets which secures the Ramp Casing to the Tailgate. The right-side is a mirror image of the left-side which also has three L Shaped Brackets that anchor and secure the Ramp Casing to the Tailgate. The opened Top Flap in the front is connected to the open end of the Ramp Casing. The front of the Left Sidewall is pierced by a large Left Axel Hole, and on the opposite side, the front of the Right Sidewall is pierced by a small Right Axel Hole. The Middle Flap is flat along the bed, while the Bottom Flap in the rear, is open and erected

FIG. A-2x is a left-side, front view of a separated Folding Tailgate Ramp System. The Tailgate Ramp hovers above the Ramp Casing with both Left and Right Axel Bracket attached to the Ramp Casing. The Axel Brackets are erected, and in an upright position, and they are aligned with the Tailgate Ramp. All three Flaps, the Top Flap, Middle Flap and the Bottom Flap are in an open position. This shows the process of connecting the Tailgate Ramp to the Ramp Casing. First, the Ramp Casing with all three attached Flaps, is installed and secure to the Tailgate. The Left Axel Brackets is then inserted in the large Left Axel Hole and secure to the Left Side Wall. The same process is repeated on the right-side where the Right Axel Bracket is inserted in the small Right Axel Hole and secure to the Right Sidewall. Both Axel Brackets are then aligned upward, just as they are, in the diagram, and then, the Tailgate Ramp is aligned and lowered and connected to the erected Axel Brackets. To continue the installation process, a slight opening of the Tailgate Ramp would be needed to access all the Bolts and the Flat Brackets.

FIG. A-2y is a rear-view of the said diagram in FIG. A-2x. With an exposed bottom side of the floating Tailgate Ramp, which is above the Ramp Casing. The Tailgate Ramp would be lowered and bolted to both Axel Bracket to form a complete Folding Tailgate Ramp System. Bolts and Nuts, flank both sides of the Ramp Casing, and in the front, on the left corner, is a floating Flat Bracket which is behind the upright and erected Right Axel Bracket. The Flat Bracket on the right, the view is being obstructed by the upright and erected Left Axel Bracket. An erected Bottom Flap is in the fore front is attached to the Back Sidewall. The Middle Flap is also erected and stretches across the Ramp Casing just in front of the erected Right and Left Axel Brackets. A partial view of an opened Top Flap is in the rear. The under-side of Plank A of the floating Tailgate Ramp is in full view as the Tailgate Ramp is aligned with the erected Axel Brackets.

FIG. A-2z is a closeup view of the front right corner of the said Ramp Casing in FIG. A-2x and FIG. A-2y. This diagram shows a floating Flat Bracket with bolts, in the front and behind the Flat Bracket is a partial view of an opened Top Flap that is attached to the Ramp Casing by a Spring Loaded Hinge. Then an upright Right Axel Bracket pierces the Right Sidewall and is aligned by a floating Washer and Nut to the far right. Secured to the Right Sidewall is a partial view of a L Shaped Bracket which secure the Ramp Casing to Tailgate. Behind the upright Right Axel Bracket is a partial view of an upright and opened Middle Flap, which is spring loaded.

FIG. A-3a is a closeup view of the front left corner of the said Ramp Casing in FIG. A-2x and FIG. A-2y. This diagram shows a floating Flat Bracket with bolts in the front, and behind the Flat Bracket is a partial view of an opened Top Flap, that is attached to the Ramp Casing by a Spring Loaded Hinge. Then an upright Right Axel Bracket pierces the Left Sidewall and is aligned by a floating large Washer and large Nut to the far left. Secured to the Left Sidewall are partial views of L Shaped Brackets which secure the Ramp Casing to the Tailgate. Behind the upright Left Axel Bracket is an upright, open Middle Flap which is spring tensioned.

FIG. A-3b is a left-side, front view of the Folding Tailgate Ramp System with an attached and upright Tailgate Ramp which is connected to the Ramp Casing. The Ramp Casing has an open-ended, left-side, which reveals the three L Shaped Brackets that secure the Ramp Casing to the Tailgate. A separated Top Flap, is in the front, and a partial view of a hovering Middle Flap, is behind the Tailgate Ramp, and above the Ramp Casing, and a floating Bottom Flap in the rear. The Flaps are moveable parts but are detached from the Ramp Casing in this diagram. When connected, the Top Flap and the Middle Flap are spring loaded they and move with the Tailgate Ramp while the Bottom Flap moves independently.

FIG. A-3c is a left-side rear view of the said erected Tailgate Ramp attached to the Ramp Casing, that is illustrated in FIG. A-3b. From this view the open-ended left-side is in the front and all the inner components are visible. The Top Flap is partially visible at the far right while the hovering Middle Flap and Bottom Flap are in full view. At the peeled back left side, the three L Shaped Brackets which connect the Ramp Casing to the Tailgate, are visible from this view. The Bottom Flap which hovers above the rear of the Ramp Casing, on the left, has attached Hinges that extend downward and would be connected to the Hinge Slots below.

FIG. A-3d is a left-side, front view of a fully completed Folding Tailgate Ramp System with an upright Tailgate Ramp that is attached to the Ramp Casing. The inner components of the peeled back left-side, revealed the inner components that connect the Ramp Casing to the Tailgate. The Motor Bracket which secures the Motor, is aligned and separated from the Motor Head and is at the front left corner. In the front, the Top Flap is connected to the Ramp Casing which is connected to the erected Tailgate Ramp. In the rear, the erected Bottom Flap is connected to the rear of the Ramp Casing by regular Hinges.

FIG. A-3e is a left-side, rear-view of the said diagram in FIG. A-3d which shows an erected Tailgate Ramp secured to the Ramp Casing. From this view the Tailgate Ramp has been rotated 90 degrees on its Axels and is now upright which reveals the Middle Flap that is against the bottom of it. The Middle Flap is spring loaded and moves with the Tailgate Ramp as it turns on the Axels and form a miniature ramp. In the rear of the Ramp Casing is the Bottom Flap, which opens to allow the Tailgate Ramp to lift and closes. The Bottom Flap when close to the floor of the Ramp Casing forms a miniature ramp. In the front, on the right, is a floating Motor Bracket which is aligned with the Motor Head. To the left of the Motor Head are L brackets which anchor the Ramp Casing to the Tailgate.

FIG. A-3f is a closeup view of the left front corner, of the same illustration in FIG. A-3d and FIG. A-3e. The Motor is inserted in the Tube and secure to the Left Sidewall by the Nut, while the floating and aligned Motor Bracket fits over the Motor Head, and secures it in place, and there by prevent it from rotating with the motion of the body of the Motor. The Motor Bracket is secured to the Left Sidewall by the three floating Bolts. The Pin is aligned with the center hole of the Motor Bracket, and when the Motor Bracket is attached to the Left Sidewall, the Pin goes through the Motor Head Connector and the Motor Bracket and lock them together. This sturdy connection keeps the Motor Head fixed even when the rest of the motor is in motion.

FIG. A-3g is a closeup view of the right, front corner of the same illustration in FIG. A-3d and FIG. A-3e. The Nut secures the cylindrical part of the Right Axel Bracket in place, while the protruding Power Cord tip is a network of wires which is the power connection for the Struts. In the front is a partial view of the Top Flap which is connected to the Ramp Casing. Behind the Top Flap is a partial view of the Right Axel Bracket which is connected to the Flat Bracket. The Flat Bracket connects the Right Axel Bracket to the Tailgate Ramp. Above the Axel Bracket is the corner tip of Plank B of the Tailgate Ramp and on the right is the Right Sidewall, which is penetrated by the Axel Bracket. A L Shaped Bracket is attached to the Right Sidewall and secures the front to the Ramp Casing to the Tailgate. On the other side of the Right Sidewall, is a small section of the Middle Flap that is resting on the erected Plank A of the Tailgate Ramp.

FIG. A-3h is a left-side, rear-view of a pickup with an opened Tailgate, and a closed Tailgate Ramp imbedded in it. The Top Flap is closed and seal off the top end of the Tailgate while the Bottom Flap is closed and hold the Tailgate Ramp in place. The Tailgate Ramp takes up almost all of the Tailgate and therefore it creates a wide surface where the bed of the pickup truck can be accessed. On the left corner, the skin has been removed which reveals the inner components.

FIG. A-3i is a closeup view of the front, left-side of the said diagram in FIG. A-3h of the Tailgate with an imbedded Tailgate Ramp. From this view, a Pin is placed through the Motor Bracket and the Motor Head Connector which secures the Motor Head to the Motor Bracket. The Motor Head is now fixed and will not move when the body of the Motor rotates. On the front side, the Top Flap is closed and is flush with the Tailgate. Behind the Top Flap is the Tube of Plank A. The Hinge Extension Stops and the Hinge Slot Stops of Plank B are behind the Tube. A part of the #2 Hinge Barrel is visible at the center of the Hinge Slot Stops.

FIG. A-3j is a right-side, rear-view of the said diagram in FIG. A-3h of a pickup truck with an opened Tailgate, with a closed Tailgate Ramp imbedded in it. A closed FTRS embedded in the inside end of the Tailgate takes up minimal space. It is less than two inches (2″) thick and is flush with the outer ends of the inside end of the Tailgate. The Top Flap is closed and seal off the top end of the Tailgate while the Bottom Flap hold the Tailgate Ramp in place while it is in a closed position. In the front right corner, the top has been peeled back which reveals the inner components.

FIG. A-3k is a closeup view of the front, right-side of the said diagram in FIG. A-3j of a Tailgate with an imbedded Tailgate Ramp. A peeled back top layer at the front corner reveals the Right Axel Bracket which pierces, and penetrates the Right Sidewall. A partial L Shaped Bracket which secures the Ramp Casing to the Tailgate is in view through the open area. In the front is a closed and flush Top Flap and left of the Right Sidewall is the curved section of the Right Axel Bracket which is connected to the Tube of Plank A. Behind the Axel Bracket and below Plank B is a partial view of the Power Cord of the Struts. The Hinge Extension Stops and the Hinge Slot Stops of Plank B are behind the Tube and the #2 Hinge Barrels are visible at the center of the Hinge Slot Stops. Below and in front of the #2 Hinge Barrels and the Hinge Extension Stops is a tiny gap which is a partial view of Plank C.

FIG. A-3l is a rear, overhead view of a pickup truck with an opened Tailgate, with an imbedded Folding Tailgate Ramp System. The Top Flap at the top of the Tailgate is opened but in reality, it is spring tensioned and only opens if it is pushed by the Tailgate Ramp. The Bottom Flap is opened and is in an upright position and therefore make way for the Tailgate Ramp to be open and close. With the Bottom Flap opened, the Tailgate Ramp is now able to lift and rotate on its Axel which initiates the opening process of the Folding Tailgate Ramp System.

FIG. A-3m is a rear, left-side view of a pickup truck with an opened Tailgate and a partially opened Tailgate Ramp. The Tailgate Ramp is in the beginning stage of the opening process, and is opened to about 20 degrees. The left end, notched out bent piece of the Middle Flap, appears as if it is holding up the Tailgate Ramp. It is spring loaded which forces it up as the Tailgate Ramp is being lifted. The Bottom Flap is closed all the way to the floor of the Ramp Casing which creates a miniature ramp, to access the bed of the pickup truck. With all the Planks of the Tailgate Ramp together, the Tailgate Ramp rotates on its Axels which initiates the upward movement. As the Tailgate Ramp rises, the Middle Flap is lifted, and moves along with it and as the opening continues, the Top Flap will be pushed open by the Tailgate Ramp. To operate the FTRS, first, the Tailgate is opened and lowered. The Bottom Flap which secures the Tailgate Ramp, is then pulled up to clear the path of the said Tailgate Ramp. The Motor which is hidden, penetrates the Left Axel Bracket and the Tube, is anchored at the Motorhead, to the outside of the Left Sidewall by the Motor Bracket, is activated which initiate the opening process of the Tailgate Ramp. The cylindrical body of the Motor that is secured and locked to the Tube, rotates clockwise which cause the Tailgate to lift from the floor of the Ramp Casing. The spring-loaded Middle Flap which sits on the floor of the Ramp Casing, and below the Tailgate Ramp, keeps pushing on it as the Motor turns and lift the Tailgate Ramp. At the process continues, the Tailgate Ramp lift with every turn of the Motor and pulls the Middle Flap up, until it forms a miniature ramp, between the Tube of the Tailgate Ramp and the floor of the Ramp Casing. The underside of the Tailgate Ramp is now flipped over, and it begins to go downward, as the opening process continues. The Tailgate Ramp begins to push on the top edge of the spring-loaded Top Flap as it moves downward and with each turn it pushes it further open. This process continues until the Tailgate Ramp moves 155 degrees from the floor of the Ramp Casing, and comes to a halt. The Motor paused and the second step in the opening process is initiated.

FIG. A-3n is a rear, left-side view of a pickup with an opened Tailgate and a partially opened Tailgate Ramp. The Tailgate Ramp rotates from the bed of the Ramp Casing to about 155 degrees and at this point another opening process of the folded inner Planks will be initiated. With a rotation of 155 degrees of the Tailgate Ramp, the Middle Flap has formed into a miniature ramp is now resting on the Tube area of the Tailgate Ramp. Behind the Middle Flap is the Middle Flap Casing, which is an indentation on the floor of the Ramp Casing where it rests.

FIG. A-3o is a rear, left-side view of a pickup, with an opened Tailgate with an opening Tailgate Ramp, and with Plank A that rotates to 155 degrees. Now the second step is triggered and Planks B is activated. Plank A is now stationery and Plank B begins its opening process and is now open to about 30 degrees. At the tip of the Tailgate, below Plank A, the Top Flap is being pushed and begins to open. The #1 Left Strut along with the hidden #1 Right Strut, extend and push Plank B and will continue to push it until it is aligned and on the same plane as Plank A.

FIG. A-3p is a rear, left-side view of a pickup with an opened Tailgate, a partially rotated and stationery Plank A and an opening Plank B which has been opened to about 135 degrees. In this picture the under sides of Plank A and Plank B has been flipped over and are now facing up. Plank A is still stationery, while Plank B continues to open. At the tip of the Tailgate, below Plank A, the Top Flap is being pushed and begins to open. The #1 Left Strut along with the hidden #1 Right Strut, extend and push Plank B and will continue to do so until it is aligned and on the same plane as Plank A.

FIG. A-3q is a rear, left-side view of a pickup with an opened Tailgate, a partially rotated and stationery Plank A and a fully opened Plank B which has been opened to its maximum at 180 degrees. Plank A and Plank B are now at the same angle and together they formed a contiguous platform as the opening process continues. Plank B has reached its maximum opening capacity and is now stationery, and is aligned with Plank A. Planks C and Plank D are still hidden and will be activated to complete the opening process and the full extension of the Tailgate Ramp.

FIG. A-3r is a rear, left-side view of a pickup with an opened Tailgate, a partially rotated and stationery Plank A, and a fully opened Plank B which has been opened to its maximum at 180 degrees. Both Plank A and Plank B are on the same plane and are aligned. Plank C begins its open process, and is now open to about 35 degrees, while Plank D is face to face with Plank C and is hidden from view. From the back of the pickup, the Bottom Flap is closed all the way to the floor of the Ramp Casing which creates a miniature ramp that provides a smooth transition from the bed of the Pickup to the floor of the Ramp Casing. On the other end of the Ramp Casing, is the Middle Flap, which is spring loaded and has been lifted by the spring tension with the rotation of the Tailgate Ramp, and is now fully lifted and forms a miniature ramp. The Top Flap is barely visible at the left, topside of the Tailgate, below Plank A, is being pushed by Plank A of the Tailgate Ramp as it rotates on its Axels. Plank A and Plank B are adjoined and locked on the same plane. The #2 Left Strut along with the hidden #2 Right Strut, extend and push Plank C and will continue to push it until it is aligned and on the same plane as Plank A and Plank B.

FIG. A-3s is a rear, left-side view of a pickup with an opened Tailgate, a partially rotated and stationery Plank A, and a fully opened Plank B which has been opened to its maximum at 180 degrees. Plank A and Plank B are on the same plane and are at the same angle. Plank C still continue its opening process and is now open to about 135 degrees, while Plank D is still face to face with Plank C and is hidden from view. From the back of the Pickup, the Bottom Flap is closed all the way to the floor of the Ramp Casing which creates a miniature ramp that provides a smooth transition from the bed of the Pickup to the floor of the Ramp Casing. On the other end of the Ramp Casing, is the Middle Flap, which is spring loaded and has been lifted by the spring tension with the rotation of the Tailgate Ramp, and is now fully lifted and form a miniature ramp between the Tailgate Ramp and the Ramp Casing. The Top Flap is barely visible at the left, topside of the Tailgate, below Plank A, is being pushed by Plank A of the Tailgate Ramp as it rotates on its Axels. Plank A and Plank B are adjoined and locked on the same plane. The #2 Left Strut along with the hidden #2 Right Strut, extend and push Plank C and will continue to push it until it is aligned and on the same plane as Plank A and Plank B.

FIG. A-3t is a rear, left-side view of a pickup with an opened Tailgate, a partially rotated and stationery Plank A and a fully opened Plank B and Plank C which has been opened to their maximum at 180 degrees. Plank A, Plank B and Plank C are on the same plane and are at the same angle and therefore together they formed a contiguous platform. Plank D is still face to face with Plank C and is hidden from view. From the back of the pickup, the Bottom Flap is closed all the way to the floor of the Ramp Casing which creates a miniature ramp that provides a smooth transition from the bed of the Pickup to the floor of the Ramp Casing. On the other end of the Ramp Casing, is the Middle Flap, which is spring loaded and has been lifted by the spring tension with the rotation of the Tailgate Ramp, and is now fully lifted and form a miniature ramp between the Tailgate Ramp and the Ramp Casing. Plank A, Plank B and Plank C are adjoined and locked on the same plane. The Strut, extend and push Plank C all the way to its maximum opening capacity until it is aligned and on the same plane as Plank A and Plank B.

FIG. A-3u is a rear, left-side view of a pickup truck with an opened Tailgate, a partially rotated and stationery Plank A and a fully opened Plank B and Plank C which has been opened to their maximum at 180 degrees. Plank A, Plank B and Plank C are on the same plane and are at the same angle and therefore together they formed a contiguous platform. Plank D is now visible and begins its opening process where it has now lifted about 35 degrees and continues to rise. From the back of the pickup, the Bottom Flap is closed all the way to the floor of the Ramp Casing which creates a miniature ramp that provides a smooth transition from the bed of the pickup to the floor of the Ramp Casing. On the other end of the Ramp Casing, is the Middle Flap, which is spring loaded and has been lifted by the spring tension with the rotation of the Tailgate Ramp, and is now fully lifted and form a miniature ramp between the Tailgate Ramp and the Ramp Casing. Plank A, Plank B and Plank C are adjoined and locked on the same plane. Now that Plank A, Plank B and Plank C are on the same plane, Plank D is engaged by the activation of the #3 Left and Right Struts. As the #3 Struts extend, the #3 Hinge Barrels rotates and Plank D begins to open from below Plank C. As the opening process continues, the #3 Left and Right Struts will continue to extend and Plank D will be lifted up until it is flush with the other three Planks. The Hinge Extension Stops of Plank C will collide with the Hinge Slot Stops of Plank D, and the Hinge Extension Stops of Plank D will collide with the Hinge Slot Stops of Plank C and therefore, this will close the interlocking joint between Plank C and Plank D.

FIG. A-3v is a rear, left-side view of a pickup with an opened Tailgate, a partially rotated and stationery Plank A and a fully opened Plank B and Plank C which has been opened to its maximum at 180 degrees. Plank A, Plank B and Plank C are on the same plane and are at the same angle and therefore together they formed a contiguous platform. Plank D continues to open and has reached about 135 degrees and is getting closer to be on the same plane as the other Planks. From the back of the Pickup truck, the Bottom Flap is closed all the way to the floor of the Ramp Casing which creates a miniature ramp that provides a smooth transition from the bed of the Pickup to the floor of the Ramp Casing. On the other end of the Ramp Casing, is the Middle Flap, which is spring loaded and has been lifted by the spring tension with the rotation of the Tailgate Ramp, and is now fully lifted and form a miniature ramp between the Tailgate Ramp and the Ramp Casing. Plank A, Plank B and Plank C are adjoined and locked on the same plane. The #3 Left Strut along with the hidden #3 Right Strut, continue to extend and push Plank D until it is almost aligned and on the same plane as Plank A, Plank B and Plank C.

FIG. A-3w is a rear, left-side view of a pickup with an opened Tailgate, a partially rotated and stationery Plank A and a fully opened Plank B, Plank C and Plank D, have been opened to their maximum of 180 degrees. All the Planks are on the same plane and are at the same angle and therefore together they formed a contiguous platform. With all the Planks fully extended, aligned and at the same angle, the third step in the opening process is activated and the clockwise rotation of the Axels and this will cause extended Planks to be lower it to the surface. From the back of the pickup, the Bottom Flap is closed all the way to the floor of the Ramp Casing which creates a miniature ramp that provides a smooth transition from the bed of the Pickup to the floor of the Ramp Casing. On the other end of the Ramp Casing, is the Middle Flap, which is spring loaded and has been lifted by the spring tension with the rotation of the Tailgate Ramp, and is now fully lifted and form a miniature ramp between the Tailgate Ramp and the Ramp Casing. The Struts push Plank D until it is aligned and flush with the other Planks and it is now on the same plane as Plank A, Plank B and Plank C. Now all four Planks are on the same plane and the Struts are all fully extended, the Tailgate Ramp is now open, but it is angled up, and still 45 degrees from the surface. The final step in the opening process is then activated to complete the opening process. The Motor resumed its clockwise rotation, which turn the Right and Left Axels, which turn the Tailgate Ramp towards the surface. The Tailgate Ramp continues to push the Top Flap downward with every rotation of the of the Axels. The process continues until the Top Flap is fully opened and the Beveled Edge of the Tailgate Ramp touches the surface. The FTRS now provides a service, that bridge the elevated area and the surface.

FIG. A-3x is a rear, sideview of a pickup truck with an opened Tailgate and a fully extended Tailgate Ramp. Now that all the Planks are aligned and extended, the Axels begin to rotate which cause the activation of the next step in the opening process where the Tailgate Ramp is lowered to the Surface. As the Tailgate Ramp continues its rotation, it is being lowered and is now parallel to the surface. From the back of the pickup, the Bottom Flap is closed all the way to the floor of the Ramp Casing which creates a miniature ramp that provides a smooth transition from the bed of the pickup to the floor of the Ramp Casing. On the other end of the Ramp Casing, is the Middle Flap, which is spring loaded and has been lifted by the spring tension with the rotation of the Tailgate Ramp, and is now fully lifted and form a miniature ramp between the Tailgate Ramp and the Ramp Casing. The Top Flap is barely visible at the left end of the Tailgate, below Plank A, is being continually pushed by Plank A of the Tailgate, as it rotates on its Axels.

FIG. A-3y is a left-side view of the rear of a pickup with an opened Tailgate and a fully extended and lowered Tailgate Ramp. The Tailgate Ramp is fully opened and has rotated all the way to the surface. The tip of the Tailgate Ramp touches the pavement while still connected to the Tailgate, and therefore creating a full-size ramp which give access to the bed of the pickup truck. The Middle Flap is erected and has been lifted intentionally to show the sudden drop from the Ramp to the floor of the Ramp Casing. The Middle Flap is spring loaded and is always against the Tailgate Ramp, and when it is fully lifted, it creates a miniature ramp, that bridge the gap between the Ramp Casing and the Tailgate Ramp. As the Tailgate Ramp reaches the surface, the interlocking joints between each Plank will be tested as the Tailgate Ramp is being accessed. The joints are designed is such a way that allows the load to push each interlocking joint downward which spread the payload to the adjoined Planks. This allows the interlocking joints to be extremely durable and the Planks will always be aligned whenever they are fully opened.

FIG. A-3z is a left-side view of the rear of a pickup with an opened Tailgate and a fully extended and lowered Tailgate Ramp. In this picture the Middle Flap is against the Tailgate Ramp and is fully open. The Tailgate Ramp is sturdy and wide enough to accommodate motor cycles, four wheelers and small off-road vehicles. As the Tailgate Ramp reaches the surface, the interlocking joints between the Plank are closed and provide an even surface. The joints are designed is such a way that allows the load to push each interlocking joint downward which spread the payload away from the joint to the adjoined Planks. This allows the interlocking joints to be extremely durable. Now that the Tailgate Ramp is open and fully extended, the closing process can be activated which is technically a reverse of the opening process. First, the Bottom Flap is pulled up from the surface of the Ramp Casing. This clears the path for the Tailgate Ramp and ensures a smooth and uninterrupted closing. The Motor is then activated which turn the Axels counterclockwise, which turn the Tailgate Ramp and lift it off the surface. The Tailgate Ramp lift to 45 degrees and pause its rotation. The Top Flap lift with the upward moment of the Tailgate Ramp as its Spring Tensioned Hinges recoil and keep it attached to the edge of it. The #3 Struts are then activated and contract, thus pulling Plank D from aligned to below and face to face with Plank C. The #2 Struts are then activated and contract, thus pulling Plank C from aligned to below and face to face with Plank B, while Plank D which is locked to Plank C, is sandwiched between Plank B and Plank C. The #1 Struts are then activated and contract, thus pulling Plank B from aligned to below and face to face with Plank A, while Plank C and Plank D which are locked to Plank B, are sandwiched between Plank A and Plank B. With all the Planks closed, the Motor is activated again and continue to move counterclockwise. The Right Axel and the Left Axel begin to rotate which turns the Tailgate Ramp, and as it is lifted, the Top Flap lift with it until it closes off the top end of the Tailgate. As the Tailgate Ramp continue to lift and goes upright and over, it starts to push down on the Middle Flap. The process continues until the Tailgate Ramp closes and pushes the Middle Flap to the surface of Ramp Casing with it. The Bottom Flap is then pulled back on top of the Tailgate Ramp to hold it in place while closed. The Tailgate Ramp is locked away and now the Tailgate can now be closed.

FIG. B-1a is a front-view of aligned and separated Plank A, Plank B and Plank C. These three Planks together form a Three Planked, Tailgate Ramp, as they are joined together. The Three Planked, Tailgate Ramp is shorter, which is ideal for lower vehicles such as minivans and smaller SUVs. The front right end, and the left ends of Plank A are the connecting area to the Right and Left Axels Brackets which connects at a rotating joint to the Ramp Casing. The rear of Plank A, connects and interlocks with the front of Plank B. The rear of Plank B, connects and interlocks with the front of Plank C. The rear of Plank C is beveled and this makes accessing the Three Planked, Tailgate Ramp much easier as it touches the surface.

FIG. B-1b is a left-side view of the topside of the Three Planked, Tailgate Ramp with all three planks attached to form one platform. With all the Planks adjoined and on the same plane, the Three Planked, Tailgate Ramp is now stretched out and the Right and Left #1 and #2 Struts are fully extended, and flat against the Planks. The three separated planks of FIG. B-1a is now joined together and connected in this illustration, and they form a contiguous Three Planked, Tailgate Ramp. The Three Planked, Tailgate Ramp has identical Plank A and Plank B with the Four Planked, Tailgate Ramp. The two interlocking joints are similar to the first two interlocking joints of the Four Planked, Tailgate Ramp. Both Plank Cs are similar in size but where they differ from the Four Planked, Tailgate Ramp is, like Plank D, Plank C has beveled rear end instead of the jagged edge of the third interlocking joint. Plank three of the Three Planked, Tailgate Ramp is beveled at the far rear end. This beveled area touches the surface when it is in full operation and makes it easier to access. There is no Plank D, and minus its weight and its length, the Three Planked, Tailgate Ramp is shorter and lighter than the Four Planked, Tailgate Ramp.

FIG. B-1c is a left-side view of the topside of the Three Planked, Tailgate Ramp with Plank A and Plank B aligned and on the same plane, while Plank C has been pulled forward about 90 degrees. The Right and Left Struts #2 are slight lifted at an angle as they are pulling Plank C forward. As Plank C continues to be pulled forward by the Right and Left #2 Struts, which contract as they pull, the #2 Hinge Barrels rotates with every pull of the Struts, and this allows the Plank to move forward. The #1 Hinge Barrels are stationery between Plank A and Plank B as both Planks are aligned and are on the same plane.

FIG. B-1d is a left-side, front view of the topside of the Three Planked, Tailgate Ramp with Plank A and Plank B aligned and on the same plane, while Plank C is face to face with Plank B. The underside of Plank C has been flipped up and is in full view at the rear half of the diagram. It also blocks out most of Plank B, where it is only visible on the far left-side. The end of Plank C is inside the #1 Hinge Barrels where it appears to be touching but a small gap separates them. The #1 Hinge Barrels are still stationery while Plank C moved from being aligned with Plank B and now folding on top of it. Now that Plank C is folded and face to face with Plank B, its motion has been ceased and it is now locked with Plank B. The #1 Left and Right Struts are outstretched and are about to be activated and will pull Plank B forward with a locked Plank C, which is on top and face to face with it.

FIG. B-1e is a left-side, topside view of the Three Planked, Tailgate Ramp with a flat Plank A, while Plank B and Plank C are face to face and are being pulled forward, about 90 degrees, to an upright position. Plank C is in the forefront of the upright section with the underside facing outward and Plank B which is in the rear, is visible around the edges, on the left-side and the rear top edge. Plank B which has a locked Plank C, is being pulled by the Right and the Left #1 Struts that is slightly lifted off the surface. As the Struts contract and pull the Plank, the #1 Hinge Barrels move along and rotate with every push. On top, the interlocking joint is jagged, and it reveals the #2 Hinge Barrels, with offsetting Hinge Slot Stops and Hinge Extension Stops.

FIG. B-1f is a left-side view of a closed Three Planked, Tailgate Ramp where Planks A, Plank B and Plank C are all folded together. Plank A and Plank B are face to face and Plank C is sandwiched between them. The Tube and the left-side of Plank A is visible from this view, while the underside of Plank B is on top and is in full view, while Plank C is hidden from view. The Three Planked Tailgate Ramp is fully folded where Plank C is folded face to face and loch with Plank B, and Plank B is folded Face to face with Plank A. The Three Planked Tailgate Ramp is one third (⅓) its length when closed and therefore is able to fit in to the Ramp Casing of a Tailgate.

FIG. B-1g is a rear view of a SUV with an installed Ramp Casing which is embedded in the rear section. The Three Planked, Tailgate Ramp when installed would allow wheelchair access to the SUV or a minivan and would only utilize minimal space. From the front, the Bumper has been notched out to give enough clearance to the opening Tailgate Ramp. On the left-side, at the front of the Left Sidewall is a Left Axel Hole, which is the larger of the Axel Holes, that housed the Left Axel Bracket of the Tailgate Ramp. On the Right-side, at the front of the Right Sidewall is a Right Axel Hole, which is the smaller of the Axel Holes, that housed the Right Axel Bracket of the Tailgate Ramp. To the inside of the Axel Holes are Hinge Slots, which anchor the Spring Loaded Hinges of the Top Flap. In the rear of the Ramp Casing, along the Back Wall, are two Hinge Slots which anchors the Bottom Flap of the Tailgate Ramp.

FIG. B-1h is a rear view of a SUV with a complete and fully closed Three Planked, Tailgate Ramp installed in the Ramp Casing. The top of the Three Planked, Tailgate Ramp is about flushed with the floor of the SUV, which creates an even surface to move about. The Three Planked, Tailgate Ramp takes up minimal space which does not impede on the storage capacity of the trunk of the SUV. From the front, the Bumper has been notched out to give enough clearance to the opening Tailgate Ramp. Inside the Notched Out Bumper is a Beveled Area which is angled and flushed with it. Behind the Beveled Area is the Top Flap which is flushed with the front side of the Ramp Casing. The Three Planked, Tailgate Ramp is inserted inside the Ramp Casing, and is secures in place by the Bottom Flap which stretches across the rear.

FIG. B-1i is a rear view of a SUV with a Three Planked, Tailgate Ramp. The Three Planked, Tailgate Ramp has been flipped over on its Axels and the topside is facing down and the bottom side is now up. At this point the Three Planked, Tailgate Ramp has rotated about 155 degrees from the floor of the Ramp Casing and pause as the inner Planks are about to be deployed to complete the opening process. The Notched Out Bumper is connected to the Beveled Edge which is connected to the Ramp Casing. The Top Flap is being pushed open by the Three Planked Tailgate Ramp as it rotates on its Axels. The jagged end with #1 Hinge Barrels that connects Plank A and Plank B are in full view while Plank B which is below Plank A is about to initiate the second step in the opening process.

FIG. B-1j is a rear view of a SUV with a complete Three Planked, Tailgate Ramp, with a stationery Plank A that had rotate 155 degrees. Plank B begins to open and has open to about 90 degrees while Plank C which is hidden from view is face to face with Plank B. Below the interlocking joint of Plank A and Plank B, is a partial view of the #1 Left Strut, and with the hidden #1 Right Struts, together they will continue to push Plank B upward until it is flush with Plank A.

FIG. B-1k is a rear view of a SUV with a complete Three Planked, Tailgate Ramp, with a stationery Plank A that had rotate 155 degrees. Plank B has been fully extended to 180 degrees and is now aligned and on the same plane as Plank A. Plank C is still face to face with Plank B and is now barely visible from the bottom side, at the front open joint, along the Hinge Extension Stops. From this view, the open joint between Plank B and Plank C revels offsetting Hinge Extension Stops and Hinge Slot Stops. Plank A and Plank B forms a contiguous plane with a flat and flush interlocking joint. The Middle Flap bridge the sudden drop from the Ramp to the Ramp Casing, and below, to the left-side of the Three Planked, Tailgate Ramp is the Notched Out Bumper which allows the fully extended Ramp to sit lower.

FIG. B-1l is a rear view of a SUV with a complete Three Planked, Tailgate Ramp, with a stationery Plank A that had rotate 155 degrees. Plank B has been fully extended to 180 degrees and is now aligned and on the same plane as Plank A. Plank C begins to open and has open to about 90 degrees. Below the interlocking joint of Plank B and Plank C, is a partial view of the #2 Left Strut, and along with the hidden #2 Right Struts, they will continue to push Plank C upward until it is flush with Plank A and Plank B.

FIG. B-1m is a rear view of a SUV with a complete Three Planked, Tailgate Ramp, with a stationery Plank A that had rotate 155 degrees. Plank B and Plank C have been fully extended, and both are now aligned and are on the same plane as Plank A. Together the three Planks form a fully extended and contiguous plain with even and flush interlocking joints. Now the Tailgate Ramp is about to be lowered to the surface and complete its rotation on the Axels.

FIG. B-1n is a rear view of a SUV with a complete Three Planked, Tailgate Ramp, that is fully extended and has rotated 200 degrees to the surface. Together the three Planks form a fully extended and contiguous Three Planked, Tailgate Ramp which has been lowered to the surface. With the Ramp being extended all the way to the surface it is ready to be accessed. The Three Planked Tailgate Ramp sits on the Notched Out Bumper which makes it easier to reach the surface. Plank A, Plank B and Plank C are all on the same plane and with even and flush interlocking joints which provide a smooth path to the back of the SUV.

FIG. B-1o FIG. B-1o is a rear view of a SUV with a complete Three Planked, Tailgate Ramp, of the said diagram in FIG. B-1n. Plank A, Plank B and Plank C have been fully extended, and are now aligned and are on the same plane. From straight on, and behind the SUV, the Ramp is almost as wide as the back door. Together the three Planks form a fully extended and contiguous Three Planked, Tailgate Ramp which has been lowered to the surface. With the Ramp being extended all the way to the surface it is ready to be accessed. The Three Planked Tailgate Ramp sits on the Notched Out Bumper which makes it easier to reach the surface. The Ramp creates a wide, smooth surface for the user to access the back of the SUV.

I claim:

1. A Folding Tailgate Ramp System (FTRS) that is retractable, and each Plank section fold independently, one by one as it retracts on itself;
A) A stationery Ramp Casing that is attached to the indented inside of the Tailgate, that is the supporting anchor for the Tailgate Ramp.
B) A rotating, extendable and retractable Tailgate Ramp which rotates clockwise from the floor of the Ramp Casing, extend to the surface, folds on itself as it rotates counterclockwise from the surface, and collapse into the Ramp Casing.
C) A Three (3) Planked, Tailgate Ramp.
D) A Four (4) Planked Tailgate Ramp.
E) A Tailgate Ramp with the potential of more than four (4) Planks.

2. Moveable Planks, that are flat rectangular sections, connect together by the interlocking hinge joints, and all connected together form a Tailgate Ramp;
A) A rotating Plank A that is powered by a motor, connects to the Ramp Casing at front and Plank B at rear, rotates clockwise to open from the floor of the Ramp Casing, then rotates counterclockwise to close back to the floor of the Ramp Casing.
B) A Plank B which is strut assisted, open and close on interlocking hinge joints, and is connected to Plank A at front and Plank C at rear.
C) A Plank C which is strut assisted, open and close on interlocking hinge joints, and is connected to Plank B at front and Plank D at rear.
D) A Plank D which is strut assisted, open and close on interlocking hinge joints, and is connected to Plank C at front and has beveled rear.
E) Reducing Planks from Plank A to the end Plank, in the form of a step pyramid.
F) Each Plank moves independently and together they fold inward, with sharp overlaps, where the end Plank is folded and the other Planks fold around it.

3. Interlocking Hinge Joints with extended Hinge Extension Stops and recessed Hinge Slot Stops, connects side by side completes a jagged end of a Plank, and two jagged ends connected, creates an Interlocking Hinge Joint;
A) The joints allow the Planks to fold with sharp-edged overlaps, where the Plank at the end is folded first and continue to fold inward until the Tailgate Ramp has retracted on itself.
B) Hinge Extension Stops that is an extension of the Hinge Barrels, which act as a barrier and stop the movement of the interlocking joint, when they collide with the Hinge Slot Stop of the adjoined Plank.
C) Hinge Slot Stops are indentations between the Hinge Barrels, that accommodate the Hinge Extension Stops of the adjoined Plank, and when they collide, creates a barrier that ends any further movement of the interlocking joint.

4. The Recessed Inside of the Tailgate, which is a notched-out, open inside section, was created to accommodate the FTRS which provides a flush topside with the surrounding areas of the Tailgate;
A) Secures the Ramp Casing to the Tailgate which anchors the Tailgate Ramp.
B) The topside of a folded Tailgate Ramp is flush with the outer edges.
F) Has an open topside that housed the Top Flap, and also allows the Tailgate Ramp clearance to reach the surface.

5. Moveable Flaps which are attached to the Ramp Casing where they form miniature ramps, cover open ends and secure the Tailgate Ramp;
A) A Top Flap which is spring loaded and cover the open end of the Ramp Casing.
B) A Middle Flap which is spring loaded and moves up and down with the movement of the Tailgate Ramp, pulled up to forms a miniature ramp and closes beneath the Tailgate Ramp.
C) A Bottom Flap which secures and hold a closed Tailgate Ramp, and form a miniature ramp when the said Tailgate Ramp vacates the bed of the Ramp Casing.
